(19) United States
(12) Patent Application Publication
(10) Pub. No.: US 2020/0349852 A1
(43) Pub. Date: Nov. 5, 2020

(54) SMART DRONE ROOFTOP AND GROUND AIRPORT SYSTEM

(71) Applicant: Michele DiCosola, Wheeling, IL (US)

(72) Inventor: Michele DiCosola, Wheeling, IL (US)

(21) Appl. No.: 16/866,484

(22) Filed: May 4, 2020

Related U.S. Application Data
(60) Provisional application No. 62/842,757, filed on May 3, 2019.

(51) Int. Cl. G08G 5/00; G06Q 10/08; G05D 1/06; G06Q 20/20; B64C 39/02

(52) U.S. Cl. CPC G08G 5/0013; G08G 5/0069; G08G 5/0043; G06Q 10/0832; B64C 2201/066; G06Q 20/20; B64C 39/024; B64C 2201/128; B64C 2201/145; G05D 1/0653

(57) ABSTRACT

An unmanned vehicle control system is disclosed, comprising a ground control station in operable communication with a plurality of unmanned vehicles via a communications network. The ground control station receives unmanned vehicle mission information and provides a plurality of instructions to the unmanned vehicle to execute a mission including a take-off procedure and a landing procedure. A plurality of microservices process requests from a controller and at least one charging station provides a docking point for the plurality of unmanned vehicles. The charging station provides a power source to the plurality of unmanned vehicles and receives mission information from the ground control station, wherein the unmanned vehicles are operable to deliver a good to a remote location.

### CROSS-REFERENCE TO RELATED APPLICATIONS

The present application claims priority to U.S. Provisional Patent Application 62/842,757 filed on May 3, 2019, entitled “UNIVERSAL AUTOMATED ARTIFICIAL INTELLIGENT ROOFTOP UAS/UAV DRONE PORT/AIRPORT STATION FOR GENERAL PURPOSE SERVICES OF ROBOTIC UAS/UAVS, AND ITS SUPPORTING HARDWARE & EQUIPMENT RELATED TO; LOADING/UNLOADING DELIVERIES, DEPLOYMENT/ARRIVAL, DISPATCHING, AIR TRAFFIC CONTROL, CHARGING, STORING/GARAGING, DE-ICING/ANTI-ICING, METEOROLOGICAL & DATA DISSEMINATION/RETRIEVAL, GIB DATA MINIGN, AND MIMO NETWORK SERVICES” the entire disclosure of which is incorporated by reference herein.

### TECHNICAL FIELD

The embodiments provided herein relate to unmanned aerial vehicles, unmanned vehicle operating systems, and airport facilities thereof.

### BACKGROUND

Air traffic control (ATC) is the task of managing aircraft movements and making sure they are safe, orderly and expeditious. At larger and more frequently trafficked airports, air traffic control comprises a series of highly complex operations that requires managing frequent traffic moving in all three dimensions. A “towered” or “controlled” airport has a control tower where the air traffic controllers are based. Pilots are required to maintain two-way radio communication with the controllers, and to acknowledge and comply with their instructions.

A “non-towered” airport has no operating control tower, and therefore, two-way radio communications are not required; however, it is good operating practice for pilots to transmit their intentions on the airport's common traffic advisory frequency (CTAF) for the benefit of other aircraft in the area. The CTAF may be a Universal Integrated Community (UNICOM), MULTICOM, Flight Service Station (FSS), or tower frequency.

The majority of the world's airports are small facilities without a tower. Not all towered airports have 24/7 ATC operations. In those cases, non-towered procedures apply when the tower is not in use, such as at night. Non-towered airports come under area (en route) control. Remote and virtual tower (RVT) is a system in which ATC is handled by controllers who are not present at the airport itself. Air traffic control responsibilities at airports are typically divided into at least two main areas: ground and tower, although a single controller may work both stations. The busiest airports may subdivide responsibilities further, with clearance delivery, apron control, and/or other specialized ATC stations known in the arts.

Weather observations at the airport are crucial to ensuring safe takeoffs and landings. In the U.S. and Canada, the vast majority of airports, large and small, will either have some form of automated airport weather station, whether an AWOS, ASOS, or AWSS, a human observer or a combination of the two. These weather observations, predominantly in the METAR format, are available over the radio, through automatic terminal information service (ATIS), and/or via the ATC or the flight service station.

Planes take-off and land into the wind in order to achieve maximum performance. Because pilots need instantaneous information during landing, a windsock can also be kept in view of the runway. Aviation windsocks are made with lightweight material, withstand strong winds, and may be illuminated after dark or in foggy weather. Because visibility of windsocks is limited, often multiple glow-orange windsocks are placed on both sides of the runway.

The FAA's Airport Compliance Program ensures airport sponsors comply with the Federal obligations they assume when they accept Federal grant funds or the transfer of Federal property for airport purposes. The program serves to protect the public interest in civil aviation and ensure compliance with applicable Federal laws, FAA rules and regulations, and policies.

There exists a need for a new airport system for unmanned aerial vehicles, commonly known as drones or UAVs, capable of integrating both the national and global systems of operations and safety currently utilized by the Federal Aviation Administration. As further described herein, all relevant components of traditional airport systems, with a specific focus on traffic controls and weather observations, have been integrated into the present design.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a universal automated artificial intelligent rooftop UAS/UAV drone port or airport station, the station being for general purpose services of robotic UAS/UAVs, and its supporting hardware & equipment related to loading and unloading, deliveries, deployment and arrival, dispatching, air traffic control, charging, storing and garaging, de-icing and anti-icing, meteorological & data dissemination and retrieval, big data mining, and MIMO network services; (“UAS” or “Drone Airport System” or “DAS”). The Drone Airport System operation are supported by the Drone Operating System (“DOS”) and provides the following capabilities: 1) Drone on demand delivery services; 2) Drones are parked, stored, and/or charged in the drone garage and/or on a drone landing pad, smart drone mailbox landing pad and/or on a portable drone landing pad; 3) Orders are made via mobile, land, and TV applications using wired and/or wireless connections; 4) Drone AI Cloud (Artificial Intelligence Cloud) figures out if the weather permits deliver to and from the location requested at the time requested; 5) Drone AI Cloud will figure out which drone is available, using the fastest, most convenient, safest and properly equipped drone for the weather conditions, payload requirements, and any other specific demand option(s); 6) the app then confirms the customer has elected that option, then proceeds to the customer order specifications, then proceeds to pre-paid through the mobile, land, or TV app., where they will receive an automatic text, push notification, and or email, of their receipt and purchase; 7) The vendor is automatically informed on their POS system and in their department of interest (shipping, kitchen, lab or pharmacy dispensary, etc.) in the location, that the order has been placed, the customer has paid in full and has elected to use the Drone Delivery Hailing Option 8) The UTM deploys the drone to the landing pad for loading/unloading, drop off and pickup; 9) The Drone is loaded and departs to its destination; 10) The drone delivers arrives at its destination, rings the smart doorbell (if available) and sends a text message and or push notification of its arrival, confirms the receiver of the package, releases the product to the consumer and informs the POS that the order has been delivered.

The Drone AI then selects either the drone's next destination for charging, based upon its remaining battery use and the vacancy availability of the next landing pad to frog leap to if needed and or the nearest vacant charging station/hanger, then sends it to its next order, or parks it at the nearest Smart Drone Rooftop AirPort Parking Station, where it can recharge and wait for further instructions.

In a further embodiment, all rooftop UAS/drone hardware, exterior and or interior equipment and landing pad equipment will have a water proof option such as superhydrophobic (water) and oleophobic (hydrocarbons) coating, that will completely repel almost any liquid and or nanotechnology coating, to coat an object and create a barrier of air on its surface.

In a further embodiment, all UAS/drone(s) that deploy will have the option to use UAS/UAV de-icing inflatable boot equipment on the leading and trailing edges(s) of the propeller arm(s).

In a further embodiment, all UAS/drone hardware will have impact protections options, using products like Mashable D30 Crystalex clear formable elastomer material for protective gear on the UAS/drone for drop test crash resistances.

In a further embodiment, it is contemplated as an option that all UAS/drone hardware will utilize nanocrystalline metal alloy options for lighter, stronger, and more efficient UAS.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 is a perspective view of the present embodiments, Universal Automated Artificial Intelligent Rooftop UAS/UAV Drone Port/Airport Station: for General Purpose Services of Robotic UAS/UAVs, and its Supporting Hardware & Equipment related to; Loading/Unloading, Deliveries, Deployment/Arrival, Dispatching, Air Traffic Control, Charging, Storing/Garaging, De-Icing/Anti Icing, Meteorological & Data Dissemination/Retrieval, Big Data Mining, and MIMO Network Services (“Drone Airport System” or “DAS”), shown operating from a rooftop of a commercial building, in accordance with an exemplary embodiment of the present invention;

FIG. 2 is a diagram showing a cloud-based network and related communication routes employed in operation of the Drone Airport System, including other interactive components, such as business entities, end-user wired/wireless communication devices, server; shown are also various supportive systems, including Drone Operating System, Point of Sale System, Drone Weather System, and Drone Security System, in accordance with an exemplary embodiment of the present invention;

FIG. 3 is a diagram of the primary operating components, supporting systems and their communication methods, connected via a centralized, cloud-based network system; shown are DAS (Drone Airport System), DRONE (drone supporting equipment), DOS (drone operating system's logistic module), DOS (navigational module), DOS (communication module), POS (point of sale system), DSS (drone security system), DWS (drone weather system), in accordance with an exemplary embodiment of the present invention;

FIG. 4 is a flowchart of the primary components of the Drone Airport System (DOS) and other operational components associated therewith, including but not limited to: DWS (drone weather system), POS (point of sale system), DSS (drone security system), and DOS (drone operating system), in accordance with an exemplary embodiment of the present invention;

FIG. 5 is a flowchart, showing the hierarchy of various operation systems outlined in FIGS. 3 and 4, wherein said drawing is showing that all depicted systems have a modular design, made to be interchangeable and/or reconfigured to accommodate the end-user's specific needs, in accordance with an exemplary embodiment of the present invention;

FIG. 6 is a perspective view of the Drone Airport System, showing all the primary components utilized in operation of a rooftop airport system, incorporating landing platforms, meteorological equipment, de-icing/anti-icing equipment, charging stations, communication equipment, liquid storage tanks, drone parking/garage systems, in accordance with an exemplary embodiment of the present invention;

FIG. 7 is a perspective view of a city with a plurality of tall structures wherein two of said structures house the Drone Airport System, each containing the necessary hardware, except for the radar system (attached to the airport in the foreground), which is shared by the nearby airports to reduce the operational costs, in accordance with an exemplary embodiment of the present invention;

FIG. 8 is a perspective view of buildings located in a congested, urban area wherein one of said buildings is housing the Drone Airport System designed to accommodate possible restrictive city ordinances, made to service high traffic intensity, incorporating low-profile, drone garage systems, in accordance with an exemplary embodiment of the present invention;

FIG. 9 is a perspective view of the Drone Airport System operating from a rooftop of a low commercial structure, incorporating a plurality of low-profile, drone garage systems located on the rooftop of the structure and a multitude of independently-functioning drone landing pads positioned in front of the businesses occupying said commercial structure, in accordance with an exemplary embodiment of the present invention;

FIG. 10 is a front view of a low commercial structure housing a plurality of businesses wherein said businesses utilize three done landing pads positioned at the street level in front of the building; further showing the Drone Airport System equipment positioned on the rooftop of said structure with a low profile design such that the equipment is not visible to the pedestrians positioned on the street/sidewalk, thereby accommodating the more restrictive zoning requirement, in accordance with an exemplary embodiment of the present invention;

FIG. 11 is a perspective view of a restaurant wherein the Drone Airport System is located on the rooftop, with a drone landing pad adjacent to a pick-up window and an elongated parking platform for drones awaiting deployment, in accordance with an exemplary embodiment of the present invention;

FIG. 12 is a top view of the restaurant shown in FIG. 11, showing the restaurant's drive through path and the space occupied by the Drone Airport System on the roof of said restaurant, including the garage systems, meteorological equipment, liquid storage tanks, computer system, network system, communication system, and the location of two portable drone landing pads, in accordance with an exemplary embodiment of the present invention;

FIG. 13 is perspective view of a low commercial structure wherein the Drone Airport System is housed on its roof, and utilizing at the street level a plurality of drone landing pads; further shown is a nearby street intersection defining a drone flight path, designed to utilize the air space directly above the existing street setbacks, further configured to allow the drones to reach the airport from the street level, in accordance with an exemplary embodiment of the present invention;

FIG. 14 is a front view of various structures, including commercial and residential buildings, showing the restricted zone (no-flight-areas) for drones operating on and near rooftops of both commercial and residential buildings wherein said buildings also utilize drone landing pads, positioned at the street level, creating a restricted area between the building and the front elevation of each structure, in accordance with an exemplary embodiment of the present invention;

FIG. 15 is a graphical representation of a top view of a building, showing the footprint of the Drone Airport System (part of the DAS Airport Hardware Module), located on the rooftop of said buildings, wherein footprint incorporates: 1) Meteorological & Weather (Wx) Observation & Forecast Equipment; 2) News Rooftop Rentals for UAS, Charging, De-icing/Anti-icing and Garaging; 3) Rooftop Parking Lots for UAS Peer-to-Peer UAS Sharing, Logistical Less Than Load (LTL) Deliveries, UAS hailing, UAS Commercial Services, Take Away Delivery Services, and UAS Private Use Services; 4) Public Rooftop Rentals for UAS, Charging, De- icing/Anti-icing and Garaging: Police, Fire, Medical; 5) Computer Networking, Electronics, Communications & Security Systems, 5G Antenna Array, MIMO, Beamforming, Back Up Battery and Redundancy System(s); 6) Liquid Storage Stations Charging, De-icing/Anti-Icing and Garaging Services; in accordance with an exemplary embodiment of the present invention;

FIG. 16 is a screenshot of the drone tracking software and part of the DAS Airport Software Module showing rooftops of numerous buildings, and the usage of said software to track a plurality of drones using a grid view C2 to E4, in accordance with an exemplary embodiment of the present invention;

FIG. 17 is a screenshot from the DAS Airport Software Module designed to control distances between operational drones and the locations of re-programmed Geofencing, created to protect vital public and/or government-controlled infrastructure, in accordance with an exemplary embodiment of the present invention;

FIG. 18 illustrates a block diagram of the DAS Airport Communication Module, and shows the key components (A/V Communications, 4G/5G Options, Virtual Network Small Nods, Internet of things, AI Air Traffic Control, Cyber Security, Big Date, Cellular Chip) of said module interconnected via a cloud-based network, in accordance with an exemplary embodiment of the present invention;

FIG. 19 illustrates a block diagram of the layered network communication system (called Stratum Cloud Communication), part of the DAS Airport Communication Module, subdividing communication requirements between the customers, security, internal systems (point of sale, weather system, maintenance, airport system), and vendors ordering products/services, in accordance with an exemplary embodiment of the present invention;

FIG. 20 is a flowchart illustrating part of the DAS Airport Communication Module, further defining the key components outlined in FIG.18 (A/V Communications, 4G/5G Options, Virtual Network Small Nods, Internet of Things, AI Air Traffic Control, Cyber Security, Big Date, Cellular Chip) of said module interconnected via a cloud-based network, in accordance with an exemplary embodiment of the present invention;

FIG. 21 is a flowchart illustrating part of the DAS Airport Communication Module, showing the various methods of mobile and cloud-based payment services available to end-users utilizing drones as their means of delivering the required products and services, including but not limited to crypto currency, block chain services, merchant credit, PayPal, direct checking, e-commerce, third party digital ticket, Apply Pay, G Pay, Amazon Pay, Wal-Mart Pay, in accordance with an exemplary embodiment of the present invention;

FIG. 22 is a flowchart illustrating part of the DAS Airport Communication Module, showing the Communication, Command and Control (C3) Architecture, in accordance with an exemplary embodiment of the present invention;

FIG. 23 is a flowchart illustrating part of the DAS Airport Communication Module, outlining the integration of MIM Technology, a method for multiplying the capacity of a radio/communication links using multiple transmission and receiving antennas to exploit multipath propagation, in accordance with an exemplary embodiment of the present invention;

FIG. 24 is a graphical chart illustrating part of the DAS Airport Communication Module, further outlining the 5G network, antenna arrays (MIMO) configurations and features, in accordance with an exemplary embodiment of the present invention;

FIG. 25 is a graphical chart illustrating part of the DAS Airport Communication Module, outlining integration into the Drone Airport System, the Global Distribution System (GDS), a computerized network system enabling transactions between travel industry service providers, mainly airlines, hotels, car rental companies, and travel agencies, in accordance with an exemplary embodiment of the present invention;

FIG. 26 is a graphical chart illustrating part of the DAS Airport Communication Module, outlining integration into the Drone Airport System, the Next Generation Air Transportation System (NextGen), an FAA-led project, focusing on development of a system designed to implement innovative new technologies and airspace procedures to improve safety, in accordance with an exemplary embodiment of the present invention;

FIG. 27 shows the weather module systems integrated into the Drone Airport System, wherein said module includes measuring instruments, micro servers, weather software and self-contained solar, recharging system, in accordance with an exemplary embodiment of the present invention;

FIG. 28 shows the 4-Dimensional (4-D) Weather (Wx) Cube, incorporated into DAS Weather Module, enabling continuously updated weather observations (surface to low Earth orbit, including space weather and ocean parameters), high resolution (space and time) analysis and forecast information (conventional weather parameters from numerical models), designed to predict various aviation parameters (icing, turbulence, wind, visibility), in accordance with an exemplary embodiment of the present invention;

FIG. 29 is a graphical chart illustrating part of the DAS Weather Module, outlining the benefits of the 4-Dimensional (4-D) Weather (Wx) Cube, incorporated into DAS Weather Module, shown in FIG. 28, in accordance with an exemplary embodiment of the present invention;

FIG. 30 is a graphical image illustrating part of the DAS Compliance Module, outlining the primary factors having impact on the development of Sustainable Airport System, in accordance with an exemplary embodiment of the present invention;

FIG. 31 is a graphical image, showing FAR Classification of UAS/UAV Ground and Rooftop DronePort/Airport's and Airport Airspace, and integration thereof into the DAS Drone Airport System, in accordance with an exemplary embodiment of the present invention;

FIG. 32 is a flowchart illustrating part of the DAS Compliance Module, outlining the specific airport/drone categories of said Compliance Module, in accordance with an exemplary embodiment of the present invention;

FIG. 33 is a flowchart illustrating part of the DAS Compliance Module, outlining the specifics of the Airport Certification and Operations, in accordance with an exemplary embodiment of the present invention;

FIG. 34 is a flowchart illustrating part of the DAS Compliance Module, outlining the specifics of the Coordinated Time and Day System, integrated into the DAS Drone Airport System, in accordance with an exemplary embodiment of the present invention;

FIG. 35 is a flowchart illustrating part of the DAS Compliance Module, outlining the specifics of the Drone Identification, and the Pilot Certification and Operation Standards, integrated into the DAS Drone Airport System, in accordance with an exemplary embodiment of the present invention;

FIG. 36 is a flowchart illustrating part of the DAS Compliance Module, outlining the specifics of the Airport Conditions/Safety Standards, integrated into the DAS Drone Airport System, in accordance with an exemplary embodiment of the present invention;

FIG. 37 is a flowchart illustrating part of the DAS Compliance Module, outlining the specifics of the Licensing, Bonds and Insurance Standards, integrated into the DAS Drone Airport System, in accordance with an exemplary embodiment of the present invention;

FIG. 38 is a flowchart illustrating part of the DAS Compliance Module, outlining a first portion of the specifics of the Procedures for Adverse Conditions, integrated into the DAS Drone Airport System, in accordance with an exemplary embodiment of the present invention;

FIG. 39 is a flowchart illustrating part of the DAS Compliance Module, outlining a second portion of the specifics of the Procedures for Adverse Conditions, integrated into the DAS Drone Airport System, in accordance with an exemplary embodiment of the present invention;

FIG. 40 is a flowchart illustrating part of the DAS Compliance Module, outlining the specifics of the Security and Emergency Procedures integrated into the DAS Drone Airport System, in accordance with an exemplary embodiment of the present invention;

FIG. 41 is graphical display illustrating part of the DRONE and Supporting Equipment, showing a plurality of drone equipment, and related accessories, which may be utilized in formation of the DAS Drone Airport System, with focus on the Rooftop Drone Garage Systems, in accordance with an exemplary embodiment of the present invention;

FIG. 42 is graphical display illustrating part of the DRONE and Supporting Equipment, showing a plurality of drone equipment, and related accessories, which may be utilized in formation of the DAS Drone Airport System, with focus on the Stackable Rooftop Drone Garage Systems, in accordance with an exemplary embodiment of the present invention;

FIG. 43 is graphical display illustrating part of the DRONE and Supporting Equipment, showing a plurality of drone equipment, and related accessories, which may be utilized in formation of the DAS Drone Airport System, with focus on the Mailbox Drone Landing Pad, in accordance with an exemplary embodiment of the present invention;

FIG. 44 is a graphical image illustrating part of the DOS Drone Operating System's Logistic and Communication Module, showing screenshots of computer applications, including: 1) drone and components availability screen; 2) drone scheduling screen; 3) drone and components location screen; 4) drone utilization screen; 5) emergency services programs screen; 6) tornado warning screen; in accordance with an exemplary embodiment of the present invention;

FIG. 45 is a graphical image illustrating part of the DOS Drone Operating System's Navigational Module, utilized by the DAS Drone Airport System, showing screenshots of computer applications, including: 1) navigational flight to target screen; 2) claims adjustment drone application screen; 3) drone availability screen; 4) application availability screen; 5) autonomous flight path planning screen; in accordance with an exemplary embodiment of the present invention;

FIG. 46 is a graphical image illustrating part of the DOS Drone Operating System's Navigational Module, utilized by the DAS Drone Airport System, showing screenshots of computer applications, including: 1) projected weather condition screen; 2) flight congestion and rerouting screen; 3) projected hazard avoidance screen; in accordance with an exemplary embodiment of the present invention;

FIG. 47 is a graphical image illustrating part of the DOS Drone Operating System's Pilot Module, utilized by the DAS Drone Airport System, showing screenshots of computer applications, including: 1) visual system calibration screen; 2) flight control calibration screen; 3) flight to target screen; 4) flight weather radar screen; 5) in-flight obstacle avoidance screen; 6) misc. applications interface screen; in accordance with an exemplary embodiment of the present invention;

FIG. 48 is a graphical image illustrating part of the DOS Drone Operating System's Pilot Module, utilized by the DAS Drone Airport System, showing screenshots of computer applications, including: 1) thermal imaging camera screen; 2) night vision imaging camera screen; 3) manual and visual flight screen; 4) fly by the instruments screen; in accordance with an exemplary embodiment of the present invention;

FIG. 49 is a graphical image illustrating part of the POS Point of Sale System (Customer Module), which may be utilized by the Smart DAS Drone Airport System, showing screenshots of computer applications permitting purchase of products/goods via smart TV systems, in accordance with an exemplary embodiment of the present invention;

FIG. 50 is a graphical image illustrating part of the POS Point of Sale System (Customer Module), which may be utilized by the DAS Drone Airport System, showing screenshots of computer applications permitting purchase of products/goods via portable devices, such as a smart phone, wherein said screenshot include: 1) cuisine selection screen; 2) restaurant selection screen; 3) restaurant profile screen; in accordance with an exemplary embodiment of the present invention;

FIG. 51 is a graphical image illustrating part of the POS Point of Sale System (Vendor Module), which may be utilized by the DAS Drone Airport System, showing screenshots of point of sale hardware/software available to restaurant owners, in accordance with an exemplary embodiment of the present invention;

FIG. 52 is a graphical image illustrating part of the POS Point of Sale System (Customer Module), which may be utilized by the DAS Drone Airport System, showing screenshots of computer applications permitting order tracking via smart TV systems, or other wired/wireless devices, in accordance with an exemplary embodiment of the present invention;

FIG. 53 illustrates a schematic of the drone airport system, according to some embodiments;

FIG. 54 illustrates a block diagram of the unmanned systems services network, according to some embodiments;

FIG. 55 illustrates a block diagram of the communications involved in reserving and implementing a landing procedure, according to some embodiments; and

FIG. 56 illustrates a block diagram of the communications involved in reserving and implementing a take-off procedure, according to some embodiments.

### DESCRIPTIVE KEY

100—Smart Drone Rooftop and Ground Airport System.

101—Drone (“UAV's” or “Unmanned Aerial Vehicle” or “UAS” or “Unmanned Aerial Systems” or “VTOL's or “Vertical Take Off and Landing Vehicle” or “eVTOL's” or “Electric Vertical Take Off and Landing Vehicle” or “VSTOL' s” or Vertical Short Take-Off and Landing Vehicles” or “STOL's” Short Take-Off and Landing Vehicles” or “eSTOL's” or “Electric Small Take-Off and Landing Vehicle” or “CTOL's” or “Conventional Take-Off and Landing Vehicle” or “eCTOL's” or “Electric Conventional Take-Off and Landing Vehicle” or “AV's” or “Autonomous Vehicles” or “CAV's” or “Connected and Autonomous Vehicles” or “Cargo Air Vehicles” or “CAV's” or Electric Cargo Air Vehicles” or “eCAV's” or “PAV's” or “Passenger Air Vehicles” or ePAV's″ or “Electric Passenger Air Vehicles”).

102—Drone Garage/Charging Station Stackable.

103—Drone Garage/Charging Station.

104—Computer, Security, Communication and Networking Container.

105—Liquid Storage.

106—Radar Equipment.

107—Landing Pad (exposed).

108—Landing Pad (enclosed).

109—Landing Pad (extended).

200—Wireless and Non-Wireless Communication Devices:

201—Personal Computers;

202—Tablets;

203—Online Video Games;

204—Video Game Consoles;

205—Video Game Controllers and Accessories;

206—Smart Phones;

207—Smart Televisions;

208—Smart Television Controllers and Accessories;

209—Other Contemporary Communication Devices;

209—Other Contemporary Communication Devices.

210—Wireless Communication Systems:

211—Wireless Fidelity, Wireless Internet System (WiFi);

212—ZigBee Wireless Technology;

213—Bluetooth Systems;

213A-Advanced Wireless Research (NSF)

213B-Network File System (NFS)

213C-Near Field Communications (NFC)

214—Wireless Broadband WiMAX;

215—Mobile Communication Standard (LTE Advanced);

216—Internet of Things (IoT);

217—Near Field Communication (NFC);

218—Other Contemporary Communication Systems.

219—Telemetry Module

220—TCP/IP Module

221—Dedicated Short Range Communications (DSRC) Module

222—Drone to Drone Communication (D2D) Module

223—Drone to Landing Pad Communication (D2L) Module

224—Drone to Infrastructure Communication (D2I) Module

225—Drone to Drone Single-Hop Broadcasting Module

226—Drone to Drone Multi-Hop Broadcasting Module

227—Drone Platooning Module

228—Smart Drone Mailbox Landing Pad Module

228A—Smart Landing Pad Module

228B—Smart Portable Landing Pad Module

300—Network System:

300A—Unmanned System Services Network (USSN) every object is a node with the following characteristics:

300A1—Node Type: drone, battery, point-of-sale, rooftop, mailbox, etc.

300A2—Industry Type: Public, Private, Public Private Participation (PPP), and Military

300A3—Sector Type: For special-purpose applications like medical delivery or law enforcement.

300A4—Unique 160 Bit ID

300A5—Public-Private Key Pair

300A6—Primary Status (available or Unavailable)

300A7—Secondary Status (additional details)

300A8—Event Log

300A9—Schedule of Commitments

300A10—Every Node has access to the following services

300A11—NextGen Weather Data Streams

300A12—ADS-B Data Exchange

300A13—GPS

300A14—Drone Flight Planner (DFP)

300a15—Drone Data Exchange (DDE)

300A16—Drone System State (DSS)

300A17—Drone Mission Database (DMDB)

300A18—Device Authentication Authority (DAA)

300A19—Drone Mission Checker (DMC)

300B—Autonomous Aerial Vehicle Operating System (AAVOS) combines DSSN and US SN)

300C—Drone System Service Network (DSSN) consists of nodes and devices

300D—Every Node has the following equipment

300D1—4G, 4G LTE, and 5G antenna(s)

300D2—WiFi Antenna

300D3—Raspberry Pi or Similar SoC computer that can be programmed

300D4—Flash Card for Storage

300E—Drone Request System (DRS) for users and customers to hail services

301—Server;

302—User Communication Module;

303—User Preferences Module;

304—Vendor Locator Module;

305—Vendor Management Module;

306—Messages Module;

307—Rules Module;

308—Order Management Module has four (4) types of delivery order service modules;

308A—In-House Customer's Direct Order Hailing Module

308B—Vendor's Direct Customer's Order Hailing Module

308C—Vendor's In-House Staff Point-of-Sale (POS) Hailing Request Module

308D—3^{rd} Party Take Away Delivery Service Hailing Request Module using our OEM API Hailing App and UAS Hailing Services

309—Payment Management Module;

310—Communications Module;

311—Drone Control Module;

312—Vision System Module;

313—Delivery Management Module;

314—Order Tracking Module;

315—Data Management Module;

316—Data Storage Module;

317—Application Control Module;

318—Application Management Software;

319—The Cloud/Online Data Storage and Computing.

319A—Agnostic Open Platform Auxiliary Operating System (OS) Module (mobile app. Ready)

320—Agnostic Open Platform Operating System (OS) Multi-Module Operation Enabled

321—OS Module 1—applications operating system for third-party platforms/applications (Apple IOS, Android, Roku)

322—OS Module 2—ready for ANSP, UTM, USS, LAANC, ATC, UAM, GATSS, SBAS, GPS, IMU airspace management system(s) integration via Cloud

323—OS Module 3—Ready for NEXGEN network participating systems communication and data sharing for any platform such as Smart Cities or First Responders

324—OS Module 4—ready for DOS, POS, and DAS system integration via cloud

325—OS Module 5—Block Chain Management System

326—OS Module 6—Block Chain Data Mining System

327—OS Module 7—Cyber Security Network System

328—OS Module 8—application APIs for third party applications

329—OS Module 9—application open source firmware for third party application

330—OS Module 10—Global Air Traffic Surveillance System (GATSS)

331—OS Module 11—Urban Air Mobility Eco-System (UAM)

332—OS Module 12—Advanced Air Mobility System (AAM)

333—OS Module 13—Low Altitude Authorization and Notification Capability (LAANC)

334—OS Module 14—US Data Exchange (USDE)

335—OS Module 15—UAS Service Supplier (USS)

336—OS Module 16—Third Party Software Development Kit (SDK) Integration

337—OS Module 17—Drone as A Service (DaaS) with AI Cloud

337A OS Module 18—Drone as a Service (DaaS) AI Cloud Computing Cross Platform for Private, Community, Public and Hybrid

337B—OS Module 19—Drone as a Service (DaaS) third party integration

338—OS Module 20—Infrastructure as a Service (IaaS) with AI Cloud

338A—OS Module 21—Infrastructure as a Service (IaaS) with AI Cloud third party integration

338B—OS Module 22—Infrastructure as a Service (IaaS) AI Cloud Computing Cross Platform for Private, Community, Public and Hybrid

339—OS Module 23—Platform as a Service (PaaS) open source with AI Cloud

339A—OS Module 24—Platform as a Service (PaaS) AI Cloud Computing Cross Platform for Private, Community, Public and Hybrid

339B—OS Module 25—Platform as a Service (PaaS) third party open source integration

340—OS Module 26—Software as a Service (SaaS) with AI Cloud

340A—OS Module 27—Software as a Service (SaaS) third party integration

340B—OS Module 28—Software as a Service (SaaS) AI Cloud Computing Cross Platform for Private, Community, Public and Hybrid

342—OS Module 29—Cloud Computing System

343—OS Module 30—Block Chain Computing and Harvesting System

344—OS Module 31—Agnostic AI Cloud Platform

345—OS Module 32—Graphical User Interface (GUI) with API apps

346—OS Module 33—Command Line Interface (CLI) with API apps

347—OS Module 34—Vehicle Fleet Management (VFM) Operating System Module for Unmanned Ground Vehicle (UGV) Hailing Service

400—Flight Directing and Control Systems:

401—Global Positioning System (GPS);

402—Geotracking System;

403—Object Tracking System;

404—Autonomous Take-Off/Landing Support System;

405—Light Detection and Ranging (LiDAR);

406—Positional Sensors;

407—Flight Routing and Re-Routing System;

408—External Vision Systems.

409—Telemetry Systems

410—Radar

411—Inertial Measurement Unit (IMU)

412—Satellite Based Augmented System (SBAS)

413—Global Air Traffic Surveillance System (GATSS)

414—Urban Air Mobility Eco-System (UAM)

415—Advanced Air Mobility System (AAM)

416—Low Altitude Authorization and Notification Capability (LAANC)

417—US Data Exchange (USDE)

418—UAS Service Supplier (USS)

419—Laser Scanner

420—Random Sampling Consensus (RANSAC)

421—Sonar Object Detection (SOD)

422—Fast Lightweight Autonomy System (FLA)

423—Radio Frequency (RF)

424—Radio Frequency Identification System (RFID)

425—Real Time Locating System (RTLC)

426—Asset Tracking Labels (ATL)

427—Barcodes

428—Static QR Codes

429—Dynamic QR Codes

430—Simultaneous Localization and Mapping (SLAM)

431—Extended Kalman Filter (EKF)

432—Real World Interface (RWI)

433—Vision Process System (VPS)

434—Clustering

435—IRS Rising Laser Gyro

436—Inertial Reference System (IRS)

437—MEMS Accelerometer Gyroscope Management System

438—Piezo Electric Vibration Sensor System (PEVS)

439—Unmanned Traffic Management Fleet System (UTM)

440—Air Navigation Service Provider (ANSP)

441—United States Postal Service (U.S.P.S.) System

442—Third Party Carrier System Integrations

500—Weather Station:

501—Thermometer;

502—Sky Cam;

503—Anemometer;

504—Barometer;

505—Digital Rain Gauge;

506—Lightning Detector;

507—Frequency-Hopping Spread Spectrum Radio;

508—AWOS—Automated Weather Observing Systems;

509—ASOS—Automated Surface Observing Systems;

510—AWSS—Automated Weather Sensor System;

511—LLWAS—Low Level Wind Shear Advisory System;

512—Ceilometer;

513—Radar;

514—Satellite;

515—Hydrometer-Humidity Sensors;

516—Hail Pads;

517—Pyranometer;

518—Disdrometer;

519—Transmissometer.

600—Methods of mobile and cloud-based payment services:

601—Merchant Credit Card Services;

602—Block Chain Services;

603—Crypto Currency Services;

604—PayPal Services;

605—Direct Checking and Savings Services;

606—E-Commerce Services;

607—In-house and Third-Party (i.e. Groupon) Rebates, Coupons, Incentive Credits and Code Services;

608—Third-Party Digital Ticket Purchases (e.g., Ticket Master, Eventbrite);

609—Apple Pay;

610—G Pay (Google Pay);

611—Amazon Pay;

612—Walmart Pay;

613—All other Third-Party E-Wallets.

700—End-User

701—Mechanical Components for Delivery

702—Smart HVAC Shipping Container

702A—Disposable Drone Shipping Container Delivery Box in various sizes, material, thickness and shapes

702B—Disposable and Reusable Hybrid Drone Shipping Container Delivery and Landing Pad in various sizes, material, thickness and shapes

703—Smart Drone (Quad, Hexa, Octa, etc.)

703A—Drone third party integration

704—Smart Drone Mailbox Landing Pad

705—Smart Drone Charging Station/Hanger

705A—Smart Drone Charging Station/Hanger De-Ice Anti-Ice Station

706—Smart Parcel Mailbox Landing Pad

707—Smart Hanger Charging, De-Icing and Anti-Icing Station

800—Other systems, previously disclosed in patent applications, are hereby incorporated by reference:

801—LANDING AND TAKEOFF PLATFORM FOR UNMANNED AERIAL VEHICLES (UAVs); U.S. Provisional Patent Application No. 62/272,987; 802—PORTABLE LANDING/TAKEOFF PLATFORM WITH ACCESSORIES FOR UNMANNED AERIAL VEHICLES; U.S. Provisional Patent Application No. 62/292,831;

803—LANDING AND TAKEOFF PLATFORM FOR DRONES UTILIZING THE UNIVERSAL DRONE OPERATING METHOD AND THE RELATED POINT OF SALE SYSTEM; U.S. Provisional Patent Application No. 62/548,937;

804—DRONE DELIVERY CONTAINER; U.S. Provisional Patent Application No. 62/302140;

805—SELF-POWERED, PRODUCT AND FOOD DELIVERY CONTAINER FOR DRONES UTILIZING THE UNIVERSAL DRONE OPERATING METHOD AND THE RELATED POINT OF SALE SYSTEM; U.S. Provisional Patent Application No. 62/544,983;

806—SYSTEM AND METHOD OF PERFORMING CLAIMS AND PUBLIC ADJUSTER SERVICES VIA UNMANNED AERIAL VEHICLES; U.S. Provisional Patent Application No. 62/380,992;

807—CLAIMS ADJUSTMENT DRONE; U.S. Provisional Patent Application No. 62/550,679;

808—THE UNIVERSAL MERCHANDISE, CONSUMABLES AND SERVICES ORDERING SYSTEM AND METHOD FOR COMMUNICATION DEVICES, VIDEO GAMES AND SMART TELEVISION PRODUCTS; U.S. Provisional Patent Application No. 62/398,482;

809—POINT OF SALE SYSTEM FOR ORDERING PRODUCTS AND SERVICES DELIVERABLE VIA DRONE; U.S. Provisional Patent Application No. 62/560,085;

810—SYSTEM FOR DISPATCHING UNMANNED AERIAL VEHICLES (UAV) TO SOURCES OF 911 EMERGENCY CALLS AND METHOD OF FACILITATING COMMUNICATIONS BETWEEN THE UAV AND THE RESPONDING EMERGENCY PERSONNEL; U.S. Provisional Patent Application No. 62/415,955;

811—SYSTEM AND METHOD FOR ALERTING AND DISPATCHING UNMANNED AERIAL VEHICLES TO LOCATIONS OF ACCIDENTS AND NATURAL DISASTERS; U.S. Provisional Patent Application No. 62/573,001;

812—UNIVERSAL LOGISTICS OPERATING SYSTEM AND METHOD FOR UNMANNED AREAL VEHICLES; U.S. Provisional Patent Application No. 62/426,911;

813—OPERATING SYSTEM FOR DRONES PROVIDING SERVICES AND DELIVERING FOOD/PRODUCTS; U.S. Provisional Patent Application No. 62/588,803;

814—UNIVERSAL, AUTOMATED SYSTEM FOR DOCKING, CHARGING AND LAUNCHING UNMANNED AERIAL VEHICLES (UAV); U.S. Provisional Patent Application No. 62/503,634;

815—MAILBOX/CHARGING STATION FOR UNMANNED AERIAL VEHICLES (UAV) UTILIZING THE UNIVERSAL DRONE OPERATING SYSTEM; U.S. Provisional Patent Application No. 62/536,590.

900 Additional Vendor-User, Smart Drone Rooftop Airport, Smart Drone Ground Airport Infrastructure Features and Options.

901—Quick Drone Battery Change Station

902—Smart Mailbox Landing Pad

903—External Camera Rooftop Airport Monitoring

904—Internal Camera Drone Monitoring

905—External Rooftop Airport Lighting System

906—Biochip Wireless Communication Devices

907—Point of Sale Module (POS)

908—Drone Shipping Container

909—Ground Control Station Module

910—Drone System Services Network

911—Controller Reservation and Take-Off Implementation Module

912—Smart Refrigerators

913—Smart Doorbell Video/Audio Camera

914—AI Autonomous Air Traffic Control (ATC)

915—Commercial Interior/Exterior Drone Elevator for departure and arrival port

915A—Commercial Interior/Exterior Drone Shaft System for departure and arrival port for exit/entry of building at rooftop for smart drone rooftop airport

915B—Commercial Automated Rooftop Door System for departure and arrival port exit/entry of building at rooftop for smart drone rooftop airport

916—Solar Utility System for electric resource

917—Water Utility System Integration

918—Gas Utility Drone Fuel System Integration

919—Hydrogen Fuel Cell Drone System Integration

919A—Hydrogen Oxygen Electric Hybrid Drone Fuel Cell System Integration

920—Micro Controller Unit (MCU)

921—Unmanned Ground Vehicle (UGV)

921—VeriPort

922—HeliPort

923—Vertical Take-Off and Landing Vehicle

924—An R-Client, or rooftop client, is located on the rooftop with the controller. R-clients include non-optional and optional modular feature integrations of:

925—Smart Rooftop Landing Pads,

926—Smart Rooftop Landing/Charging Stations,

927—Smart Rooftop Storage/Charging/De-Icing/Hanger Stations,

928—Rooftop Delivery Storage Containers,

929—Hail Pads, Rooftop Quick Change UAS Battery Stations,

930—Air Navigation Service Provider Devices (ANSP) Systems,

931—4G.

932—4G LTE,

933—5G

934—Air-to-Ground and Air-to-Air Systems,

935—NextGen Weather Station Systems,

936—Weather Data Equipment and Collection hubs (Anemometer, Thermometer, Barometer,

937—Digital Rain Gauge,

938—Lightning Detector,

939—Automated Weather Observing Systems(AWOS),

940−Automated Surface Observing System (ASOS),

941—Automated Weather Sensor System (AWSS),

942—Low Level Wind Shear Advisory System (LLWAS),

943—Ceilometer,

944−Frequency Hopping Spread Spectrum Radio(FHSS),

945—Code Division Multiple Access(CDMA),

946—RADAR,

947—Light Detecting and Ranging (LiDAR),

948—Infrared, Sonar Object Detection Device(SOD),

949—Radio Frequency Device(RF),

950—Radio Frequency Identification Devices(RFID),

951—Static and Dynamic Quick Response Devices (QR Codes),

952—Solar Panels,

953—Active Digital Distributed Antenna System (DAS),

954—Near Field Communication Antenna (NFC),

955—Wireless Fidelity Wireless Internet System (Wi-Fi),

956—Wi-Fi router,

957—Global Positioning Transmitting System (GPS),

958—Global Air Traffic Surveillance System Devices (GATSS),

959—Inertial Reference System Devices (IRS),

960—Unmanned Aerial System Service Supplier (USS),

961—International Mobile Subscriber Identity (IMSI)

962—Anti-Catchers (Cell Tower Simulators) Systems,

963 —Wide-Area Augmentation System (WAAS),

964—NFC antenna, Bluetooth Antenna,

965—Low Wind Antenna,

966—C-RAN Antenna System,

967—Massive MIMO,

968—Common Public Radio interfaces, (CPRI),

969—Baseband Unit (BBU),

970—Base Station,

971—Base Transceiver System (BTS),

972—Coordinated Multi-Point (CoMP),

973—Beamforming Hardware,

974—Transport Extension Nodes (TEN),

975—Central Area Nodes (CAN),

976—Carrier Access Point (CAP),

977—Wide-Area Integration Node (WIN),

978—Voltage Standing Wave Radio (VSWR),

979—Wireless Broadband WiMAX,

980—Zigbee Wireless Devices,

981—Spectrum Access Systems (SAS),

982—Multi-Tenant Data Center (MTDC),

983—Citizens Broadband Radio System Device (CBRS),

984—C-UAS/C-UAV, (Counter Anti-Drone Devices),

985—Anti EMP Devices,

986—Internet of Things Devices (IoT),

987—Dedicated Short Range Communication Devices (DSRC),

988—Drone to Drone Communication Devices (D2D),

989—Drone Landing Pad Communication Devices (D2L),

990—Drone to Infrastructure Communication Devices (D2I),

991—Drone to Drone Single-Hop Broadcasting Devices,

992—Drone to Drones Multi-Hop Broadcasting Devices,

993—Drone Platooning Devices,

994—Sensors,

995—Intelligent Lighting,

996—Blockchain Devices,

997—Telemetry Devices,

998—Sky Cam Cameras,

999—Security Cameras,

1001—Vision Process Systems (VPS),

1002—Real World Interface (RWI),

1003—Extended Kalmen Filter (EKF),

1004—Simultaneous Localization and Mapping Devices (SLAM),

1005—Fast Lightweight Autonomy System (FLA),

1006—Random Sampling Consensus Devices (RANSAC),

1007—Laser Scanner,

1008—US Data Exchange Devices (USDE),

1009—Low Altitude Authorization and Notification Capability Devices (LAANC),

1010—Urban Air Mobility Eco-System Devices (UAM),

1011—Real Time Locating System (RTLC),

1012—Asset Tracking Label System Devices (ATL),

1013—Barcodes,

1014—Servers,

1015—Auxiliary Energy Systems,

1016—Unmanned Traffic Management devices (UTM),

1017—FANS-1,

1018—FANS-1/A Systems,

1019—FANS Router,

1020—FAN enabled Avionics, Edge Computing Systems,

1021—Cloud Systems, Multi-Cloud Systems,

1022—Local Cloud Systems, Distributed Cloud Systems,

1023—Hybrid Cloud Systems,

1024—Compute Edge,

1025—Device Edge,

1026—Sensor Edge Systems,

1027—Machine Learning Systems, Augmented Reality (AR)

1028—Virtual Reality (VR)

1029—Mixed Reality (MR) Systems,

1030—Artificial Intelligence (AI) Systems,

1031′—High Performance Networking (HPN) Systems,

1032—Internet of Things (IoT) Systems,

1033—Predictive Maintenance Systems,

1034—Asset Optimization Systems,

1035—Cognitive Analytic Systems,

1036—Industrial Internet of Things (IIoT) Automation Systems,

1037—Digital Operations Systems,

1038—DigitalOps Systems,

1039—DigiOps Systems,

1040—VMWare Systems,

1041—Public and Workforce Safety and Efficiency Systems

1041—Smart City System Integration Services.

1042—Helicopter Emergency Medical Services Tool (HEMST)

1100—Cyber and Network Security

1101—AWS=Amazon Web Services

1102—AWS EC2=web service that provides secure, resizable compute capacity in the cloud. It is designed to make web-scale cloud computing easier for developers

1103—AWS EBS=Amazon Elastic Block Store

1104—AWS VPC=Amazon Virtual Private Cloud

1105—AWS S3=Amazon Simple Storage Service

1106—AWS Route S3=highly available and scalable cloud Domain Name System

1107—AWS Shield=managed Distributed Denial of Service (DDoS) protection service

1108—VPN=Virtual Private Network

1109—AWS Direct Connect=a cloud service solution that makes it easy to establish a dedicated network connection from your premises to AWS

1110—IPSEC=secure network protocol suite that authenticates and encrypts the packets of data to provide secure encrypted communication between two computers over an Internet Protocol network. It is used in VPNs

1111—IAM=Identity and Access Management

1112—WAF=Web Application Firewall

1113—AWS Cloudwatch=monitoring and observability service

1114—Unified view of operational health

1115—AWS CloudFront=Fast Highly secure Content Delivery Network

1116—AWS CloudTrail=AWS activity and Application Programming Interface usage monitoring

1117—AWS IoT=broad and deep IoT services, from the edge to the cloud. Device software,

1118—FreeRTOS and AWS IoT Greengrass, provides local data collection and analysis

1119—AWS RDS=Amazon Relational Database Service (Amazon RDS) makes it easy to set up, operate, and scale a relational database in the cloud. It provides cost-efficient and

1120—resizable capacity while automating time-consuming administration tasks

1121—Cisco CSR=cloud services router

1122—Web UI=Web User Interface

1123—Web API=Web Application Programming Interface

1124—Web Servers=Front End Web Application Servers

1125—NIST, DISA, STIGs, and SANs Guidance for Risk Assessment on all Software/Hardware, including OS.

1126—Endpoint Protection (Carbon Black, Cylance, Symantec, Norton, etc.)

1127—VPN, Direct Connect -IPSEC Tunnel Fiber, HTTPS and Configuration Service

1128—IDS & IPS & WAF/DAM, Anti-Phishing protection in email client/GPO

1129—AWS—IAM—KMS Key Management Service

1130—AWS Shield Advanced—Defends against layer 7 attacks like HTTP flood attacks that overwhelm an application with HTTP GET or POST requests, +Elastic IP Address

1131—AWS WAF—Load balancer & Cloud front Or (Imperva Incapsula)

1132—Lamda Fuction to check a list of known Malicious IP addresses

1132—Lamda Function to analyze Web Traffic that generates bad or excessive requests (HTTP Flood attack indications) and add to a block list.

1133—SANS config for AWS WAF, OWASP top 10 rules

1134—Amazon Guard Duty—Route 53, VPC Flow Logs, CloudTrail event logs looking for known malicious IP addresses, domain names and potentially malicious activity

1135—Amazon Inspector—EC2

1136—Cl/DI Pipeline: AWS CodeCommit, automate with or tools like Jenkins . . . ;

1137—Add Static Code Analysis (SCA) using a tool like Micro Focus Fortify SCA [BUILD Stage] and/or Veracode and before getting to Source Code repository and/or IAST (Contrast Assess in dev environment)

1138—Dynamic Application Security Testing DAST/IAST[TEST stage], Burp Suite Pro/Micro Focus Web Inspect, Contrast Assess

1139—Runtime Application Self Protection (RASP) (ex: Imperva Prevoty, Contrast Protect, Micro-Focus AppDefender) on Pre-Production and Production Application Servers

1140—Data layer Compliance Checks using tool like Trustwave App Detective Pro

1141—Missuse or Theft of Data. Network Access Control List and Security Groups and Encryption of Data At Rest and in RDBMS SQL Server can encrypt in flight

1142—End to End Encryption in flight and Encryption of Data at rest in S3, Elastic (EBS), Elastic File System or Relational Database Service (RDS) Database

1143—S3 Server side encryption with S3 managed, KMS or DIS Provided key & DIS KMS

1144—Framework Compliance—PCI-DSS and AWS—FedRamp approved.

1145—AWS Config, and encryption at rest and in flight using NIST FIPS 140-3, 140-2 implementations, reach for NIST 800-53 and OWASP ASVS Level 3

1146—Ensure Static Cod Analysis, Database Security Analysis, and Interactive and Dynamic Application Security Test Pass Compliance for PCI-DSS

1200—Agnostic Microservices Platform

1201—TLS 1.2

1202—TLS 1.3

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “vehicle” may be used to describe unmanned vehicles configured to operate via ground, air, and marine modes of transportation and combinations thereof, including by way of non-limiting examples: unmanned aircraft systems (UAS), unmanned aircraft vehicles (UAV's), vertical take-off and landing vehicles (VTOL's), electric vertical take-off and landing vehicles (eVTOL's), vertical short take-off and landing vehicles (VSTOL's), short take-off and landing vehicles (STOL's), electric take-off and landing vehicles (eSTOL's), conventional take-off and landing vehicles (CTOL's), electric take-off and landing vehicles (eCTOL's), autonomous vehicles (AV' s), connected and autonomous vehicles (CAV's), passenger air vehicles (PAV's), electric passenger air vehicles (ePAV's), heliports, vertiports, and the like. One skilled in the arts will readily understand that various additional forms of land-operating vehicles, aircraft, watercraft, railcars, and the like may be utilized with the embodiments provided herein.

The present invention discloses a UAS/UAV rooftop DronePort/AirPort, comprising charging, de-icing, anti-icing, storing and parking garage/hanger station, which shall be provide the following capabilities: Drone on demand delivery services; Drones are parked, stored and or charging in the drone garage and or on a drone landing pad; Orders are made via mobile, land, and TV applications using wire and or wireless connections; Drone AI Cloud (Artificial Intelligence Cloud) figures out if the weather permits deliver to and from the location requested at the time requested; Drone AI Cloud will figure out which drone is available, using the fastest, most convenient, safest and properly equipped drone for the weather conditions, payload requirements, and any other specific demand option(s).

The UTM deploys the Drone to the Landing pad for loading/unloading, drop off and pickup; The drone is loaded and departs to its destination; The Drone delivers arrives at its destination, confirms the receiver of the package, releases the product to the consumer and informs the POS that the order has been delivered; The Drone AI then selects either the drone's next destination for charging, based upon its remaining battery use, sends it to its next order, or parks it at the nearest Drone AirPort Parking Station where it can recharge and wait for further instructions.

All Rooftop UAS/drone hardware, exterior and or interior equipment and landing pad equipment will have a water proof option such as superhydrophobic (water) and oleophobic (hydrocarbons) coating, that will completely repel almost any liquid and or nanotechnology coating, to coat an object and create a barrier of air on its surface.

All UAS/Drone(s) that deploy will have the option to use UAS/UAV de-icing inflatable boot equipment on the leading and trailing edges(s) of the propeller arm(s). All UAS/drone hardware will have impact protections options, using products like Mashable D30 Crystalex clear formable elastomer material for protective gear on the UAS/drone for drop test crash resistances.

All UAS/drone hardware will have nanocrystalline metal alloy options for a lighter, stronger, and more efficient UAS.

The Smart Drone Airport System has been designed to provide options for the following delivery services: 1) Less than Load Delivery (LTL); 2) Document delivery services; 3) Distribution Center Delivery; 4) Freight on Board(FOB); Cost, Insurance, and Freight (CIF); 5) Cost, No Insurance, Freight (CNF), Delivery Services; 6) Rideshare Package Delivery; 7) Rideshare Person Delivery; 8) Ride Hailing; 9) On Demand Location and Service based UAS/Drone Hiring; 10) Private and Public Use Hiring; 11) Take Away Delivery Services; 12) Parking, Storing, Garaging, Charging, De-icing, Anti-Icing, Docking Services; 13) Warehousing Delivery; and 14) Customs and Port Security Delivery Drop Offs 15) Perishable and Non Perishable foods and product Delivery; 16) Special Product Temperature and Packaging Deliveries such as Medical Prescriptions, Lab Testing Kits and Test Results.

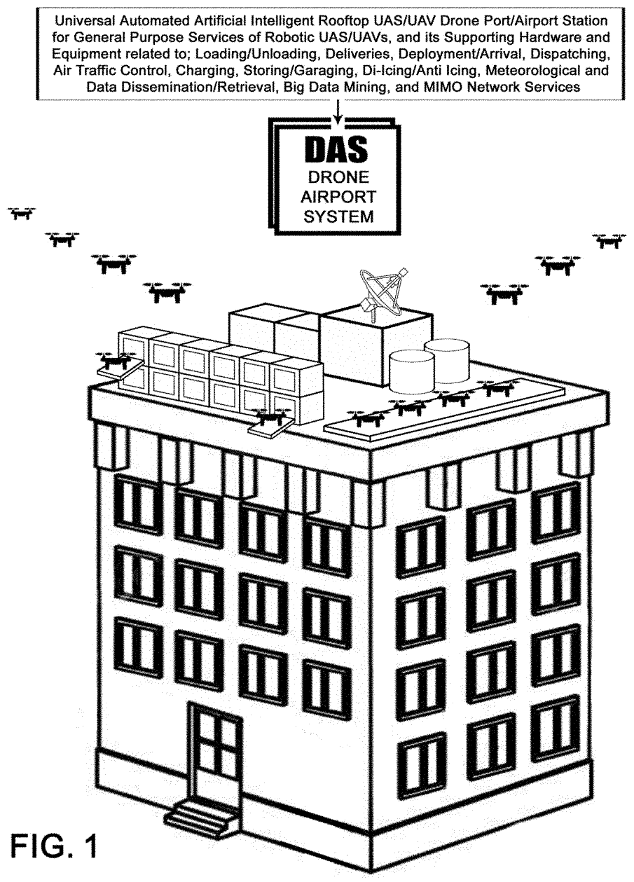

As shown in FIG.1, the Smart Drone Airport System is illustrated operating from a rooftop of a commercial building. Visible are two rows of stackable, drone garage systems, two liquid tanks containing the de-icing/anti-icing agent, landing pad, radar system, and communications systems. The airport also contains a drone loading/unloading landing pad station system, which may be used for manual battery swaps and as a cleaning station.

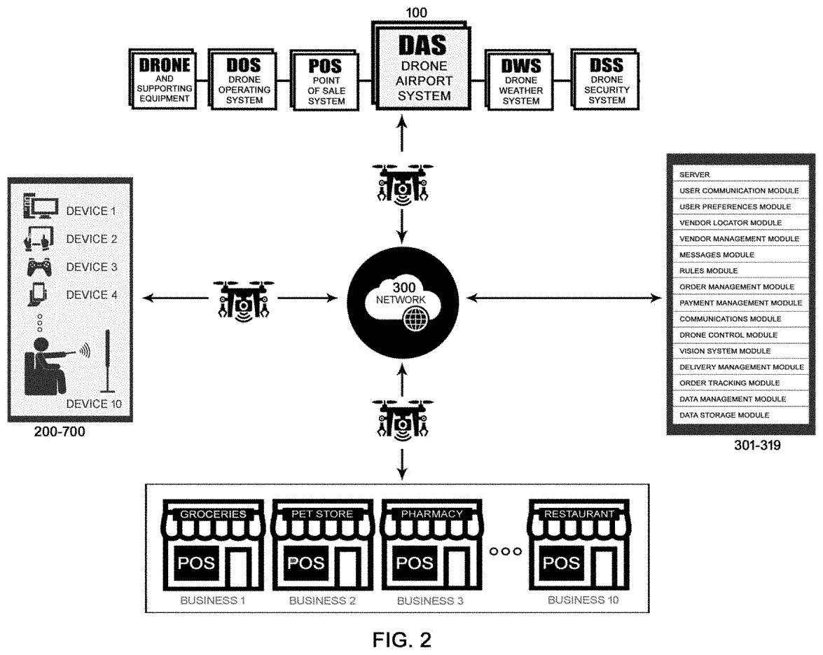

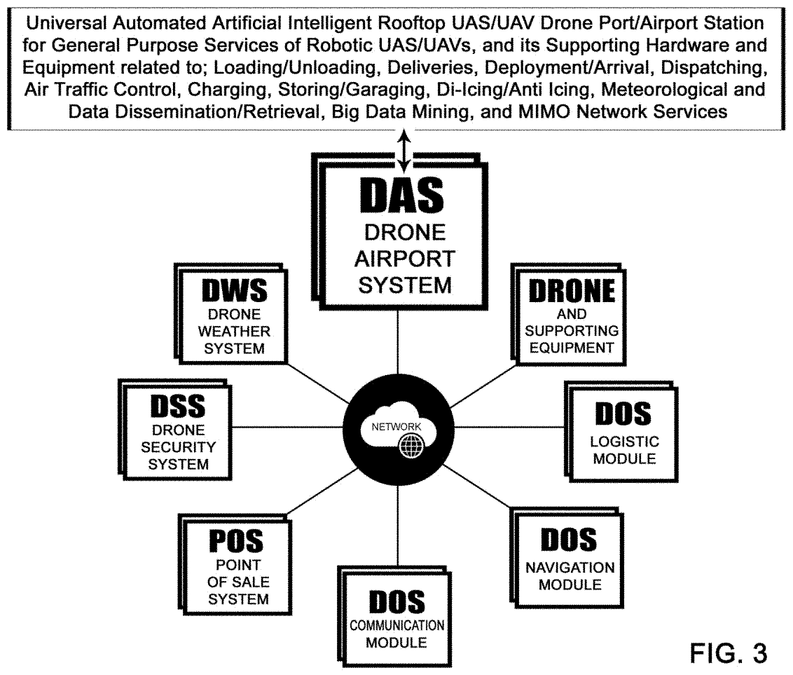

As shown in FIG. 2 and FIG. 3, the Smart Drone Airport System (SDAS) relies on a fast cloud-based Unmanned System Service Network (US SN) consisting of nodes and services, using but not limited in this description, GPS, Massive MIMO 4G, 4G LTE, and or 5G, to maintain constant, and reliable communications with drones and other interactive components, such as business entities and end-user wired/wireless communication devices. The network must also be able to maintain a reliable connection with the server and be agnostic with various supportive systems, including the Drone Operating System, Point of Sale System (POS), Drone Weather System, Drone Security System, Smart Drone Mailbox Landing Pad System, Smart Landing Pad System .

Every object on the DOS, SDAS, and USSN system as an embodiment is a Node, every Node has the following equipment: A 4G, 4G LTE and 5G antenna(s), WiFi antenna, Raspberry Pi or similar SoC computer that can be programmed, a flash card for storage, an IP identifier and Serial Number such as a smart drone landing pad that shall have an address that matches the physical address of the fixed stationed landing pad.. Every Node will have the following Characteristics: Node types- consist of the drone, battery, point-of-sale (POS), rooftop, smart mailbox landing pad, smart delivery container, smart charging/hanger station, landing pads, etc.; The Sector type—will be for special-purpose applications like medical delivery or law enforcement, etc.); Unique 160 ID encryption; Public-Private Key Pair; Public-Key Certificate; Primary Status (available or unavailable); Secondary Status (additional details); Event Log; Schedule of Commitments. Every Node has access to the following services: NextGen Weather Data Streams; ADS-B Data Exchange; GPS; Drone Flight Planner (DFP); Drone Data Exchange (DDE); Drone System State (DSS); Drone Missions Database (DMDB); Device Authentication Authority (DAA) Drone Mission Checker (DMC). Individual Nodes will publish status and event information to the DDE at regular intervals. From this, the current state of the entire system will be built and updated. Users and customers have access to another service called the Drone Request System (DRS) through which they can hail services.

Vendor Pizza Delivery Request Order and Delivery Case Sample. 1) Mike orders a pizza from Tony's Authentic Italian Pizza Pub(TAIP), a point-of-sale (POS) node. Point-of-Sale (POS) can be through a web browser, mobile app, and or land line connection. 2) Tony's Authentic Italian Pizza Pub (TAIP is fictitious) enters the following information in the Drone Request System (DRS): a) Origin of Choice (which and or where TAIP is located); b) Destination (where the customer is located); c) Requested Pickup Time; d) Payload Size, Weight, Content; e) Delivery Container Temperature (ideal range). 3) DRS will ask the DFP to plan the delivery: A) DFP will select a qualified drone based on Rooftop Airport Classification (example: Class B, C, D, E, etc.), Global Air Traffic Surveillance System (GATSS), Urban Air Mobility Eco-System (UAM), Advanced Air Mobility System (AAM), Low Altitude Authorization and Notification Capability (LAANC), US Data Exchange (USDE), type of product being transported, battery availability, charging requirements, landing pad station(s) available, charging stations available, appropriate payload equipment, proximity, departure, en-route, and destination, weather conditions, temporary flight restrictions (TFR), no fly zones, National Air Space (NAS), Advanced Air Mobility (AAM), FAA CFR's, Mandates and Guidelines, Traffic Along the Route, Weather Avoidance, Traffic Avoidance, ATC Clearance, Carrying Capacity, Shipping Container Temperature Requirements, State, Municipal, Local Ordinances, rules, regulations, and laws, Noise Restriction Areas, and any other requirements to maintain compliance. B) DFP will select a path which is the most efficient, cost effective, operable and readily available logistically to and or from the destination that includes, if necessary, charging, frog leaping between Smart Drone Rooftop Airports, battery replacement, and or payload swap locations along the way. It will include in the path a final recharge station, which may be the destination node (if it is a rooftop or mailbox charging pad or charging pad hanger station) or a pad that can be reached by more legs of flight. C) DFP will ask the DAA to verify the authenticity of each device involved in the proposed path (through pubic key certificates or some other challenge-response). D) Once it is confirmed that all targeted nodes are authorized and available, each node will be invited to be a participate. i) Each node will verify that the invitation came from a trusted node. ii) Each node will accept or reject the invitation can from a trusted node. iii) Each node will update its on-board schedule of commitments. E) DFP will send the flight itinerary to the selected drone. F) DFP will update the Drone Mission Database (DMDB) with the itinerary and start time. 4) Drone Flies Mission. A) Armed with the itinerary; it flies the first leg of the flight to get to TAIP. B) It arrives at TAIP. i) Worker attaches payload to drone via automated system or by manual application. This payload will be a container which will hold the product and can be either a non-disposable container or a disposable container, depending on the use, payload delivered and or special request. ii) If part of the itinerary, based on availability, a smart auto swap battery station will swap the battery pack, or a designated and qualified worker will manually swap the battery pack. C) TAIP's as a point-of-sale node, updates its schedule of commitments and log to indicate that part of its responsibilities has been completed. D) Drone flies the next of what may be multiple legs of the mission. i) It consults its itinerary to see which node is next. ii) It communicates in an authenticated way to ensure that the next node is ready for its arrival. iii) As it arrives at other node, they update their schedule of commitments and activity logs. iv) If, along the way, the node finds that it must update its itinerary because a node that had been included is no longer available, it will ask the DFP to update the itinerary, and the changes will be pushed to the drone and affected downstream nodes. E) When the drone arrives at the destination node, the delivery will be made, the end user will authenticate the receiving of the delivery via mobile app or mobile phone, the Drone will open the Smart Container or Smart Mailbox Landing Pad or Smart Parcel Mailbox Landing Pad, the receiving party or Smart Parcel Mailbox Landing Pad or Smart Parcel Mailbox Landing Pad, will close the container or accept the disposable container, the Drone Missions Database (DMDB) will be updated to record the finished mission, and the Drone will either charge there or move on to the recharge station if the destination is not capable of recharging the node.

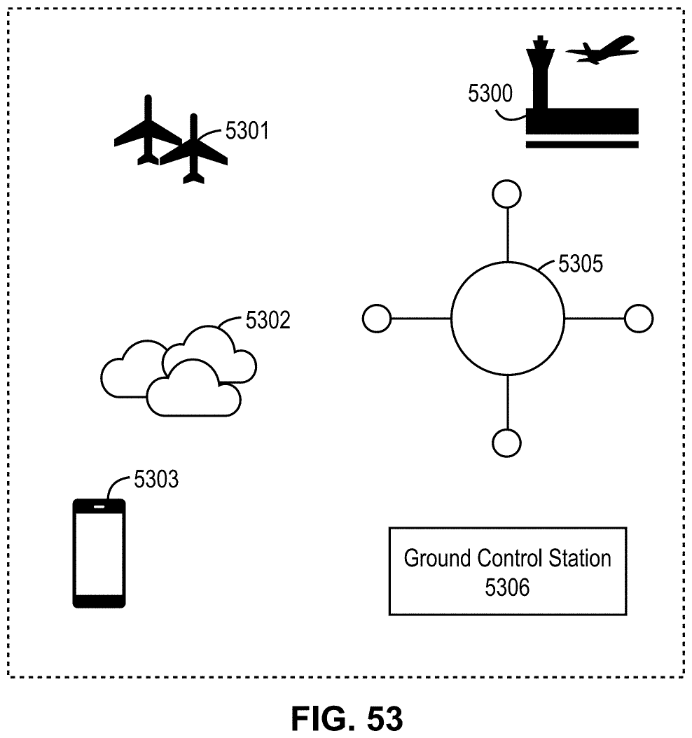

Weather, Traffic, ATC, TFR, etc., Causes a Denial for UAS Flight. Should the UAS Delivery not meet the permissions which provide an authentication for flight, the Controller will provide for the following options by redirecting to the Vehicle Fleet Management (VFM) Operating System Module, which offers four services: 1) Vendor In-House Manned Vehicle Delivery Service; 2) SDAS In-House Autonomous Unmanned Ground Vehicle (UGV) Hailing Service; 3) Third Party Manned Vehicle API App Hailing Service; 4) Third Party Autonomous Unmanned Ground Vehicle (UGV) Hailing Service using a Third Party API App. See Diagram Illustration FIG. 53-56.

FIG. 57 is the Node Diagram related to the R-Client, E-Client and Controller. This illustration demonstrates and depicts the nodes as being named a drone, POS, Rooftop, Client, etc.

FIG. 58 is a High Level Cyber Security and Network Architecture for the Smart Drone Rooftop Airport done in Visio.

Unmanned System Services Network (USSN). USSN for Smart Drone Rooftop DronePort/AirPort' s is used to enable the communications necessary to support a robust Drone or Unmanned Aerial Vehicle (UAV) or Unmanned Ground Vehicle (UGV) or Vertical Take-Off and Landing Vehicle (VTOL), etc's. facilities. The USSN has been designed to achieve the following goals: A) flexibility: the network is agnostic and can support a wide variety of data communications and platforms such as DaaS, IaaS, PaaS, SaaS, RaaS, C-RAN, allowing for open platform integration and SDK Software Development; B) Extensibility: New kinds of devices and components can be integrated into the network readily and inexpensively; C) Security: All communications will be encrypted for Confidentiality and signed so that components will authenticate themselves to the USSN and to each other; D) Performance: Data Exchange will occur efficiently when and where it is needed so that components can perform their intended functions. E) Scalability: The hardware and software are modular and can integrate in its physical and vertical form and nature, which can integrate into the network readily and inexpensively. This will allow for easy maintenance, data machine monitoring, and replacement or upgrades. Devises and components will provide for private use and or integrated interoperability. Software (closed-platform, open platform, hybrid platform, embedded software), Firmware, Cloud Computing (DaaS, IaaS, PaaS, SaaS, RaaS, C-RAN), PoE, IoT, APIs, MDK, SDK, GUI, CLI, AI, VR, AR, MR, Data Performance, Data Sharing and Date Processing, MbedOS, SoCs, iSIM, eSIM, SAS, CBRS, Block Chain, Telematics, Smart City, Smart Building, Smart Mailbox, Smart UAS, UAV/VTOL/Heliport/VeriPort, Rooftop Airports, NexGen 4Cube, Meteorology Equipment, Landing Pad, Smart Mailbox Landing Pad, and Parcel Landing Pad Equipment, etc.

USSN Architecture. The USSN consists of nodes. The are three types of nodes: Controllers, rooftop clients (R-Clients, and Extended Clients (E-Clients). Each Smart Drone Rooftop DronePort/AirPort will employ one controller node and as many client nodes as the rooftop can accommodate based on government compliance and class approvals. The controller provides services to the client nodes and serves as the smart drone rooftop airport's central point of contact. The controller node sends commands and configuration information to the client nodes and receives data and service requests from them. The controller and client communicate with each other over a TCP-IP and or Wi-Fi Network. The controller node communicates with devices beyond the rooftop using a 4G, 4G LTE, or 5G mobile data network. FZIG. 57 shows the design of a USSN using names of nodes in action.

USSN Controller Node Architecture. The Controller Node consists of an Internet-Connected Computer, Authentication Fob, GPS Transmitter, and Mobile Network Antenna. The computer and authentication fob are housed in a theft-proof, environmentally hardened container. The authentication fob is a USB key containing the Controller's 160-bit identification number (ID) and private RSA key. The controller runs a modern commercial-grade operating system that hosts the following: 1) a Wi-Fi router with managed IP address assignment; 2) a web server configured with the controller's public key certificate; 3) a database server; 4) a web application featuring a RESTful API, through which r-clients and e-clients may request reservations, data and other services; 5) an Event Logger; 6) a Fees Ledger for keeping track of takeoff and landing fees to collect; 7) an R-Client Inventory Tool, used to keep track of the R-Clients the controller manages; 8) an R-Client Messenger Tool for communicating instructions and data with R-Client.

USSN R-Client Part 1. An R-Client, or Rooftop Client, is located on the rooftop with the Controller. R-Clients include non-optional and optional modular features from both the provisional patent filing incorporated herein, plus the integration options of: Rooftop Landing Pads, Rooftop Landing/Charging Stations, Rooftop Storage/Charging/Delcing/Hanger Stations, Rooftop Delivery Storage Containers, Hail Pads, Rooftop Quick Change UAS Battery Stations, Air Navigation Service Provider Devices(ANSP) Systems, 4G. 4G LTE, and 5G, Air to Ground and Air to Air Systems, Next GEN Weather Station Systems, Weather Data Equipment and Collection hubs (Anemometer, Thermometer, Barometer, Digital Rain Gauge, Lightning Detector, Automated Weather Observing Systems(AWOS), Automated Surface Observing System (ASOS), Automated Weather Sensor System (AWSS), Low Level Wind Shear Advisory System (LLWAS), Ceilometer), Frequency Hopping Spread Spectrum Radio(FHSS), Code Division Multiple Access(CDMA), RADAR, Light Detecting and Ranging(LiDAR), Infrared, Sonar Object Detection Device(SOD), Radio Frequency Device (RF), Radio Frequency Identification Devices(RFID), Static and Dynamic Quick Response Devices (QR Codes), Solar Panels, Active Digital Distributed An tenna System (DAS), Near Field Communication Antenna (NFC), Wireless Fidelity Wireless Internet System (Wi Fi), Wi Fi router, 4G, 4G LTE and 5G Devices, Global Positioning Transmitting System(GPS), Global Air Traffic Surveillance System Devices(GATSS), Inertial Reference System Devices (IRS), Unm ann ed Aerial System Service Supplier (US S), International Mobile Subscriber Identity (IMSI) Anti Catchers (Cell Tower Simulators) Systems, Wide Area Augment ation System (WAAS), NFC antenna, Bluetooth Antenna, Low Wind Antenna, C RAN Antenna System, Massive MIMO, Common Public Radio interfaces,(CPRI), Baseband Unit(BBU), Base Station, Base Transceiver System(BTS), Coordinated Multi Point ( CoMP), Beamforming Hardware, Transport Extension Nodes (TEN), Central Area Nodes(CAN), Carrier Access Point(CAP), Wide Area Integration Node(WIN), Voltage Standing Wave Radio(VSWR), Wireless Broadband WiMAX, Zigbee Wireless Devices, Spectrum Access Systems(SAS), Multi-Tenant Data Center (MTDC), Citizens Broadband Radio System D evice(CBRS), CUAS/CUAV, (Counter Anti Drone Devices), Anti EMP Devices, Internet of Things Devices(IoT), Dedicated Short Range Communication Devices (DSRC), Drone to Drone Communication Devices (D2D), Drone Landing Pad Communication Devices (D2L), Drone to Infrastructure Communication Devices (D2I), Drone to Drone Single Hop Broadcasting Devices, Drone to Drones Multi Hop Broadcasting Devices, Drone Platooning Devices, Sensor s, Intelligent Lighting, Blockchain Devices, Telemetry Devices, Sky Cam Cameras, Security Cameras, Vision Process Systems(VPS), Real World Interface(RWI), Extended Kalmen Filter(EKF), Simultaneous Localization and Mapping Devices (SLAM), Fast Lightweight Autonomy System (FLA), Random Sampling Consensus Devices (RANSAC), Laser Scanner, US Data Exchange Devices (USDE), Low Altitude Authorization and Notification Capability Devices (LAANC), Urban Air Mobility Eco System Devices (UAM), Real Time Locating System(RTLC), Asset Tracking Label System Devices(ATL), Barcodes, Servers , Auxiliary Energy Systems, Unmanned Traffic Management devices (UTM), FANS 1, FANS 1/A Systems, FANS Router, FAN enabled Avionics, Edge Computing Systems, Cloud Systems, Multi Cloud Systems, Local Cloud Systems, Distributed Cloud Systems, Hybrid Cloud Systems, Compute Edge, Device Edge, and Sensor Edge Systems, Machine Learning Systems, Augmented Reality (AR)/Virtual Reality(VR)/Mixed Reality(MR) Systems, Artificial Intelligence (AI) Systems, High Performance Networking (HPN) Systems, Internet of Things(IoT) Systems, Predictive Maintenance Systems, Asset Optimization Systems, cognitive analytic systems, Industrial Internet of Things (IIoT) Automation Systems, Digital Operations Systems, DigitalOps Systems, DigiOps Systems, VMWare Systems, Public and Workforce Safety and Efficiency Systems.

USSN R-Client Part 2. Satellite Based Augmented System (SBAS) integration modulation that supports Wide Area or Regional Augmentation Worldwide: A) North America-Wide Area Augmentation System (WAAS); B) Europe-European Geostationary Navigation Overlay Service (EGNOS); C) Japan-Multi-Functional Satellite Augmentation System (MSAS); D) India-GPS Aided Geo-Augmentation Navigation (GAGAN). The technology is a critical component of the FAA's Next Generation (NextGen) program and the EUROCONTROL SESAR initiative. “Upgrading” to SBAS involves replacing an existing Flight Management System (FMS) with a new SBAS-capable FMS (Flight Management System). As an in-line replacement, the Universal Avionics SBAS-FMS constitutes minor changes to wiring, antenna, keying and configuration when certified for most LPV Capabilities. Still, most of the existing wiring may be used. Non-LPV SBAS-FMS installations have lesser changes.” However, direct installation of an SBAS on a UAS Rooftop Airport allows for the FAA NextGen with no “Upgrading”.

USSN R-Client Part 3. SBAS allows for National Air Space (NAS) integration of Aircraft and Helicopter Transportation with UAS, UAV, VTOL, CTOL, STOL, HeliPort, Vertiport Rooftop DronePort/AirPorts integration modulation. Approved GPS position input source in accordance with the appropriate TSO for integration with approved transponders for the ADS-B Out mandate compatible with SBAS around the world: WAAS, EGNOS, MSAS and GAGAN. This ensures compliance with Precision-Area Navigation (P-RNAV). Key element of Performance-Based Navigation (PBN) and Required Navigation Performance (RNP)/Area Navigation (RNAV). This allows for user-friendly use with more capabilities to reduce pilot work load for hybrid autonomous and manual pilots and increase flight operations efficiently for unmanned aircraft with every new Universal Avionics SBAS-FMS installation and major hardware upgrade. Enhanced safety provided with the latest TSO'd more accurate SBAS and GPS information to the onboard TAWS/EGPWS and TCAS. This eliminates manual RAIM prediction requirements, incorporates high-speed Ethernet technology that allows for faster data downloads via the Solid-State Data Transfer Unit (SSDTU). Low-Level and High-Level Rooftop Airports can provide for direct routing and direct approaches that eliminate the step-down type approaches. This will allow for shorter routing to secondary airports due to adverse weather conditions that will be provided by our Rooftop Meteorology Equipment and or NAS available third-party services. Drones will be equipped with ADS-B to have the ability to receive traffic information, weather data and flight information. Virtual Airways that may be designated by the Department of Transportation, FAA and or other government bodies for Drones will be integrated in USSN as a R-Client Virtual Drone Airway (VDA). The Smart Drone Rooftop DronePort/AirPorts will be able to seamlessly integration with the key component of Universal Avionics Future Air Navigation System (FANS) solution.

USSN R-Client Part 4 FANS. The Future Air Navigation System (FANS) integration modulation will provide: A) an option for direct data link communication between the pilot, remote pilot and the Air Traffic Controller (ATC); B) Aircraft Communications Addressing and Reporting System (ACARS) communications (Satellite-based); C) Communication, Navigation and Surveillance (CNS)/Air Traffic Management (ATM) for Air Traffic Service (ATS) Providers; D) Data Link Service Providers (DSP)/Communication Service Providers (CSP). Radio or satellite technology (SatCom) issued to enable digital transmission of short, relatively simple messages between the aircraft, UAS, UAV, VTOL, CTOL, STOL, Heliport, Veriport's and ground stations. Communications typically include the traditional: air traffic control clearances, pilot requests, and position reporting. The goal of FANS is to improve performance related to Communication, Navigation and Surveillance (CNS)/Air Traffic Management (ATM) activities within the operation environment. Through a satellite data link integration feature, airplane Drone UAS, UAV, and VTOL equipped with FANS can transmit Automatic Dependent Surveillance (ADS) reports with actual position and intent information at least every 5 minutes. This can provide for Real time Enroute and Re-Route AI Weather Reporting feature from FANS and NextGen to and between Airplanes, Drones, UAS, UAV, and VTOL Aircraft.

USSN R-Client Part 5. Additional Integration modulation for observation, prediction, UAS, UAV,VTOL, CTOL, STOL deployment and third-party services, that will be available with the assistance of UAS/UAV, VTOL, CTOL, STOLs, Meteorological, Networking, and Operating System Equipment, on the Smart Drone Rooftop DronePort/Airport: A) Information Disseminated-from the drone equipped with a drone Anemometer and or Barometer and or IMU, in order to create Drone Aircraft Report (AMDAR), that were deployed from the Smart Drone Rooftop DronePort/AirPort. Common Support Services-Weather (CSS-Wx)—Which publishes info provided by the NextGen weather processor and use of the System Wide Information Management Network, to the FAA and National Airspace System (NAS); B) Observations: through the following: NextGen CCS-Observations-Satellite Imagery; Radar Imagery; Aircraft Reports (AMDAR); Surface Reports (METARS); Upper Air Reports (Balloon Soundings); Numerical Modeling; Statistical Forecasting—NWS Forecasters, Auto Forecast System and Forecast Integration; CoSpa: Consolidation Storm Prediction for Aviation; Storm Prediction Center (SPC); Drone Weather Avoidance Field (WAF and UASWAF) Module—with Drone Deviation Model and Forecast Drone Avoidance Regions Models; Vortex 2 and 3—for Weather Chasing and Reporting with Drones; National Severe Storms Laboratories (NSSL); and Drone Inhouse, Mesonet and or other Third-Party Drone Fleet Data Sharing; and other Smart Devices that collect data and send it to the Controller and that may receive instructions from the Controller.

USSN R-Client Hardware. Each R-Client includes as part of its hardware the following: 1) a system-on-a-chip (SoC) computer, such as a Raspberry Pi, that is equipped with a WiFi Antenna; 2) a USB key that includes the R-Client's 160-bit identification number and private key; 3) an R-Client configuration manager that holds the 160-bit ID and public key of the Controller; 4) an R-Client messenger tool for communicating instructions and data with the Controller; a Wi-Fi router, NFC antenna, and or Bluetooth Antenna to communicate with other R-Client or, for Small Landing Pads/Smart Mailbox and Parcel Landing Pads, Smart Charging Stations, Hangers, HeliPort, VertiPorts for Drones (UAS, UAV, VTOL, etc.), that land on it.

USSN E-Clients. An E-Client, or External Client, is any remote device or application that requests or uses the services of the rooftop airport. Examples of E-Clients include in-flight UAVs, point-of-sale systems, take away delivery apps, API Apps., Flight-Hailing Apps, Public Safety Systems, Amber Alert Systems, Weather-Reporting System and Logistics Operators. E-Clients communicate with Controllers to request services, request data, provide data, arrange flights, and coordinate landings.

Installing a Smart Drone Rooftop DronePort/Airport. The Controller maintains an inventory of R-Clients. R-Clients include rooftop landing pads and other equipment discussed hereinabove associated with the drone services that share the roof. To install a new R-Client, the rooftop operator will: 1) Register the R-Client's 160-bit ID in the Controller's R-Client Inventory System; 2) Register the Controller's ID and public key with the R-Client's configuration manager; 3) Assign the R-Client a fixed IP address through the Controller's Wi-Fi router; and 4) Install the R-Client messenger tool on the R-Client and configure it to communicate with the Controller.

Reserving and Implementing a Takeoff Part 1. A remote requestor uses a web browser or mobile app to connect to the Controller's reservations homepage. User, Pilot and or Controller specifies “takeoff request” as the type of transaction, which of the Controller's available drone models to schedule, destination GPS, and type of payload. The Controller scans its inventory of available drones to identify a match. After asking for and receiving confirmation from the remote requestor, including payment of the fees associated with the takeoff, the Controller, at the designated takeoff time, sends GPS coordinates of the selected UAV's destination to the UAV's host pad through the R client messenger tool. The host pad communicates the GPS coordinates to the UAV and initiates the takeoff. The host pad notifies the Controller that the takeoff occurred. The Controller logs the event in its schedule and resets the R client landing pad's status to available.

Reserving and Implementing Takeoff Part 2. A remote requestor uses a web browser or mobile app to connect to the Controller's reservations homepage. 1) He specifies “takeoff request” as the type of transaction; 2) to which of the Controller's available drone models to schedule, destination GPS, and type of payload; 3) The Controller scans its inventory of available drones to identify a match; 4) After asking for and receiving confirmation from the remote requestor, including payment of the fees associated with the takeoff, the Controller, at the designate takeoff time, sends GPS coordinates of the selected UAV's destination to the UAV's host pad through the R client messenger tool; 5) The host pad communicates the GPS coordinates to the UAV and initiates the takeoff. The host pad notifies the Controller that the takeoff occurred. The Controller logs the event in its schedule and resets the R client landing pad's status to available.

USSN Other Data Requests. Besides landing pads, a rooftop may contain other R clients whose services and/or data external users (E clients) can request. For example, service providers may request low altitude weather data from NextGen weather measurement and data collection devices. To request data from R clients, a would-be consumer will access the Controller's web page to request the desired service/data set. It is up to the owner/configurator of the Controller to decide which services to make available to which E clients and to implement the communications needed to provide the service. Based on that configuration, the Controller and R client will coordinate fulfilling the E clients' request. The Controller serves as the initial point of contact that authenticates and then fulfills the request In-House and Third-Party APIs can be customized for customer needs as well.

USSN Hi Level Cyber Security and Networking Architecture for Smart Drone Rooftop AirPort. All Server, Networks, Nodes, R-Client, E-Client and Controller USSN components, hardware and software will be part of a Cyber Security and Network Architecture. DIS High Level Security Diagram, In House and 3rd APIs can be customized for customer need as well. AWS Security Icon Diagram Legend See Illustration FIG. 58 through 60.

AWS Cyber and Network Security Icon Diagram Legend Definitions (FIG. 60): AWS=Amazon Web Services, AWS EC2 =web service that provides secure, resizable compute capacity in the cloud. It is designed to make web scale cloud computing easier for developers AWS, EBS=Amazon Elastic Block Store, AWS VPC=Amazon Virtual Private Cloud, AWS S3=Amazon Simple Storage Service, AWS Route 53=highly available and scalable, Cloud Domain Name System, AWS Shield=managed Distributed Denial of Service, (DDoS) protection service, VPN=Virtual Private Network, AWS Direct Connect=a cloud service solution that makes it easy to establish a dedicated network connection from your premises to AWS, IPSEC=secure network protocol suite that authenticates and encrypts the packets of data to provide secure encrypted communication between two computers over an Internet Protocol network. It is used in VPNs, IAM=Identity and Access Management WAF=Web Application Firewall, AWS Security Icon Diagram Legend Definitions:, AWS Cloud watch=monitoring and observability service, Unified view of operational health, AWS CloudFront=Fast Highly secure Content Delivery Network, AWS CloudTrail=AWS activity and Application Programming Interface usage monitoring, AWS IoT=broad and deep IoT services, from the edge to the cloud. Device software, FreeRTOS and AWS IoT Greengrass, provides local data collection and analysis AWS RDS=Amazon Relational Database Service (Amazon RDS) makes it easy to set operate, and scale a relational database in the cloud. It provides cost efficient and resizable capacity while automating time consuming administration tasks, Cisco CSR=cloud services router, Web UI=Web User Interface, Web API=Web Application Programming Interface, Web Servers =Front End Web Application Servers

AWS Security and Cloud Diagram. This diagram lays out the Cyber Security and Network System. See FIG. 61, incorporated by Reference.

FIG. 62 is a schematic of the Platform Agnostic for Microservices using TLS 1.2 or Higher

FIG. 63 is a schematic of the DISC System Network and Cyber Architecture Platform. This diagram lays out the Platform Agnostic, Cybersecurity Reference Architecture, Corporate Data Center, High Level Diagram of basic infrastructure, AWS Security and Cloud Diagram, IA Cloud System(s), Firewalls, etc.

FIG. 64 is a schematic of the Unmanned System Service Network (USSN) (or Drone System Service Network—DSSN). This shows the Components, the process and the diagram of communication using the USSN in the DOS and SDAS System.

FIG. 65 is a schematic of a High Level Diagram showing a basic understanding of the involved components in its basic and stripped down form.

Vulnerabilities. Minimize the risk of application level vulnerabilities being introduced and exploited. End user devices: Endpoint protection (Carbon Black, Cylance, Symantec, Norton . . . ), VPN and configuration services. Follow NIST, DISA STIGs, & SANS guidance as much as possible with CEO decisions on all risk acceptance(if any risk is accepted) on all software and hardware including OS Corp Data Center and Offices, VPN, Direct Connect IPSEC tunnel Fiber, HTTPS IDS & IPS & WAF/DAM, Anti Phishing protection in email client/GPO Data Loss Prevention (DLP solutions from vendors like Symantec)

Network access control lists and Security Groups. AWS IAM KMS Key Management Service. AWS Shield Advanced→defends against layer 7 attacks like HTTP flood attacks that overwhelm an application with HTTP GET or POST requests Elastic IP Address AWS WAF—load balancer & cloud front Or (Imperva Lambda Function to check a list of known Malicious IP addresses Lambda Function to analyze Web Traffic that generates bad or excessive requests (HTTP Flood attack indications) and add to a blocked list SANS config for AWS WAF, OWASP top 10 rules.

AppSec Engineers or consultants. Amazon Guard Duty→Route 53, VPC flow logs, CloudTrail event logs looking for known malicious IP addresses, domain names and potentially malicious activity. Amazon Inspector→EC2 CI/CD pipelineAWS CodeCommit , automate with or tools like Add static code analysis (SCA) using a tool like Micro Focus Fortify SCA [BUILD Stage] and/or Veracode and before getting to Source code repository and/or IAST (Contrast Assess in dev environment) Dynamic Application Security Testing DAST/IAST[TEST stage], Burp Suite Pro| Micro Focus Web Inspect, Contrast Assess Runtime Application Self Protection (RASP) (ex: Imperva Prevoty, Contrast Protect, Micro Focus AppDefender) on Pre-Production and Production Application Servers Data layer compliance checks using tool like Trustwave App Detective Pro.

Minimize the threat of internal operators or system administrators stealing or misusing their data. Network Access Control Lists and Security Groups and Encryption of Data At Rest and in RDBMS SQL Server can encrypt in flight. End to End Encryption in flight and Encryption of Data at rest in S3, Elastic Block Store (EBS), Elastic File System or Relational Database Service (RDS) Database S3 server side encryption with S3 managed, KMS or DIS Provided keys & DIS KMS

Achieving compliance with a framework such as PCI DSS and I believe that AWS is FedRamp approved. AWS Config, and encryption at rest and in flight using NIST FIPS 140 3, 140 2 implementations, reach for NIST 800 53 and OWASP ASVS Level 3 Ensure Static Code Analysis, Database Security Analysis, and Interactive and Dynamic Application Security Tests Pass compliance for PCI DSS.

Microdevices Platform Agnostic Diagram. TLS 1.2, 1.3 Options, with scalability for future enhancements. See FIG. 63, Incorporated by Reference.

USSN System Network and Cyber Architecture Platform. This is the entire platform integration of the: 1) Microservices Platform Agnostic; 2) Cybersecurity Reference Architecture; 3) Corporate Data Center; 4) AWS Security and Cloud Diagram; 5) USSN Node System Hardware and Software Diagram. See FIG. 64-66, incorporated by reference.

Urban Air Mobility (UAM) and Advanced Air Mobility (AAM) system integration.

All portable drone landing pads are a part of the Infrastructure and shall have, in addition to the owner of records address, the longitude and latitude quadrants and GPS location of the portable landing ad at the time of its request and use.

In some embodiments, a flight plan, dispatch approval (manual and/or automated), and payload/cargo manifest, will be digitally logged and uploaded via cloud computing systems known in the arts to all required authorities/agencies and/or vendor/servicer participants for any UAS/drone flight executed for service and or delivery.

Up to two alternate routes may be provided by an algorithm and/or artificial intelligence

(AI) for best en-route flight results based on all variables necessary and available that can affect a safe UAS/drone flight, such as weather, traffic, availability, inoperability, unforeseen delays, no fly zones, and the like.

Upon confirmed matches of all above IP and physical addresses assigned to such owners of record via the UAS/drone operating system, the drone mobile and online applications and any other means of consumer private and commercial public use and request.

In some embodiments, drone landing pad stations and rooftop UAS/Drone Port/airports will have an option that allows for weather descriptor codes to be relayed and translated by cloud computing automation and big data to the appropriate receiving location in need of it for important to automated flight decisions, data harvesting, mining, dissemination, and storing.

Smart Rooftop UAS/Drone Port/airports will have an option that allows the receiving of information pertaining to weather and other phenomenon by cloud automation and big data for important to automated flight decisions, data harvesting, mining, dissemination, and storing.

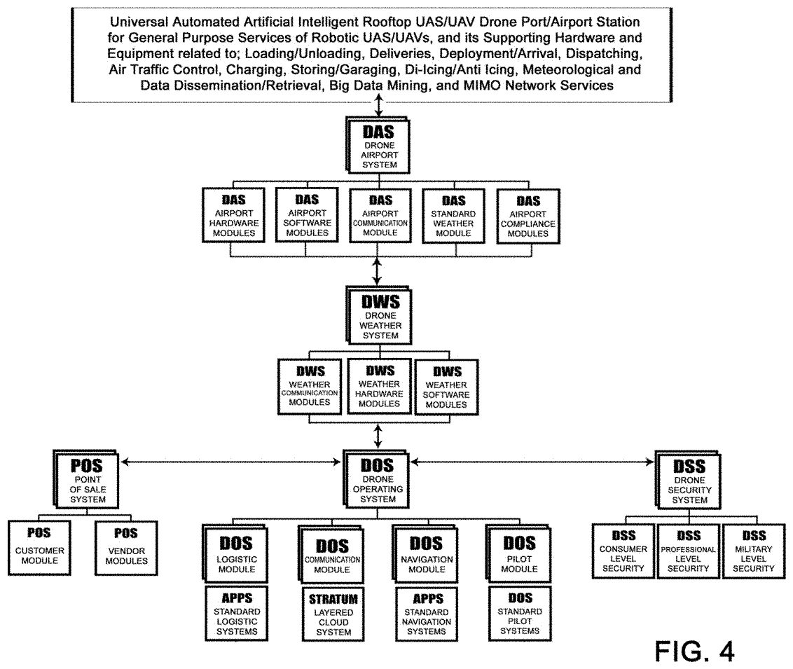

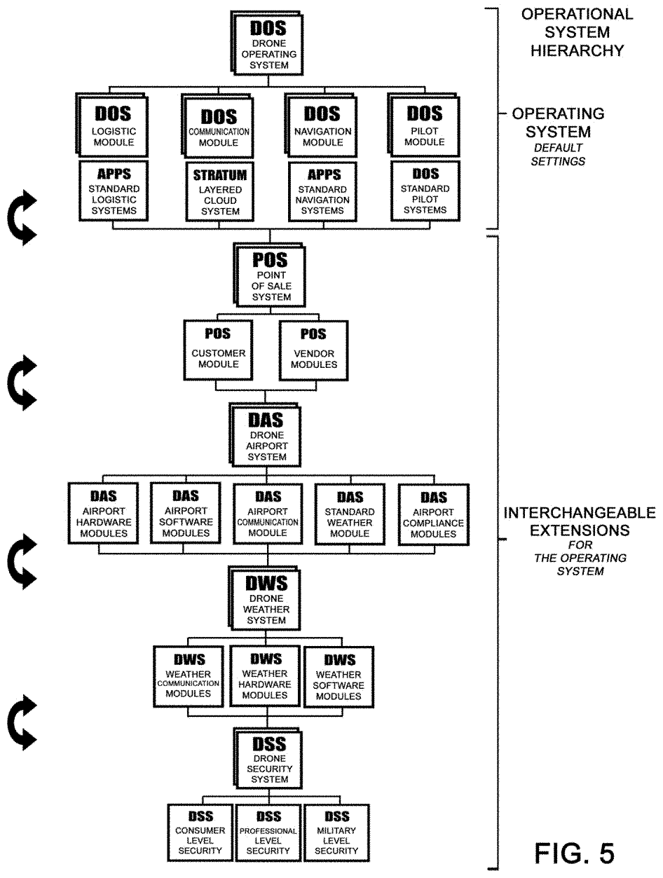

As shown in FIG. 4 and FIG. 5, the Smart Drone Airport System comprises of several sub-modules, including Airport Hardware Module, Airport Software Module, Airport Communication Module, Weather Module, and Airport Compliance Module. These modules rely on the operating system, called the Drone Operating System (DOS), and utilize functionality of other components, such as DRONE (drone supporting equipment), DOS (drone operating system's logistic module), DOS (navigational module), DOS (communication module), POS (point of sale system), DSS (drone security system), DWS (drone weather system) and Smart Drone Mailbox Landing Pad, Smart Parcel Mailbox Landing Pad, Smart Landing Pad, and Smart Portable Landing Pad.

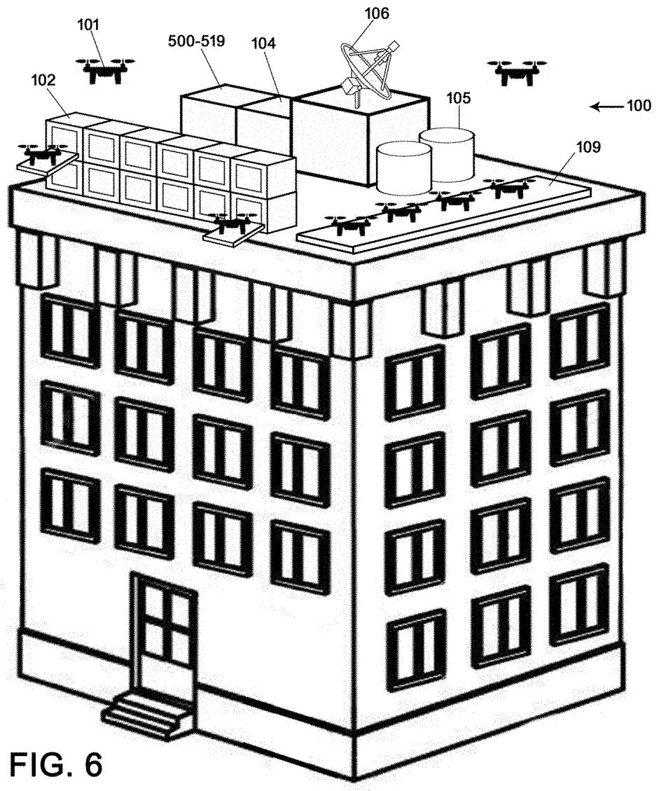

As shown in FIG. 6, the Smart Drone Airport System utilizes several primary components, incorporating landing platforms, meteorological equipment, de-icing/anti-icing equipment, charging stations, communication equipment, liquid storage tanks, drone parking/garage systems. The landing pad is designed not only to accept the incoming drones, but also serves as a recharging station and, if necessary, as a platform for de-icing the drones.

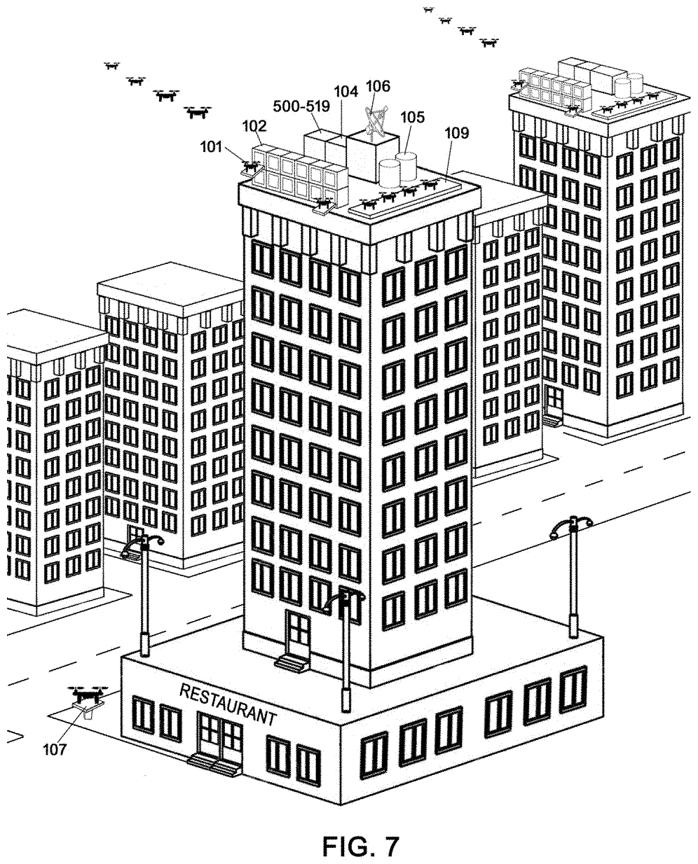

As shown in FIG. 7, the Smart Drone Airport System may be spread out over several structures located nearby. If such design of the airport facilities is desirable, the end-user may choose to use a single radar system and share its functional results with the airports located in close proximity. FIG. 7 illustrates a perspective view of a city with a plurality of tall structures wherein two of said structures house the Drone Airport System, each containing the necessary hardware, except for the radar system (attached to the airport in the foreground) which is shared by the nearby airports to reduce the operational costs.

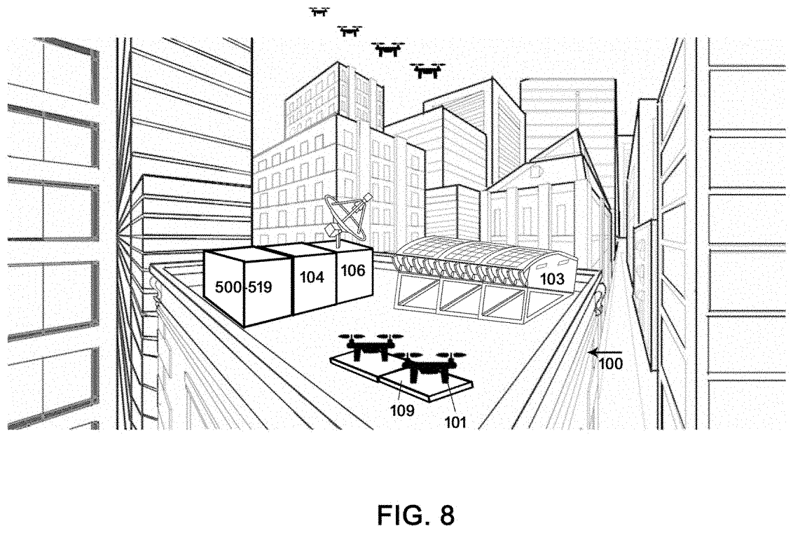

As shown in FIG. 8, the Smart Drone Airport System may be located in a highly congested urban area. Here, the end-user may choose to utilize non-stackable low-profile drone garage systems to reduce the overall height of the airport structure to further accommodate possible restrictive city ordinances.

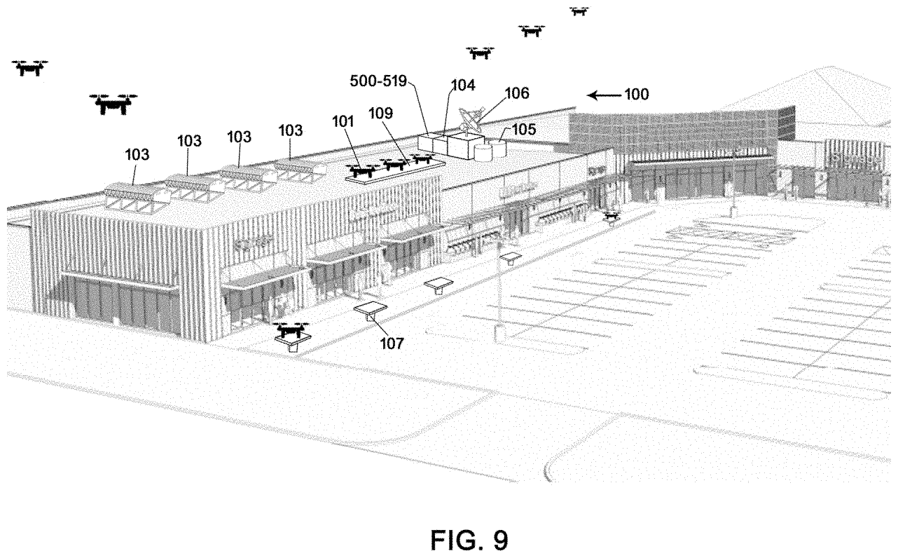

As shown in FIG. 9, the Smart Drone Airport System may operate from a rooftop of a low commercial structure (e.g., a strip mall), incorporating a plurality of low-profile, drone garage systems. Said garage systems may support not only the drones landing on the rooftop of the structure, but also a multitude of independently functioning drone landing pads and smart drone mailbox and parcel mailbox landing pads, positioned in front of the businesses occupying said commercial structure.

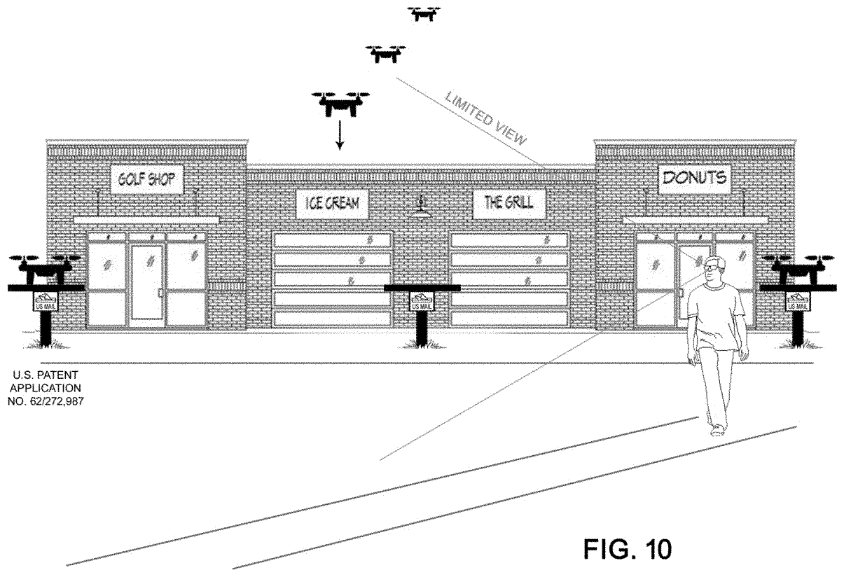

FIG. 10 shows a front view of a low commercial structure housing a plurality of businesses wherein said businesses utilize three done landing pads positioned at the street level in front of the building. Further shown is the Smart Drone Airport System in an alternate embodiment composed of low-profile garage stations so as to comply with more restrictive zoning requirements, many of which require that rooftop mechanical components not be visible to the pedestrians positioned on the street or sidewalk.

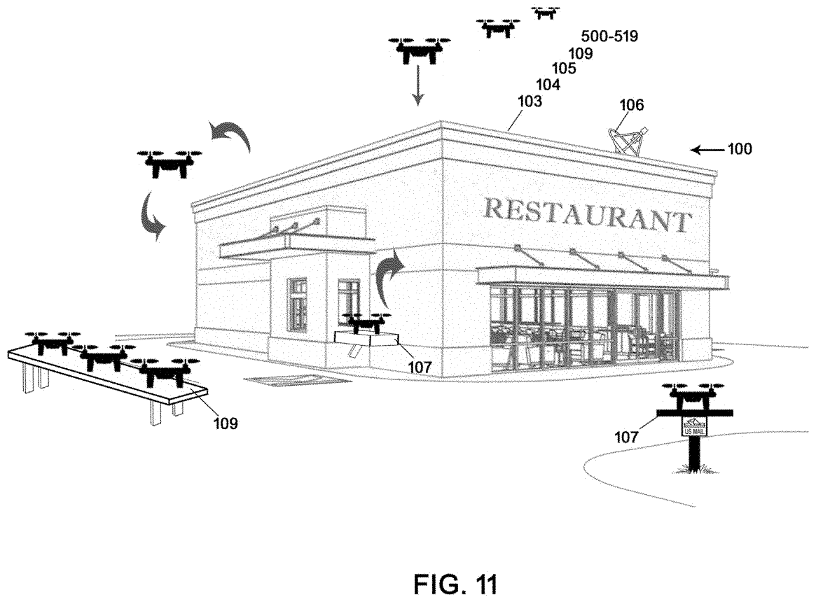

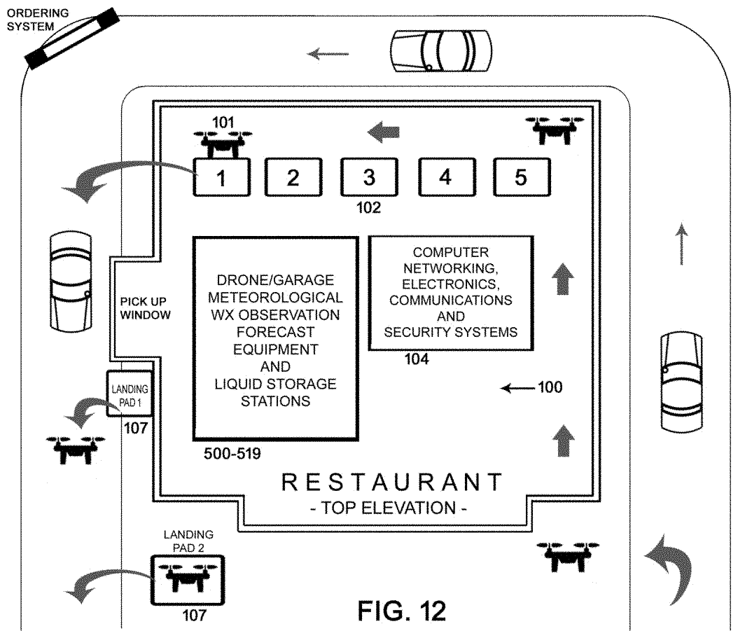

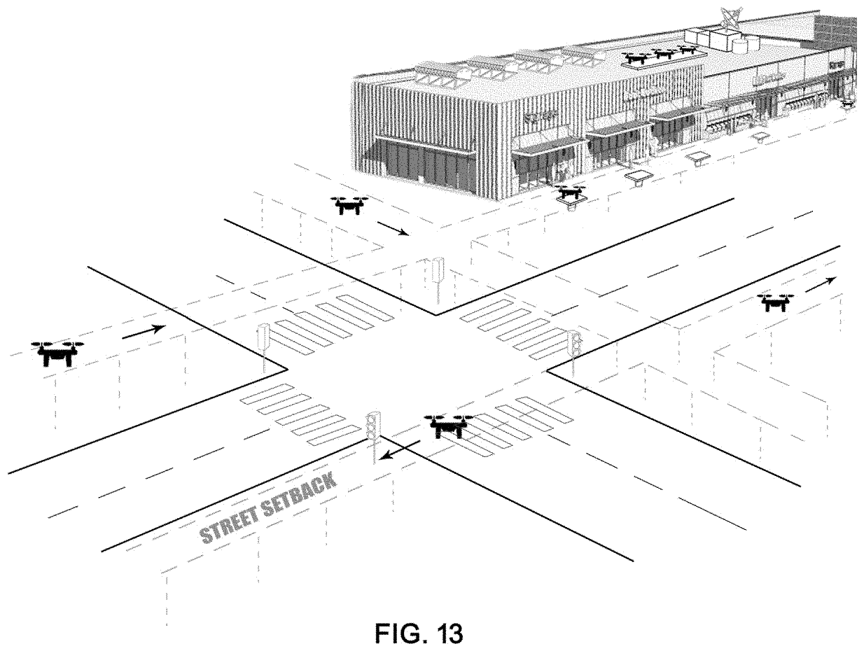

As shown in FIG. 11 and FIG. 12, the Smart Drone Airport System may be utilized in conjunction with a free-standing restaurant. In such, the communication, networking, and weather station components are positioned on the rooftop of the structure, and the portable landing pads are situated near a pick-up widow and near a driveway to accommodate the visiting customers. The drone access to these types of facilities (e.g., restaurants and other businesses located in low commercial structures) is accomplished by utilizing the air space directly above the existing street setbacks(Virtual Drone Airways (VDA)), allowing the drones to reach the airport from the street level, as shown in FIG. 13. Drones using the same sidewalk or set back, but flying in the opposite directions, will use different heights to avoid collisions.

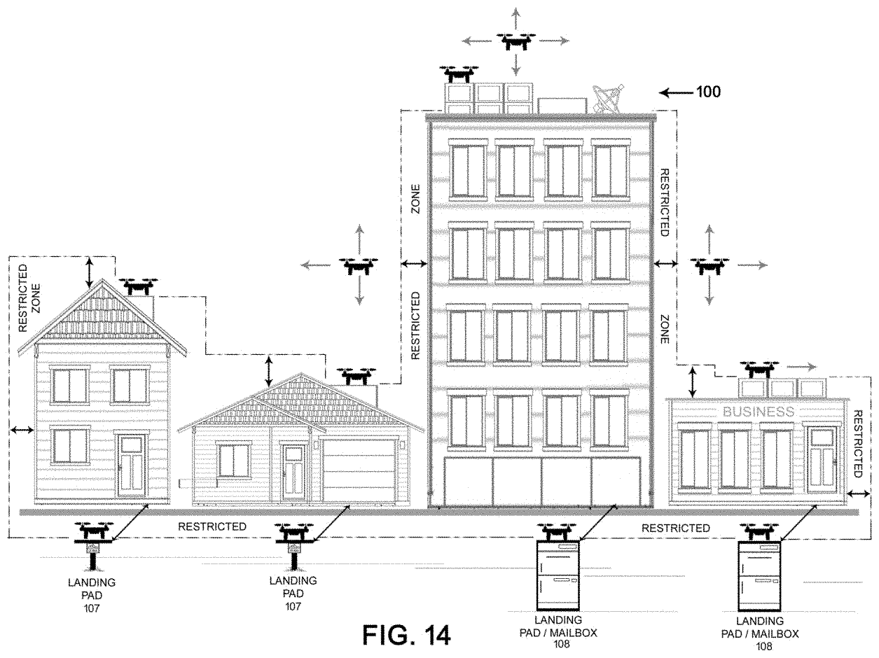

When flying around and near buildings, drones must maintain a pre-defined distance from said structures for both privacy and safety reasons, as shown in FIG. 14. This figure shows a front view of various structures, including commercial and residential buildings, outlining the restricted zone (no-flight areas, restricted areas, temporary restricted areas and geofencing areas) for drones operating on and near rooftops of both commercial and residential buildings. If said buildings also utilize drone landing pads, smart drone mailbox landing pads, and or smart parcel mailbox landing pads, positioned at the street level, their positioning will also create a restricted area between the building and the front elevation of each structure.

Airspace Classifications (“Class”) for the type of building, type of UAS, type of airspace flight levels, type of UAS equipment, payload and cargo, and any other variables that make up the “Class of UAS/Drone Airspace” and “Class of UAS/Drone Port/Airport” will be loaded in the UAS operating system (OS) in order to fly within any and all regulatory compliance codes, rules, laws, regulations, statutes, mandates and or ordinances. Clearance over, under, to the sides, between, and from one building to another must comply with regulations mandated for such use.

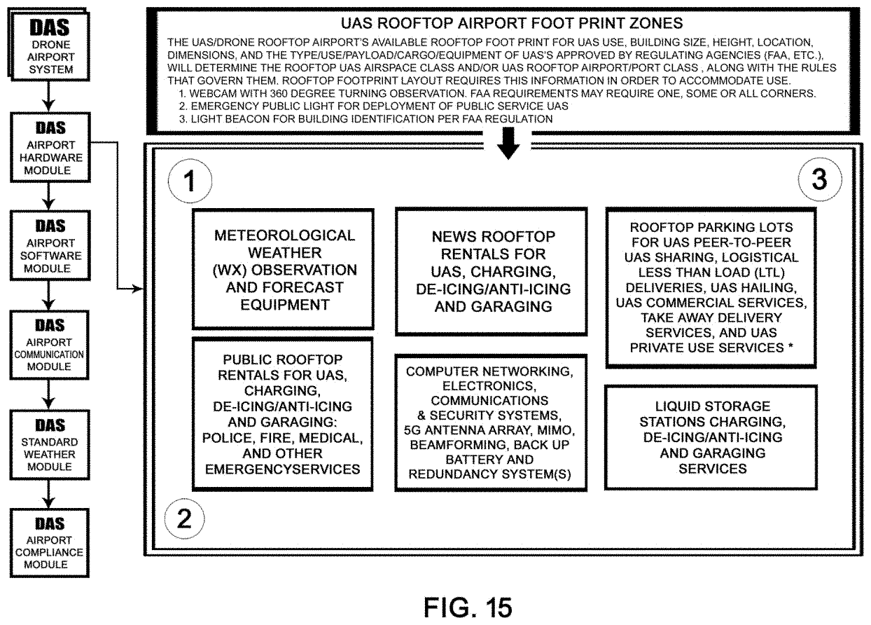

As shown in FIG. 15, the Smart Drone Airports will have standardized footprints, called UAS Rooftop Airport Foot Print Zones, and standardized safety features. The UAS/drone rooftop airport's available rooftop foot print for UAS use, building size, height, location, dimensions, and the type/use/payload/cargo/equipment of UAS's approved by regulating agencies (e.g., FAA, DOT, DOD, DHS, NASA, etc.), will determine the rooftop UAS airspace class and/or UAS rooftop airport/port class, along with the rules that govern them. Rooftop footprint layout requires this information in order to accommodate use: 1) WebCam with 360 degree turning observation wherein FAA requirements may require one, some, or all corners; 2) Emergency public light for deployment of public service UAS; 3) Light Beacon for building identification per FAA regulation.

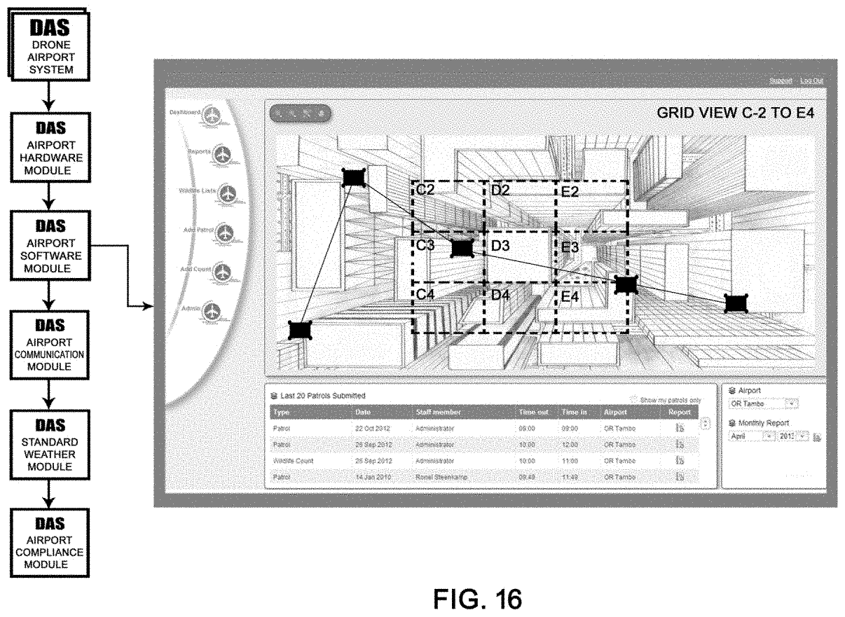

As shown in FIG. 16, the airports' software system utilizes cameras available on other active drones, radar, and the image generated by FAA-controlled systems to create a grid-based drone tracing system. In such, said tracking system sub-divides any given area of interest into grids and generates a drone identity associated with each one of said grids. FIG. 16 illustrates a screenshot of the drone tracking software for part of the part of the SDAS Airport Software Module, showing rooftops of numerous buildings and the usage of said software to track a plurality of drones using a grid view C2 to E4.

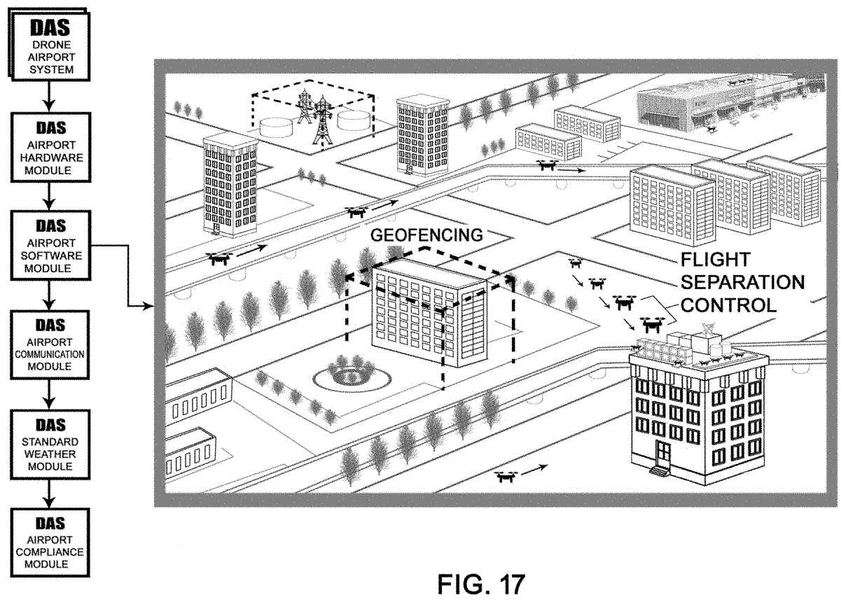

The SDAS Airport Software Module also generates an overview of a predefined geographical area, enabling review and modification of distances between the flights, flight paths, and creation/modification of geofencing shapes, as shown in FIG. 17.

Further, the mobile, internet and cloud marketing services available for UAV/UAS/drone services through integration of the UTM, DOS, mobile applications and internet include: 1) Private Programmatic Marketing-Market Place; 2) Public Programmatic Marketing-Market Place; 3) Digital Ad Exchange; 4) Publisher Ad Platform Services and Indie Group Publishers; 5) Marketing Ad Platform Services and Indie Group Marketers; 6) Behavioral People Identifiers; 7) Big Data Harvesting Services; 8) Purchase of Ad Space; 9) Geo Fencing Platform for Mobile Tracking, Coupon Offers, Incentives; 10) Rewards and Marketing Data Mining/Harvesting; 11) Membership Reward, Specials and Coupon Gamification Marketing Services and Campaigns; 12) Curated TV Content playing next to your ad; 13) TV/Video/Audio Ad Space (playing under drone, mobile applications and or internet); 14) Market by Group Segmentation (ads, people, groups); 15) Email, Text Message, MSM, Push Notification Campaigns; 16) Social Media Campaigns; 17) Content Ads; 18) Articles and News Review Services; 19) AI (Artificial Intelligence) Platform Marketing Services; 20) Virtual Reality Marketing Platform Services; 21) Augmented Reality Marketing Platform Services; 22) Mobile and Internet Surveys; 23) Pay Per Click Campaign Services; 24) Consumer Purchase Receipt Advertising Services; 25) Vender Mobile and Web Based Real time UAS/Drone Video Flight; 26) Observation and Video/Audio Capture Services; 27) Advertising Co-Op Campaign Services; and 28) Banner Ads and Display Services.

The Smart Drone Airport System, along with the supporting DOS system, is designed to provide customer letter/package mailing. Residential, commercial, and industrial residents and buildings who have their own UAV/UAS/drone, landing/launching pad, rooftop UAS/drone garage and charging station, and or Smart UAS/drone mailbox landing pad, and Smart UAS/Drone parcel mailbox landing pad, for loading and unloading, will have a feature, similar to the USPS with an integrated API app, where they will be able to use their own private and legally registered UAS/drone, to deliver to areas that are either direct to the end receiver or distribution centers that will handle the remaining delivery process. Done through our mobile app DOS services.

Customers will also have the choice to order an on demand UAS/drone for their specific type of pickup and delivery, using their UAS/Drone carrier or currier of choice, through our UAS/drone mobile, internet or TV app and DOS services. Family share of the private UAS/drone, fixed landing pad, and or portable landing pad, will be an option for customer members of the UTM and DOS services that have family that wish to be on the same account to use the equipment and services needed. Must be of any legal age mandated to be on such family plan at the time of use. Services will be available with FAA, DOT, DOD approved regulations implemented as a governor of the UAS/UAV instructions and use.

The Drone Airport System will integrate 911 drone services for all mobile device users integrated with the UTM and DOS services. Any and all customers who use the UTM and DOS application will have a feature to deploy an emergency 911 drone, which will inform the local dispatch and participating authorities of the emergency request.

The 911 Drone will attempt to be the first responder to the accident or crime by using the nearest deployable and in service UAS/drone available allowing to memorialize and assess the event(s). Customers who have their own UAS/drone and rooftop or ground garaging/charging system, will have the choice of membership to have the UAS/drone act as a security drone, which will canvas the area and parameter of the property, while using a cloud and 5G feature to stream video and/or audio to the customer's mobile device, the dispatch, and any other participating agencies in as close to real time as possible.

The DOS will memorialize the incident by simultaneously saving it at a remote and secure location. Public services such as police, fire department, amber alert, and news reporting agencies will have a designated location, drone hanger/garage/storage and charging station for their use of an UAS/UAV deployment based upon the size, classification and use of the Smart UAS/UAV rooftop DronePort/airport and UAS/UAV itself.

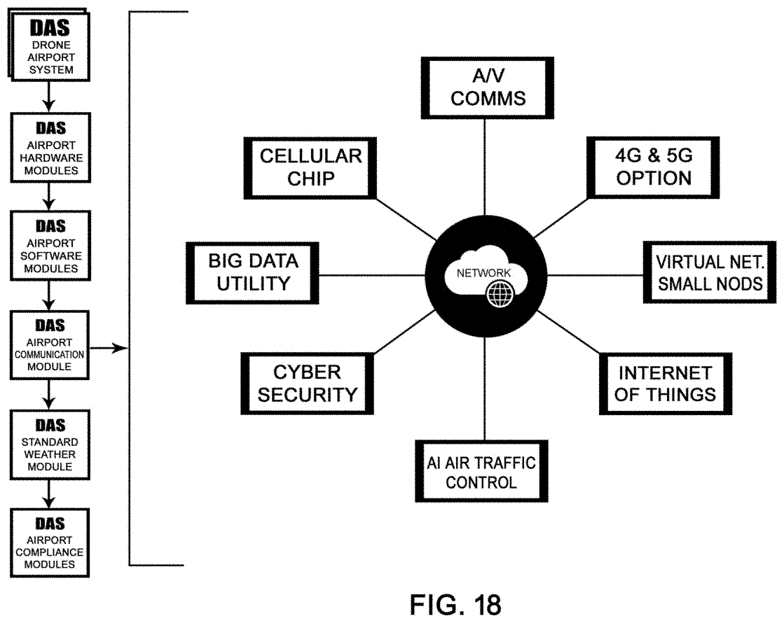

The Drone Airport System will incorporate a communication systems via the DAS Airport Communication Module. FIG. 18, shows the SDAS Airport Communication Module and its key components (A/V Communications, 4G, 4G LTE, and 5G Options, Virtual Network Small Nods, Internet of things, AI Air Traffic Control, Cyber Security, Big Date, Cellular Chip), wherein said components are interconnected via a cloud-based network.

Other capabilities of the communication module include the Drone AI Air Traffic Control (DIAATC), LAANC, DOC, UTM, dispatch, end user mobile app, network system and big data cloud data harvesting, dissemination and storing.

The Drone Operating System (DOS) and USSN will handle all digital, visual and audio communications, which will be done through AI, real time audio/video, virtual and augmented reality features and options.

Telecommunications will be done using both wire and wireless communications, both 4G, 4G LTE and 5G options. 5G mobile network that is configurable to need through the use of virtual network small nods internet of things (IoT) capability features for all users, through 4G, 4G LTE and 5G network.

DIAATC and LAANC, through the DOS and USSN will provide direct communications with all proper and approved authorities which will be available to airline ATC locations, government authorities, rooftop UAS/drone port/airport(s), and all product and or service provider(s), based on security clearance, type of use, and any other variable required and mandated for a safe and successful UAS/drone product and/or service delivery use.

Cyber security and Network Security features will have redundancy platforms built in the DOS, DIAATC, LAANC and/or any dispatch software for security integrity. Big data cloud features for data harvesting, dissemination, and storing. Each participating UAS/drone will have the choice of a cellular chip, similar to a mobile cell phone for use of communications.

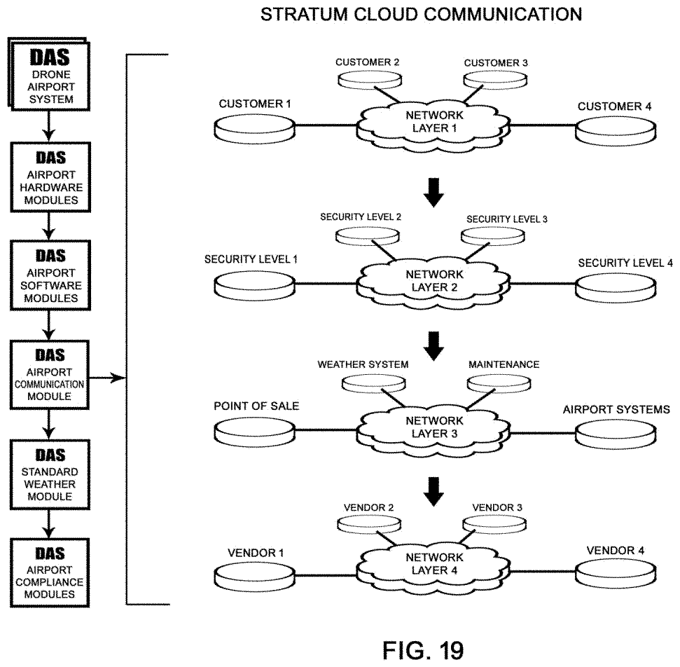

To improve the speed, reliability, as well as the security of the network system, the Smart Drone Airport System will incorporate the Stratum Cloud Communication, or layered cloud communications, shown in FIG. 19. Said communication system is a part of the SDAS Airport Communication Module, which subdivides the communication between the customers, security, internal systems (point of sale, weather system, maintenance, smart mailbox landing pad, smart parcel mailbox landing pad, airport system), and vendors ordering products/services.

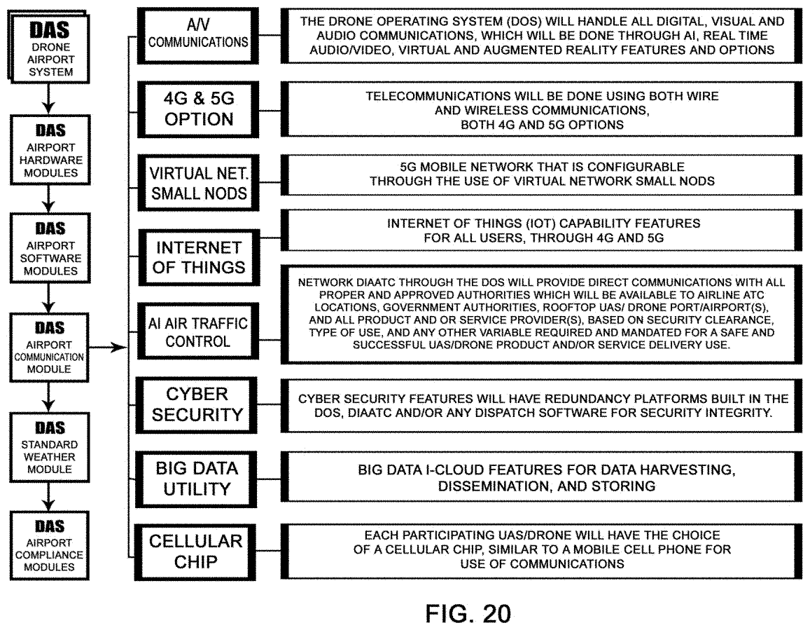

FIG. 20 is a flowchart illustrating part of the SDAS Airport Communication Module, further defining the key components outlined in FIG.18 (A/V Communications, 4G, 4G LTE, and 5G Options, Virtual Network Small Nods, Internet of Things, AI Air Traffic Control, Cyber Security, Big Date, Cellular Chip, Smart Landing Pad, Smart Drone Mailbox, Parcel Box, Landing Pad) of said module interconnected via a cloud-based network.

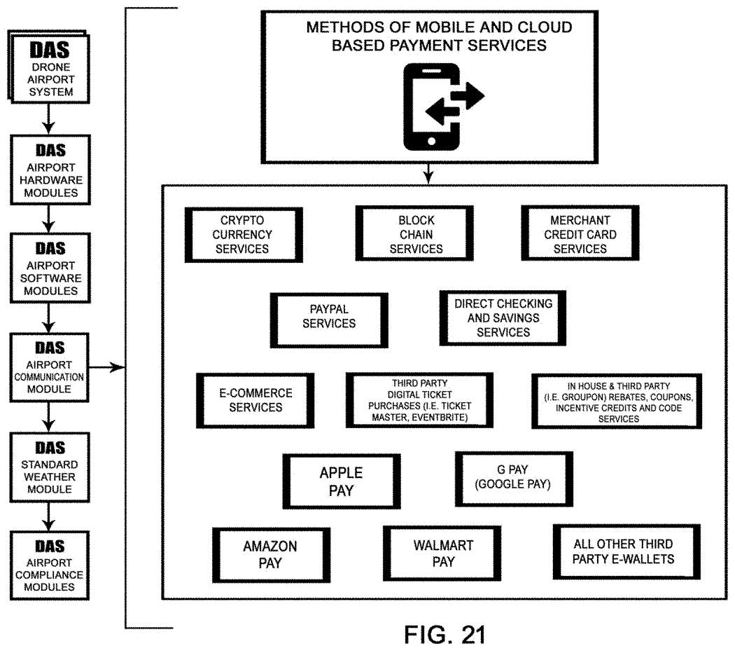

FIG. 21 is a Method of Mobile and Cloud Based Payment Services available under the Airport Communication Module. Providing for an Agnostic availability of payment resources and methods including but not limited to Crypto Currency Services, Block Chain Services, Block Chain Harvest/Mining, Merchant Credit Card Services, PayPal Services, Direct Checking and Saving Services, E-Commerce Services, Third-Party Digital Ticket Purchases (i.e. Ticket Master, Eventbrite, etc.), In-House & Third-Party (i.e. Groupon) Rebates, Coupons, Incentive Credits and Code Services.

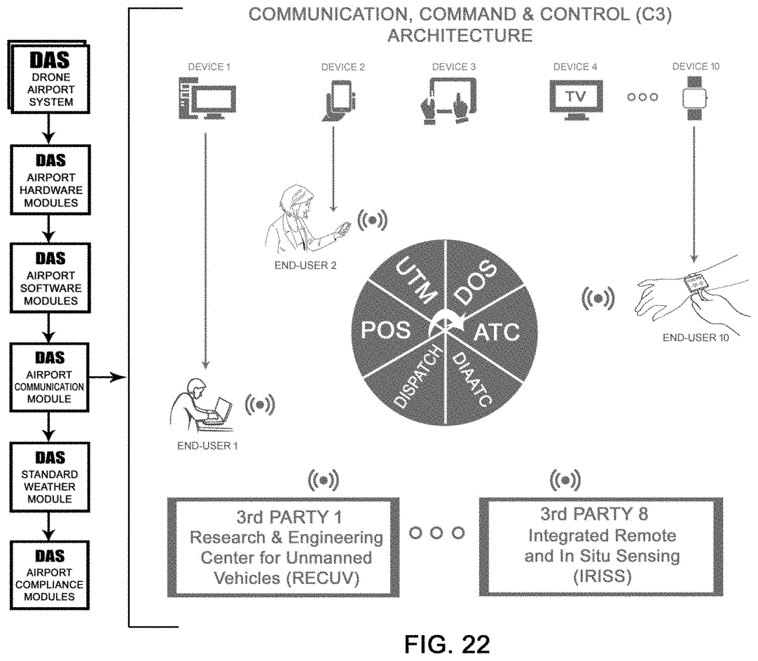

The system will incorporate the Communication, Command and Control (C3) Architecture, shown in FIG. 22. The USSN, UTM, DOS, ATC, DIAATC, LAANC, dispatch and end user integrated system(s) will provide for a platform which will accommodate for C3 and/or other third party architecture, which may need integration into third party system(s), such as RECUV Networked UAS (NetUASC3) for the Tempest UAS Tornadoes experiment. In addition to this architecture is the SDAS USSN and Smart Mailbox and Parcel Mailbox Landing Pad Module.

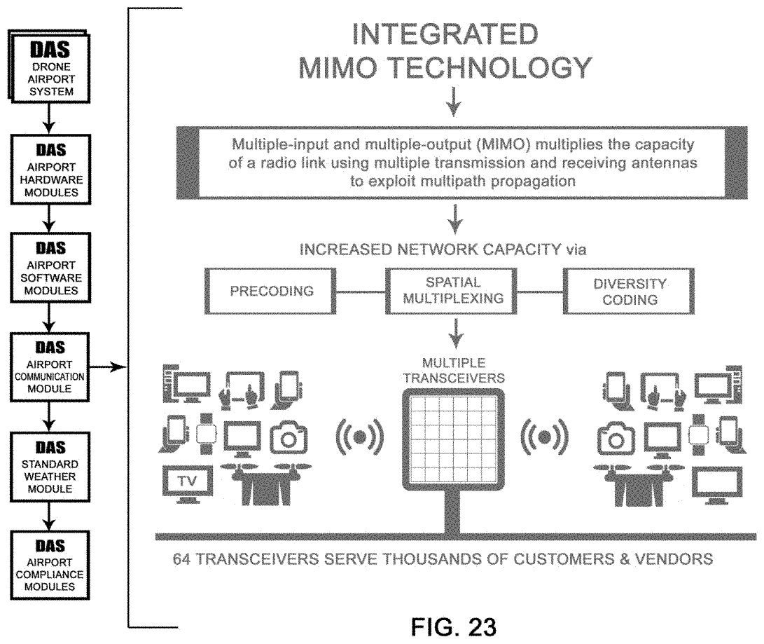

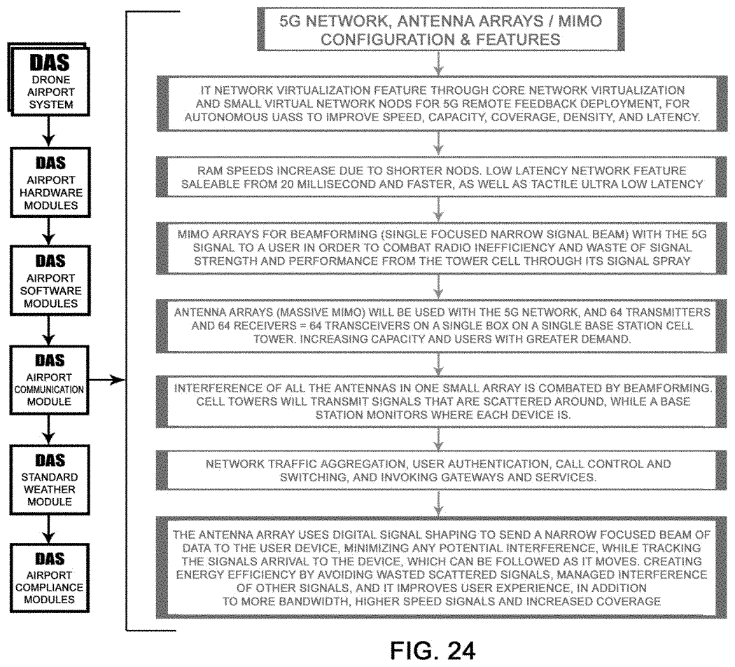

The system incorporates 4G, 4G LTE and 5G network, USSN, antenna arrays and/or MIMO (Multiple-Input and Multiple-Output) and Massive MIMO transmission and receiving antennas to exploit multipath propagation, configuration and features, shown in FIG. 23 and FIG. 24, IT network virtualization feature through core network virtualization and small virtual network nods (remotely configurable and de-centralized where the users are) for 5G remote feedback deployment, for autonomous UAS/drones to improve speed, capacity, coverage, density, and latency. RAM speeds will be faster due to shorter distance nods. This enhances flexibility, configurability, security, emergency response times and performance such as latency and disruptive times. Increased Network Capacity via Precoding, Spatial Multiplexing, and Diversity Coding in Multiple Transceivers.

Network traffic aggregation, user authentication, call control and switching, and invoking gateways and services. Low latency network feature saleable from 20 millisecond and faster, as well as tactile ultra-low latency.

MIMO (Multiple Input Output) Array(s) for Beamforming (single focused narrow signal beam) with the 5G signal to a user, in order to combat radio inefficiency and waist of signal strength and performance from the tower cell through its signal spray. Tracking the signal and user device in order to know how much signal strength is needed to reach the user.

Antenna arrays called Massive MIMO will be used through the 5G Network, with 64 Transmitters and 64 Receivers=64 Transceivers (and scalable) on a single box on a single base station cell tower. Increasing capacity and users with greater demand.

Interference of all the antennas in one small array is combated by beamforming. Cell towers will transmit signals that are scattered around, while a base station monitors where each device is located.

The Antenna Array uses Digital Signal Shaping to send a narrow-focused beam of data to the user device, minimizing any potential interference, while tracking the signals arrival to the device, which can be followed as it moves. Creating energy efficiency by avoiding wasted scattered signals, managed interference of other signals, and it improves user experience, in addition to more bandwidth, higher speed signals and increased coverage.

As shown in FIG. 21, the DAS and DOS, utilizing these advanced communication features, will enable usage of various agnostic methods of mobile and cloud-based payment services, including but not limited to: 1) Merchant Credit Card Services; 2) Block Chain Services; 3) Crypto Currency Services; 4) PayPal Services; 5) Direct Checking and Savings Services; 6) E-Commerce Services; 7) In house and Third Party (i.e. Groupon) Rebates, Coupons, Incentive Credits and Code Services; 8) Third Party Digital Ticket Purchases (e.g.,Ticket Master, Eventbrite); 9) Apple Pay; 10) G Pay (Google Pay); 11) Amazon Pay; 12) Walmart Pay; 13) All other Third Party E-Wallets.

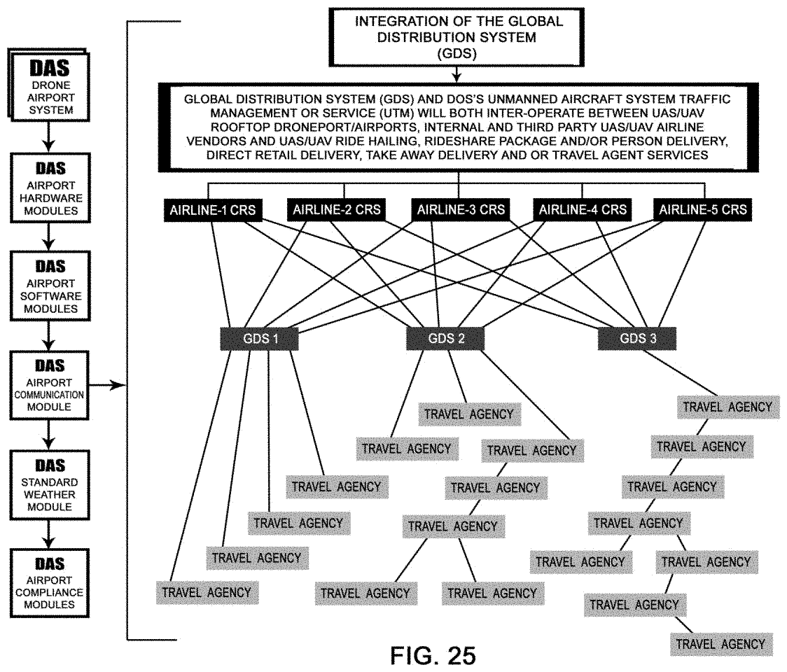

As shown in FIG. 25, the Smart Drone Airport System will enable connection with the Global Distribution System (GDS) and DOS's Unmanned Aircraft System Traffic Management or Service (UTM) and US SN. These systems inter-operate between the Smart UAS/UAV rooftop DronePort/AirPorts, internal and third party UAS/UAV airline vendors and UAS/UAV ride hailing, rideshare package and/or person delivery, direct retail delivery, take away delivery and or travel agent services. Third-Party UAS/UAV Airline Vendors will be able to use API App features to integrate into the US SN system.

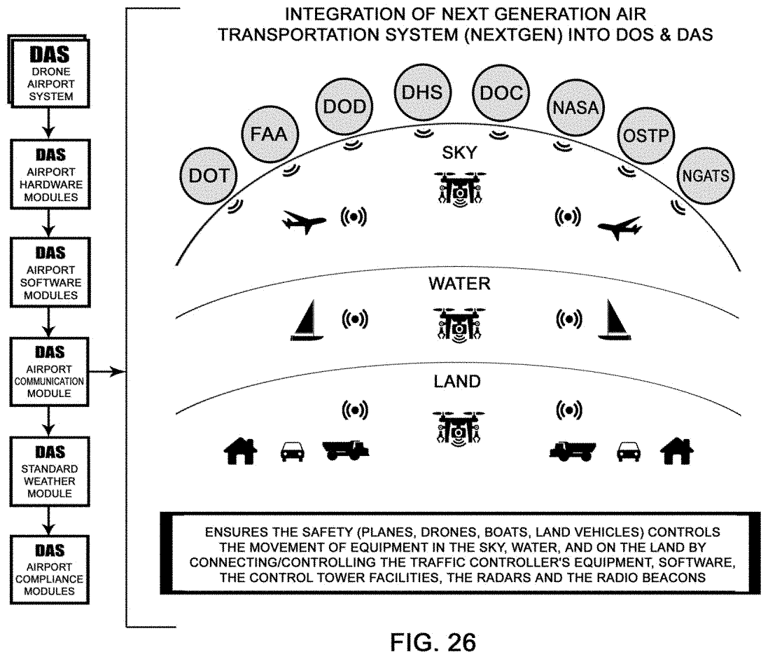

The Smart Drone Airport System, vis the DOS and USSN system, will integrate the Next Generation Air Transportation System (NextGen), an FAA-led project, focusing on development of a system designed to implement innovative new technologies and airspace procedures to improve safety, shown in FIG. 26. The DOT, FAA, DOD, DHS, DOC, NASA, OSTP, and NGATS will have access and participate in the NextGen Air Transportation System(NextGen). This will ensure the safety (Planes, Drones, Boats, Land Vehicles) by controlling the movement of equipment in the sky, water, and on the land by connecting/controlling the traffic controllers equipment, software, the control tower facilities, the radars and the radio beacons.

By the integration of NextGen, CSS, 4-D Cube, and MIMO technologies in the aviation field with our Smart Drone Rooftop DronePort/Airport(s), UAS/UAV/Drone(s) and our UAS/UAV/Smart Drone Landing Pad, Smart Mailbox and Parcel Mailbox Landing Pads and UAS/UAV Smart Garage/hanger/charging station, within the National Airspace System (NAS), Federal Aviation Administration (FAA) System, Department of Transportation System, U.S. Postal System (U.S.P.S.), NASA systems and third party carrier systems, our UTM DOS system is able to provide accurate and AI automated: 5G MIMO network communications, layered cyber security integration, UAS/UAV/drone POS land/mobile system for retailer and consumer order fulfillments, satellite weather and traffic data—for real time weather and traffic decision making (such as a Flow Constrained Area (FCA)).

In addition, the NextGen will also enable accurate and AI automated traffic control, GPS ground UAS/UAV/drone detection, satellite in-flight detection and avoidance of in-flight UAS/UAV/drones and or in-flight Weather Avoidance Field(s) (WAF) that has been translated into weather constraints via NextGen ATM Weather Integration—from order and delivery—back to home base or redirect, and for AI automated management of multiple grounded, parked, stored and in-flight UAS/UAV/drone(s)—having transponders, receivers and or cellular chips, ADS-B, GPS, both in-house and to third party system(s), detection of vacant , pending, committed, decommissioned and or occupied UAS/UAV/drone landing pads, garages/hangers/charging stations.

The UTM DOS and USSN System will be able to transmit its own weather information and traffic data to the same systems.

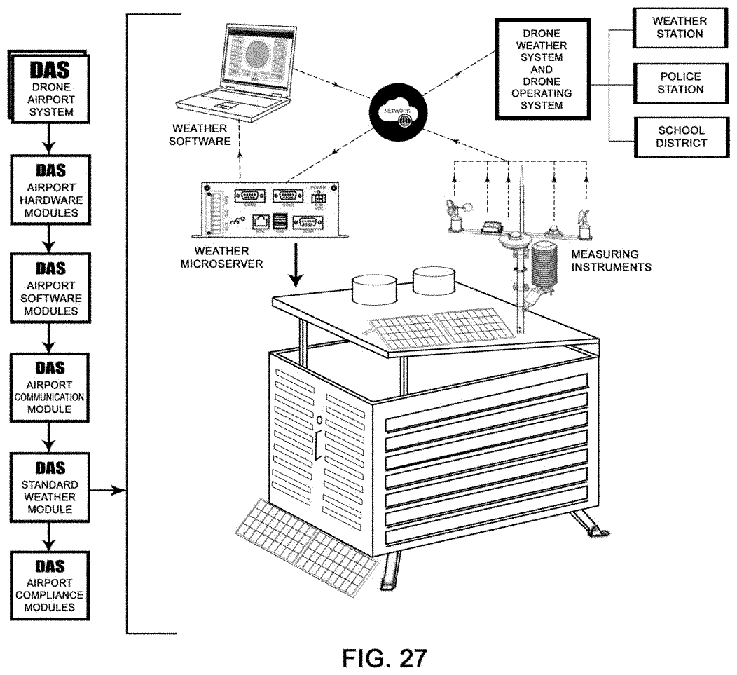

As shown in FIG. 27, the Smart Drone Airport System will integrate the Weather Module Systems. The weather system is an automated weather reporting system(s)/station software/hardware for observation and forecast reporting on UAS/UAV drone port/airport to be integrated with UAS/UAV rooftop DronePort/AirPorts, designed to incorporate: 1) AWOS-Automated Weather Observing Systems; 2) ASOS-Automated Surface Observing Systems; 3) AWSS-Automated Weather Sensor System; 4) LLWAS-Low Level Wind Shear Advisory System; 5) Ceilometer; 6) Anemometer; 7) Radar; 8) Satellite; 9) Hydrometer-Humidity Sensors; 10) Rain Gauges; 11) Hail Pads; 12) Thermometers; 13) Barometers; 14) Pyranometer; 15) Disdrometer; 16) Transmissometer.

The system will integrate Observation & Forecast Features with Flight Levels Monitoring Capabilities, providing: 1) Micro local scale-precipitation, icing, frost, temp/dew point, convection, prevailing wind direction, speed and gusts; 2) Nano-local scale or ground zero-local scale; 3) Levels from ground to 400 ft. and up to 100 ft. above rooftops; 4) Use of both AGL (Above Ground Level) and MSL (Mean Sea Level) for drone airport station elevation levels with altimeter calculations available for drone pre-flight observation and forecast use; 5) Isobar thermal circulation, horizontal pressure gradient, pressure gradient and frictional force for altimeter pressures and local wind topography from ground level to 400 ft. AGL and up to 100 ft. above Rooftops MSL; 6) UAS and UAV in flight will have options to report weather if features and equipment are available for the UAS/UAV to use.

The system will take advantage of Automated Weather Observing System (AWOS); Automated Surface Observing System (ASOS); and Automated Weather Sensor System (AWSS). Wherein said AWOS/ASOS/AWSS weather reporting transmissions are broadcasted over: 1) Discrete VHF and UHF Options; 2) Radio Frequency; 3) Low Frequency NDBs and/or VORs; 4) Voice portion of local NAVAIDS; 5) Computer; 6) Satellite; 7) Telephone; 8) Wi-Fi; 9) 4G and 5G Networks; 10) Other Wire and Wireless Communications; and 11) Radiosondes on Aircraft, SUAS, UA, UAS, UOA, and UVS.

AWOS/ASOS/AWSS frequencies, used for weather transmissions will be: 1) Found on aeronautical charts and listed such as the applicable A/FD (Airport Facility Directory), UAS (Unmanned Aircraft Systems)/FD (Facility Directory) and or UOA (unmanned Operating Area)/FD(Facility Directory) listing of the Chart Supplement; 2) By calling a dedicated automated or operator telephone line ;3) By way of Internet, Intranet, Wi-Fi, and/or any other current means of visual and/or audio communication; 4) Any Electronic Hardware, Software, Website, and or digital file, capable of providing video, audio and or graphical information related to AWOS/ASOS/AWSS Reports.

Smart Drone Airport AWOS/ASOS/AWSS information can be updated regularly to the: 3 World Meteorological Center(s), Communication Substations, FAA (Federal Aviation Administration), DUATS (Direct User Access Terminal System), Flight Services(and or its TIBS and or 800wxbrief system(s)), NWS (National Weather Service), ACAS (Adverse Conditions Alerting Service), NOAA (National Oceanic and Atmospheric Administration), NCEP (National Centers for Environmental Prediction), AWC (Aviation Weather Center), ARTCCs (Air Route Traffic Control Centers), Flight Aware (flightaware.com), CWA (Center Weather Advisories), HIWAS (Hazardous in-flight Weather Advisory Service (VORs), Data Link Weather Services (GPS and EFB Cockpit and tablet display systems (Example: FIS-B with ADS-B Data link)), Geo-fencing systems (land and mobile devices (iPad, iTouch, Smart Phone, TV, Smart TV, Laptop, Computer), ATC (Air Traffic Control Systems), Tower Control Systems, NTSB (National Transportation Safety Board), NAS (Low-Altitude National Airspace System).

The Smart Drone Airport System weather station transmission process will follow the following procedure: 1) Observation weather information from the SUAS, UAS, UOA, UVS, UAV unmanned rooftop airports have a set option to communicate with a communication substation; 2) The Communication Substation in turn relays the weather information to the three World Meteorological Centers; 3) The World Meteorological Centers in turn transmits the weather information to multiple countries; 4) For the U.S., the World Meteorological Center sends the data to the National Centers for Environmental Prediction (NCEP); 5) NCEP will then send the information to the National Weather Service to be disseminated to all participating users.

The Smart Drone Airport System data link for inbound and outbound weather data will be supplied to the following date collection services: 1) METARs (Meteorological Aerodrome Report) A01 and A02; 2) SPECI (Special Unscheduled METAR Observation and Surface Weather) A01 and A02; 3) TAFs (Terminal Aerodrome Forecast) A01 and A02; 4) NOTAMs (Notice to Airman); 5) AIRMETs (Airman's Meteorological Information (WAs)); 6) G-AIRMETs (Graphic Airman's Meteorological Information); 7) SIGMETs (Significant Meteorological Information); 8) LOW LEVEL SIGWX CHARTS (Low Level Significant Weather Prognostic Charts); 9) CONVECTIVE SIGMETs (Convective Significant Meteorological 10) Information(WSTs)); 11) SUA (Special Use Airspace); 12) PIREPs (Pilot Reports); 13) UOSREPs (Unmanned Operating System Report(AI or Operator Observation Report)); 14) NCWF (National Convective Weather Forecast); 15) FD (Wind And Temperature Aloft Forecast); 16) WH (Hurricane Advisory); 17) TFRs (Temporary Flight Restrictions); 18) NEXRAD (Weather Surveillance Radar-1988 Doppler WSR-88D); and 19) TWEB (Transcribed Weather Broadcasts (Alaska Only(TEL-TWEB)).

UAS/UAV Drone Weather Observation and Forecasts will have the Option to Receive and Provide the following: 1) The UAS operating system for the UAS/drones in transit, will receive and provide weather data interchangeably with 2) The Direct User Access Terminal (DUAT) system; 3) Flight service stations; 4) ADDS (Aviation Digital Data Service); 5) NOAA at http://noaa.gov; 6) AOPA Online; 7) Aviation Weather Center's Current Icing Potential (CIP); 8) Pilot reports if needed; 8) UAS Pireps—Receives UAS PiReps data from other UAS and create its own UAS PiRep data en route to and from destinations. UAS uploads via iCloud on Big Data System Data critical to Flight Weather Conditions

Providing “upstream” weather reports and trends; 9) IFR minimum en route altitude (MEA) in the interactive Sky Spotter program, www.asf.org/skyspotter. 10) Low Level Wind Shear (LLWAS) Advisory Systems; 11) Any other third-party system required and or available for use. Common Support Services (CSS-Wx) publishing Weather Information (i.e. Weather (Wx)). Rooftop UAS/Drone Port/Airport(s) will integrate retrieval of weather data through the Common Support Services (CSS-Wx) Weather System (NextGen), which is integrated in the National Airspace System (NAS) and FAA user interface system(s) available to users through same-time access. This data will be sent via Satellite to the Rooftops and or directly to the UAS/UAV and Drone Transponders or Receivers in real time, based on current weather conditions. The UAS/UAV/Drones will be able to use this information to travel with AI autonomous dynamic decision-making functions based on weather and traffic conditions, while maintaining flight restriction(s) under its automated governor.

The integration of National Airspace System (NAS) Software for Air Traffic Control (ATC) and dispatch management, wherein the weather and air traffic systems are designed to work conjunction with the UAS/UAV UTM DOS, and the following weather systems: 1) Global Distribution System (GDS); 2) Sabre Global Distribution System; 3) Harris Weather and Radar Processor (WARP); 4) Low- Level Wind shear Systems (LLWAS); 5) NexRad; 6) NextGen (Next Generation Air Transportation System; 7) TDWR radars; 8) Integrated Terminal Weather System (ITWS); 9) CDM—Collaborative Decision Making (FAA); 10) FSM: Flight Schedule Monitor (for CDM); 11) AOCNet; 12) FAA ground delay program information and Aircraft Situation Display to Industry (ASDI) data; 13) Air Traffic Control System Command Center (ATCSCC); 14) WSI Fusion; 15) Satellite Systems; 16) Foreflight.

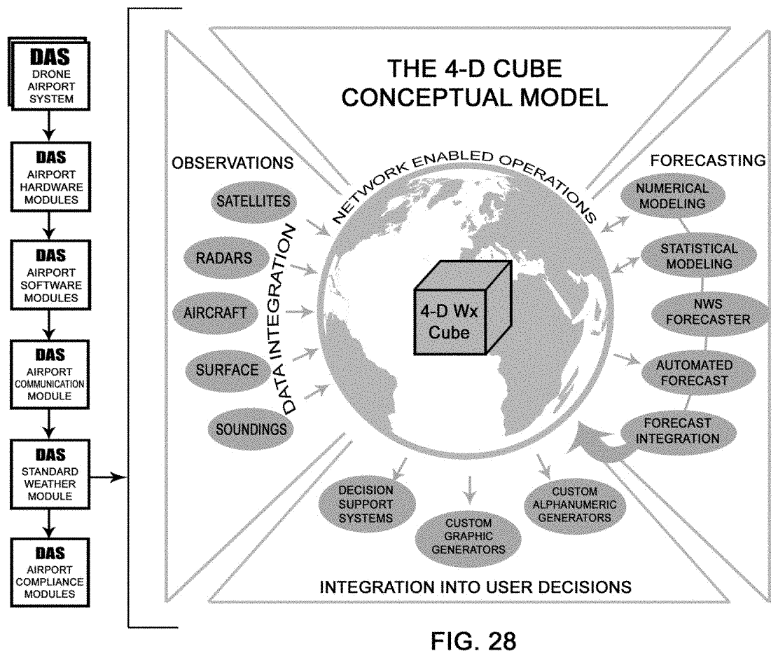

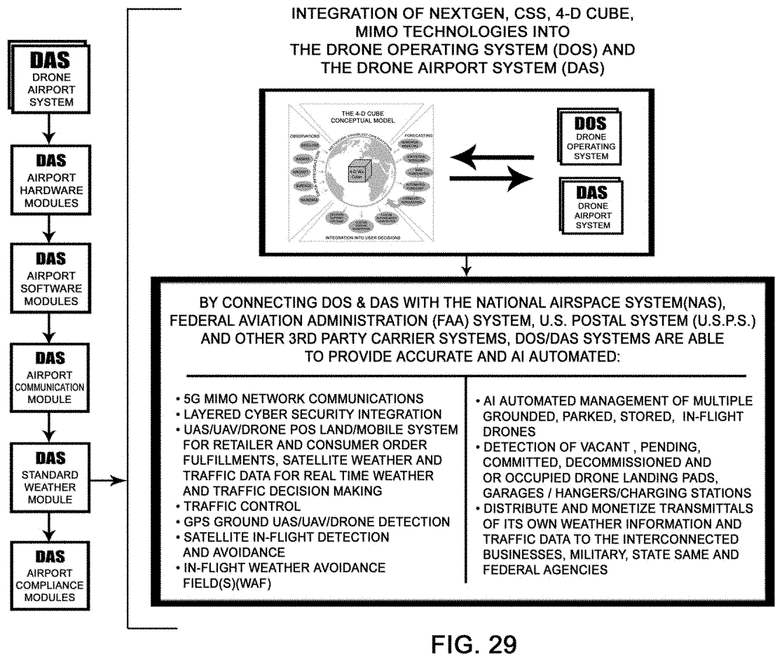

As shown in FIG. 28 and FIG. 29, the 4-Dimensional (4-D) Weather (Wx) 4Cube, is incorporated into SDAS Weather Module, enabling continuously updated weather observations (surface to low Earth orbit, including space weather and ocean parameters), high resolution (space and time) analysis and forecast information (conventional weather parameters from numerical models), designed to predict various aviation parameters (icing, turbulence, wind, visibility).

Moreover, by connecting DOS, USSN & DAS with the National Airspace System (NAS), Federal Aviation Administration (FAA) System, U.S. Postal System (U.S.P.S.), and other 3rd Party Carrier Systems, DOS/SDAS systems are able to provide accurate and AI automated: 1) 5G MIMO Network Communications; 2) Layered Cyber Security Integration; 3) UAS/UAV/drone POS land/mobile system for retailer and consumer order fulfillments, satellite weather and traffic data—for real time weather and traffic decision making (such as a Flow Constrained Area (FCA); 4) Traffic control; 5) GPS Ground UAS, UAV, drone detection; 6) Satellite in-flight detection and avoidance; 7) In-Flight Weather Avoidance Field(s) (WAF); 8) AI automated management of multiple grounded, parked, stored, in-flight drones; 9) Detection of vacant, pending, committed, decommissioned and or occupied smart drone landing pads, smart drone mailbox and parcel landing pads, garages/hangers/charging stations; 10) Distribute and monetize transmittals of its own weather information and traffic data to the interconnected businesses, military, state same and federal agencies.

Additional observation, prediction, UAS/UAV deployment and third-party services, that will be available with the assistance of UAS/UAVs, meteorological, networking, and operating system equipment, on the UAS/UAV Rooftop DronePort/AirPort: 1) Information disseminated from UAS/UAVs equipped with a UAS/UAV anemometer and or barometer, in order to create UAS/UAV aircraft reports (AMDAR), that were deployed from UAS/UAV Rooftop DronePort/Airports; 2) Common Support Services-Weather (CSS-Wx) which publishes info provided by the NextGen weather processor FIG. 29, incorporated by reference, and use of the system wide information management network, to the FAA and National Airspace System (NAS); 3) Observations: Through the following A) NextGen CCS-Observations: Satellite Imagery; Radar Imagery; Aircraft Reports (AMDAR); Surface Reports (METARS); Upper Air Reports (Balloon Sounding); B) Numerical Modeling; Statistical Forecasting including NWS Forecasters, Auto Forecast System and Forecast Integration; C) CoSpa: Consolidated Storm Prediction for Aviation; D) Storm Prediction Center (SPC); E) UAS/UAV Weather Avoidance Field (WAF and UASWAF) module with UAS/UAV deviation model and forecast UAS/UAV avoidance regions models; F) Vortex 2 and 3—For Weather Chasing and reporting with UAS/UAVs; G) National Severe Storms Laboratories (NSSL); H) UAS/UAV in-house, Mesonet and or other third-party UAS/UAV fleets.

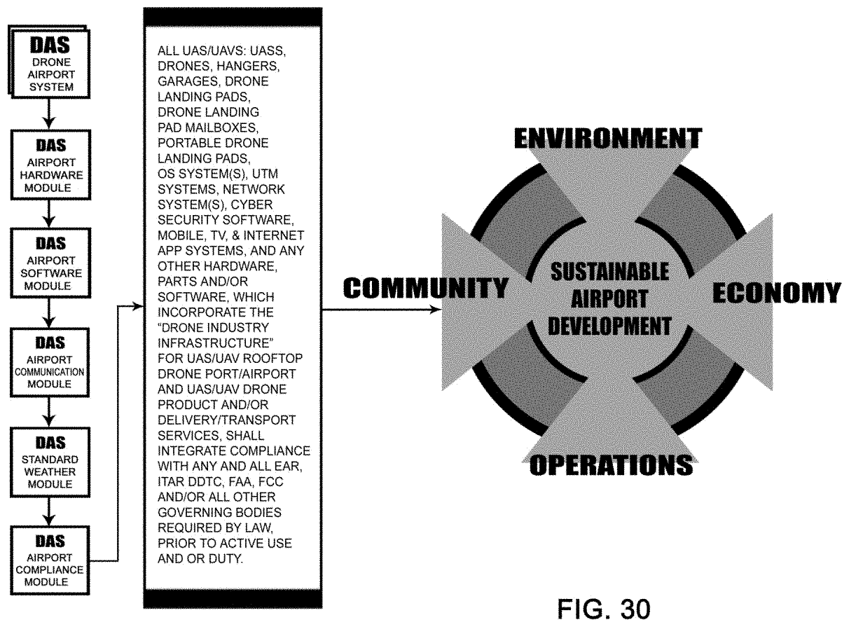

The SDAS Compliance Module of the Smart Drone Airport System, in conjunction with the Drone Software Module, has been designed to handle the legal compliance requirements. Said requirements will be modeled on the requirements imposed upon municipal and intentional airports, under the jurisdiction of the FAA, and developed to create a sustainable airport system. FIG. 30 is outlining the primary factors having impact on the development of the sustainable airport system and its 1) Environment; 2) Community; 3) Operations and; 4) Economy.

All UAS/UAVs: UASs, drones, hangers, garages, drone landing pads, smart drone mailbox and parcel landing pad, smart portable drone landing pads, OS system(s), UTM systems, network system(s), cyber security software, mobile, TV, & internet app systems, and any other hardware, parts and/or software, which incorporate the “Drone Industry Infrastructure,” for UAS/UAV rooftop drone port/airport and UAS/UAV drone product and/or delivery/transport services, shall integrate compliance with any and all EAR, ITAR DDTC, FAA, FCC, DOT, DOD, DHS, NASA and/or all other governing bodies required by law, prior to active use and or duty.

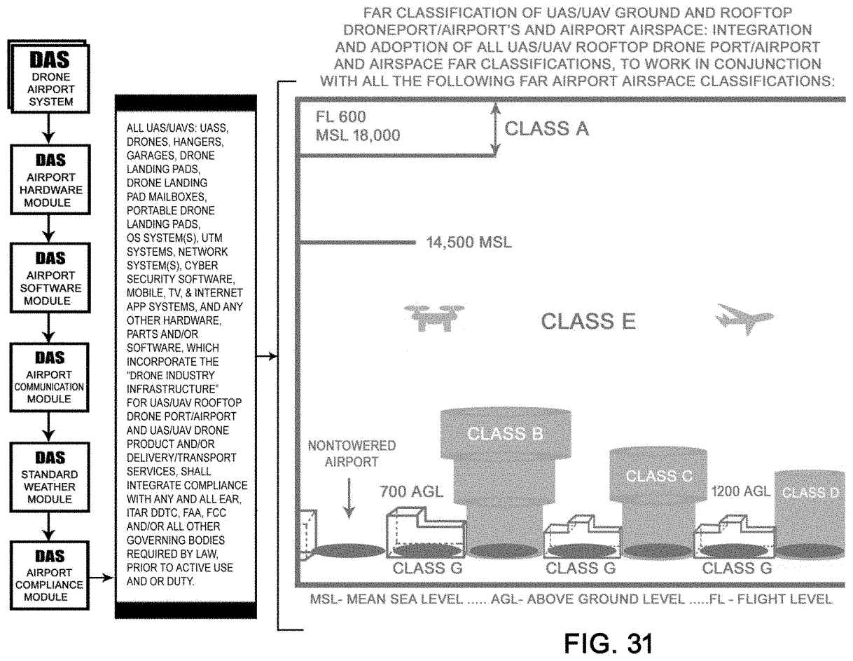

As shown in FIG. 31, the Smart Drone Airport System, via the Airport Compliance Module, integrates FAR airspace classification system. The United States airspace system's classification scheme is intended to maximize pilot flexibility within acceptable levels of risk appropriate to the type of operation and traffic density within that class of airspace—in particular to provide separation and active control in areas of dense or high-speed flight operations.

The Albert Roper (1919-10-13 The Paris Convention) implementation of International Civil Aviation Organization (ICAO) airspace classes defines classes A through G (with the exception of class F which is not used in the United States). The other U.S. implementations are described below. The United States also defines categories of airspace that may overlap with classes of airspace. Classes of airspace are mutually exclusive. Thus, airspace can be “class E” and “restricted” at the same time, but it cannot be both “class E” and “class B” at the same location and at the same time.

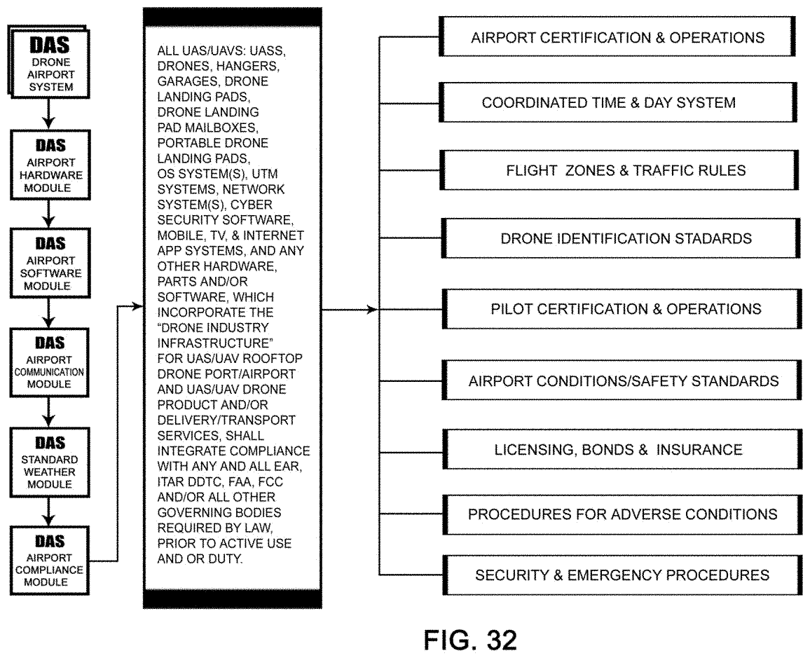

FIGS. 32-40, outline other rules and procedure modeled on the FAA rules and regulations (Advisory Circulars “ACs”), which are implement into the operational requirement of the Smart Drone Airport System; wherein said rules are subdivided into the following categories: 1) airport certification and operations; 2) coordinated time and day system; 3) flight and traffic rules; 4) drone identification standards; 5) pilot certification and operation; 6) airport conditions and safety standards; 7) licensing, bonds and insurance standards; 8) procedures for adverse conditions; 9) security and emergency procedures.

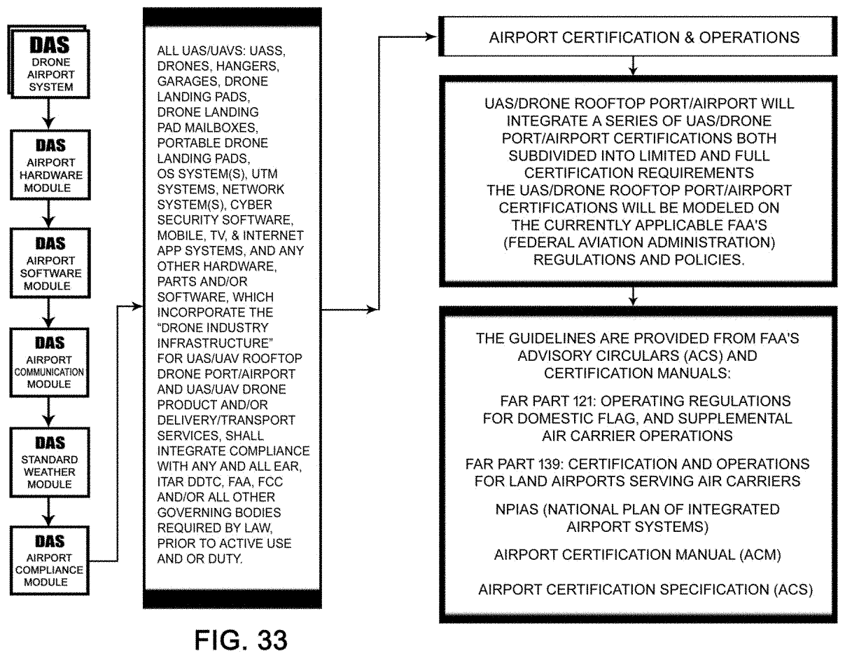

Airport certification and operations, shown in FIG. 33: Smart UAS/Drone Rooftop DronePort/AirPort will integrate a Series of UAS/drone port/airport certifications both subdivided into limited and full certification requirements the UAS/drone rooftop port/airport certifications will be modeled on the currently applicable FAA's regulations and policies. Here, the guidelines are provided from FAA's Advisory Circulars (ACs) and certification manuals, specifically: FAR Part 121: Operating Regulations for Domestic, Flag, and Supplemental Air Carrier Operations, FAR Part 139: Certification and Operations for Land Airports Serving Air Carriers, NPIAS (Nat Plan of Integrated Airport Systems), Airport Certification Manual (ACM), and Airport Certification Specification (ACS).

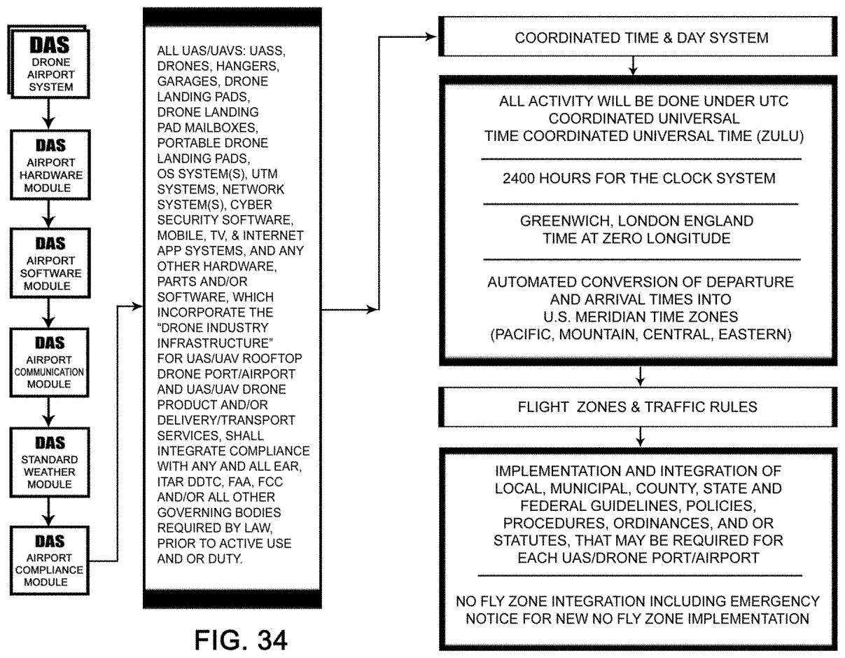

Coordinated time and day system, shown in FIG. 34: All activity will be done under UTC Coordinated Universal Time Coordinated Universal Time (Zulu), 2400 hours for the clock system, Greenwich, London England Time at Zero Longitude, Automated Conversion of Departure and Arrival Times into U.S. Meridian Time Zones(Pacific, Mountain, Central, Eastern.

Flight zones and traffic rules, shown in FIG. 34: Implementation and Integration of Local, Municipal, County, State and Federal Guidelines, Policies, Procedures, Ordinances, and or Statutes, that May be Required for Each UAS/Drone Port/Airport, No Fly Zone Integration including Emergency Notice for New No Fly Zone Implementation.

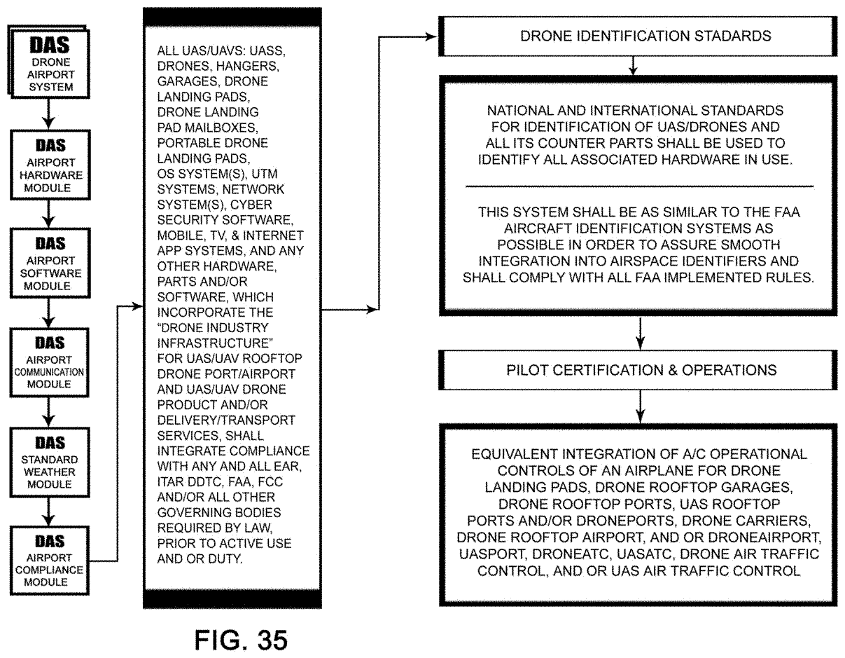

Drone identification standards, shown in FIG. 35: National and International Standard for Identification of UAS/Drones and all its counter parts shall be used to identify all associated hardware in use. This system shall be as similar to the FAA Aircraft Identification Systems as possible in order to assure smooth integration into airspace identifiers and shall comply with all FAA implemented rules.

Pilot certification and operation, shown in FIG. 35: Equivalent integration of A/C operational controls of an airplane for smart drone landing pads, smart mailbox and parcel landing pad, drone rooftop garages, drone rooftop ports, UAS rooftop ports and/or drone ports, drone carriers, smart drone rooftop airport, and or drone airport, UAS port, drone ATC, UAS ATC, drone air traffic control, and/or UAS air traffic control.

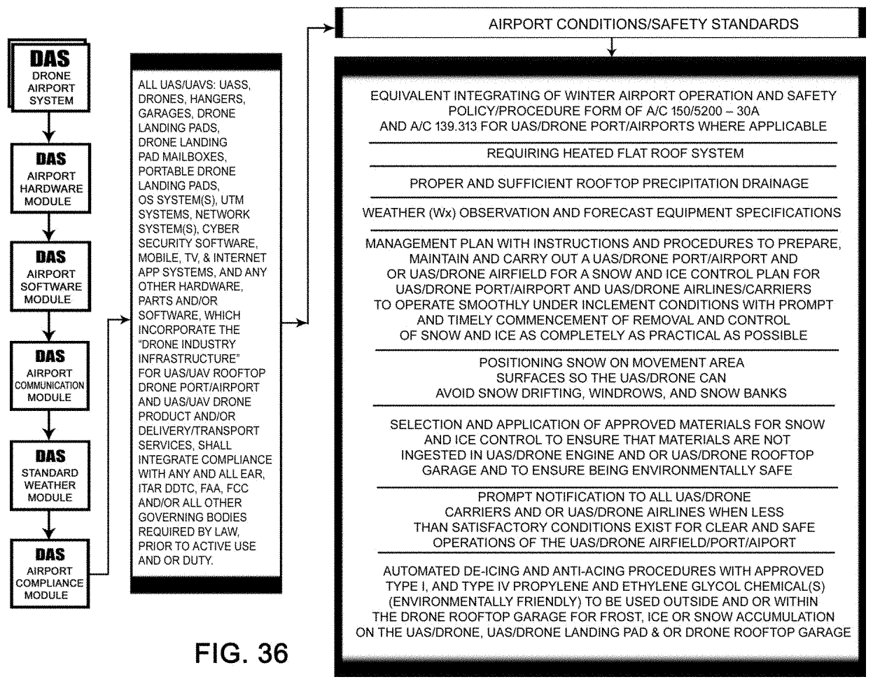

Airport conditions and safety standards, shown in FIG. 36: Equivalent integrating of winter airport operation and safety policy/procedure form of A/C 150/5200—30A and A/C 139.313 for Smart UAS/drone port/airports where applicable; Requiring heated flat roof system; Proper and sufficient rooftop precipitation drainage; Weather (Wx) observation and forecast equipment specifications; Budget projections and allocations; management plan with instructions and procedures to prepare, maintain and carry out a UAS/drone port/airport and or UAS/drone airfield for a snow and ice control plan for Smart UAS/drone port/airport and UAS/drone airlines/carriers to operate smoothly under inclement conditions with prompt and timely commencement of removal and control of snow and ice as completely as practical as possible; Positioning snow on movement area surfaces so the UAS/Drone can avoid snow drifting, windrows, and snow banks; selection and application of approved materials for snow and ice control to ensure that materials are not ingested in UAS/drone engine and or UAS/drone rooftop garage and to ensure being environmentally safe; Prompt notification to all UAS/Drone carriers and or UAS/drone airlines when less than satisfactory conditions exist for clear and safe operations of the UAS/drone airfield/port/airport; Automated de-icing and anti-acing procedures with approved Type I, and Type IV propylene and ethylene glycol chemical(s) (environmentally friendly) to be used outside and or within the UAS/drone rooftop garage for frost, ice or snow accumulation on the UAS/drone, UAS/drone landing pad and or UAS/drone rooftop garage.

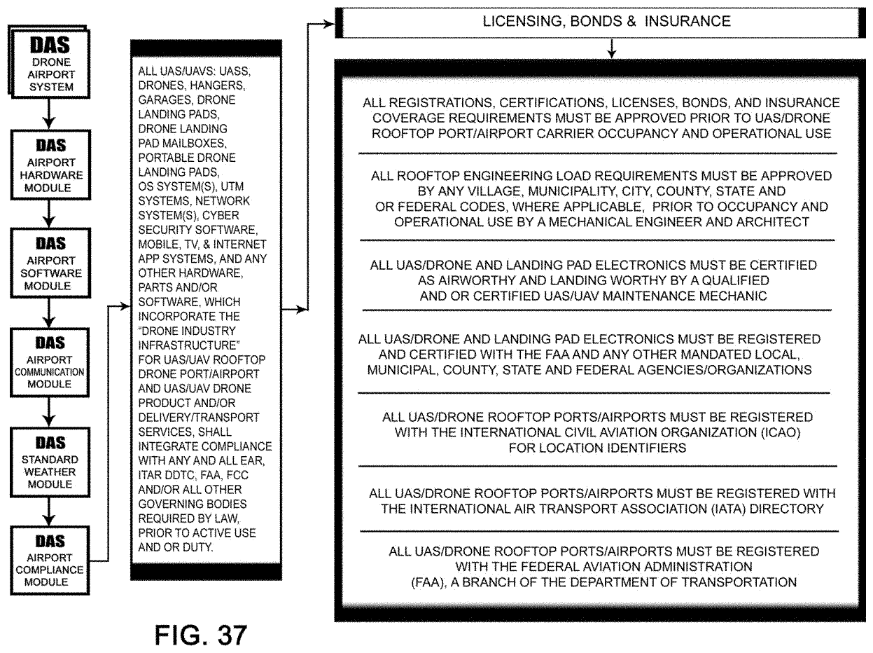

Licensing, bonds and insurance standards, shown in FIG. 37: All registrations, certifications, licenses, bonds, and insurance coverage requirements must be approved prior to UAS/Drone rooftop port/airport carrier occupancy and operational use; All rooftop engineering load requirements must be approved by any village, municipality, city, county, state and or federal codes, where applicable, prior to occupancy and operational use by a mechanical engineer and architect; All UAS/drone and landing pad electronics must be certified as airworthy and landing worthy by a qualified and or certified UAS/UAV maintenance mechanic; All UAS/drone and landing pad electronics must be registered and certified with the FAA and any other mandated local, municipal, county, state and federal agencies/organizations; All Smart Drone Rooftop DronePorts/AirPorts must be registered with the International Civil Aviation Organization (ICAO) for location identifiers; All Smart Drone Rooftop DronePorts/AirPorts must be registered with the International Air Transport Association (IATA) Directory; All Smart Drone Rooftop DronePorts/AirPorts must be registered with the Federal Aviation Administration (FAA), a branch of the Department of Transportation.

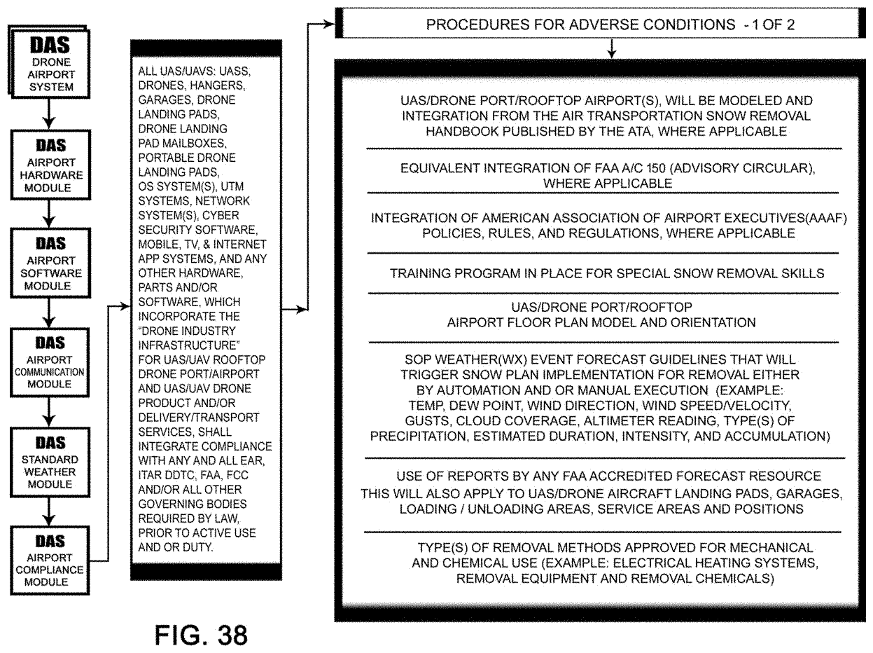

Procedures for adverse conditions (1 of 2) , shown in FIG. 38: Smart Drone Rooftop DronePorts/AirPort(s), will be modeled and integration from the air transportation snow removal handbook published by the ATA, where applicable; Equivalent Integration of FAA A/C 150 (Advisory Circular), where applicable; Integration of American Association of Airport Executives (AAAF) policies, rules, and regulations, where applicable; Training program in place for special snow removal skills; Smart Drone Rooftop DronePorts/AirPorts floor plan model and orientation; SOP Weather(Wx) event forecast guidelines that will trigger snow plan implementation for removal either by automation and or manual execution (example: temp, dew point, wind direction, wind speed/velocity, gusts, cloud coverage, altimeter reading, type(s) of precipitation, estimated duration, intensity, and accumulation); Use of reports by any FAA accredited forecast resource, this will also apply to UAS/drone aircraft landing pads, Smart Drone Mailbox and Parcel Landing Pad, Smart garages, loading/unloading areas, service areas and positions; Type(s) of removal methods approved for mechanical and chemical use (example: electrical heating systems, removal equipment and removal chemicals).

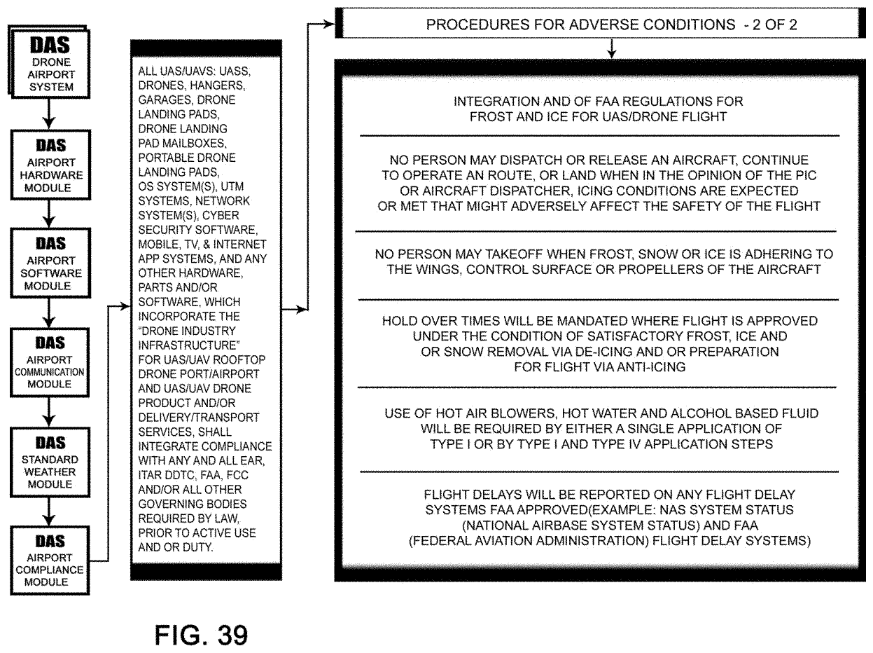

Procedures for adverse conditions (2 of 2) , shown in FIG. 39: Integration of FAA Regulations for frost and ice for UAS/drone flight; No person may dispatch or release an aircraft, continue to operate an route, or land when in the opinion of the PIC or aircraft dispatcher, icing conditions are expected or met that might adversely affect the safety of the flight; No person may takeoff when frost, snow or ice is adhering to the wings, control surface or propellers of the aircraft; Hold over times will be mandated where flight is approved under the condition of satisfactory frost, ice and or snow removal via de-icing and or preparation for flight via anti-icing; Use of hot air blowers, hot water and alcohol based fluid will be required by either a single application of Type I or by Type I and Type IV application steps; Flight delays will be reported on any flight delay systems FAA Approved (example: NAS System Status (National Airbase System Status) and FAA (Federal Aviation Administration) Flight Delay Systems).

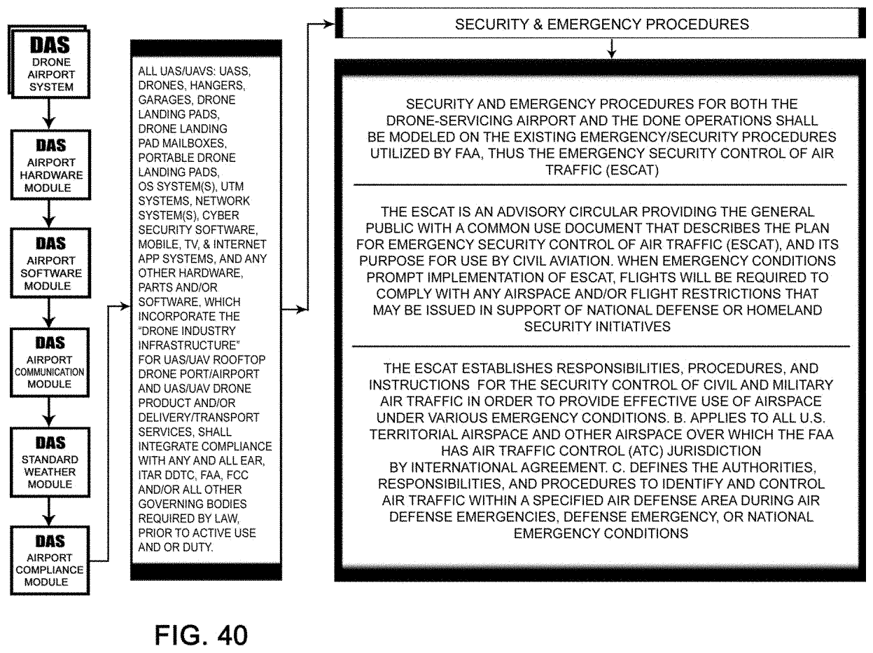

Security and emergency procedures, shown in FIG. 40: Security and emergency procedures for both the smart drone-servicing airport and the done operations shall be modeled on the existing emergency/security procedures utilized by FAA, thus the Emergency Security Control of Air Traffic (ESCAT); The ESCAT is an advisory circular providing the general public with a common use document that describes the Plan for Emergency SECURITY Control of Air Traffic (ESCAT), and its purpose for use by civil aviation. When emergency conditions prompt implementation of ESCAT, flights will be required to comply with any airspace and/or flight restrictions that may be issued in support of National Defense or Homeland Security initiatives; The ESCAT establishes responsibilities, procedures, and instructions for the security control of civil and military air traffic in order to provide effective use of airspace under various emergency conditions. b. Applies to all U.S. territorial airspace and other airspace over which the FAA has air traffic control (ATC) jurisdiction by international agreement. c. Defines the authorities, responsibilities, and procedures to identify and control air traffic within a specified air defense area during air defense emergencies, defense emergency, or national emergency conditions.

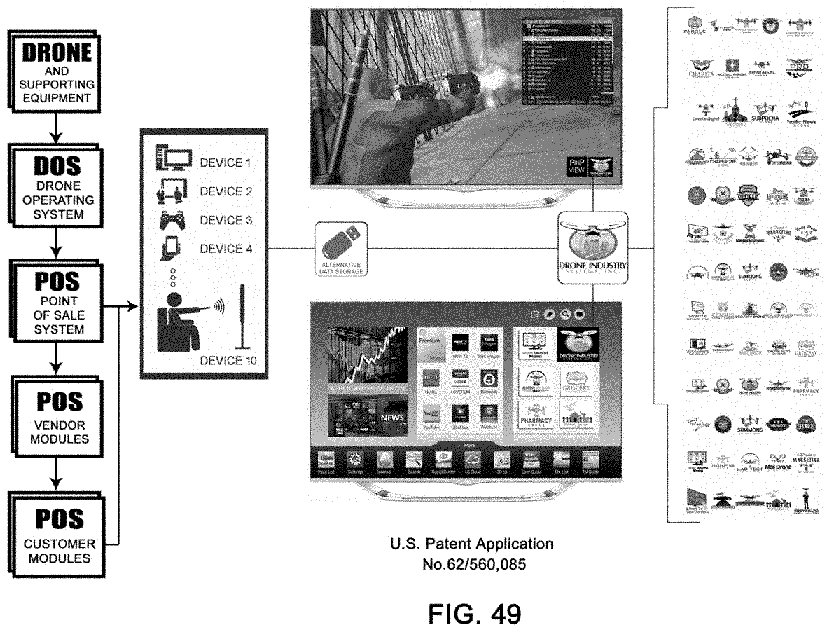

Finally, the Smart Drone Airport System, along with the Drone Operating System, and USSN System will integrate the Point of Sale System, shown in FIGS. 49, 50, 51, and 52. The Point of Sale System(POS) of the DOS, USSN and UTM are all integrated as a seamless system in modules and use Retailers, Restaurants, Curriers, Carriers, Servicers, Suppliers, Distributors, Dispatch, etc. will have a portal to order the Drone after receiving an order through the Customer UAS/Drone Mobile, Internet, or TV App and DOS services.

AI will determine the nearest drone, with the fastest execution of service, the equipment necessary to complete the delivery or mission, the most energy available to achieve that goal, if it is available for service, if it is already in service on a another deployment, if the weather permits and any other variable that makes the nearest and most logical UAS/drone, as the UAS/drone of choice.

Drones may be located and deployed directly on the retailer's rooftop of the building, on their grounds, or at a near location of similar storage, and/or garaging equipment, available for servicing and deployment.

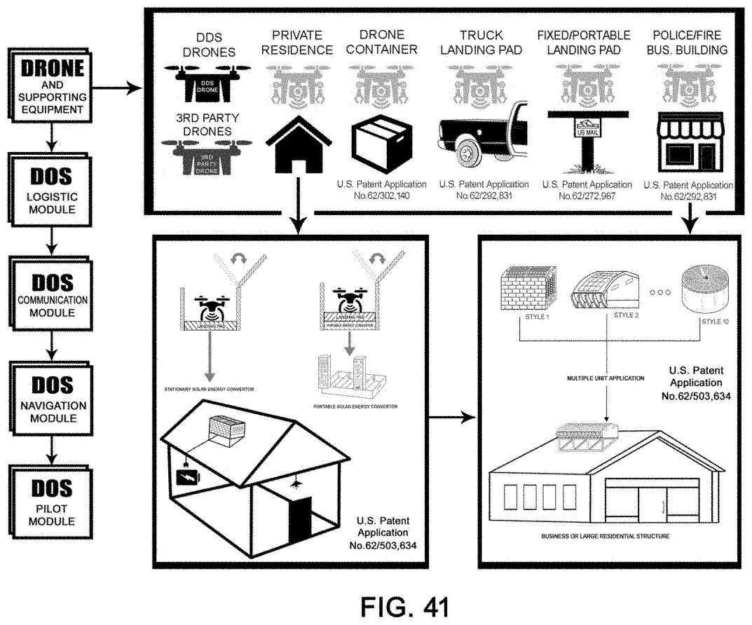

FIG. 41, illustrates the Drone and Supporting Equipment for both Private Residence and Police, Fire and Business Buildings. Rooftop Smart Drone Garage/Hanger Charging Stations are illustrated to be on top of the residential and commercial roofs.

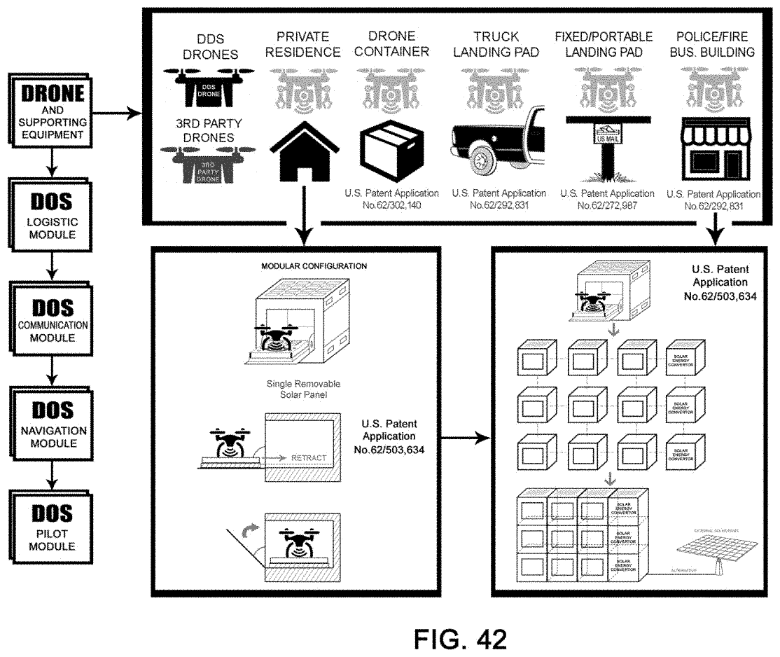

FIG. 42, illustrates and builds from FIG. 41, showing different configurations for both Single Removable Smart Solar Panel Drone Garage/Hanger Charging Stations and Modular Systems.

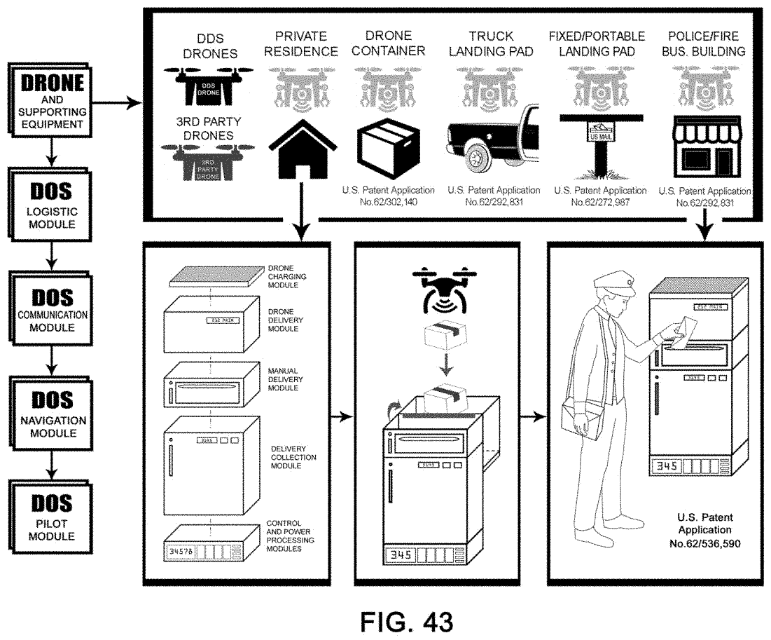

FIG. 43, illustrates and builds from FIG. 41 and FIG. 42, showing a Smart Drone Parcel Mailbox Landing Pad with a 1) Drone Charging Module; 2) Drone Delivery Module: 3) Manual Delivery Module; 4) Delivery Collection Module; 5) Control and Power Processing Modules.

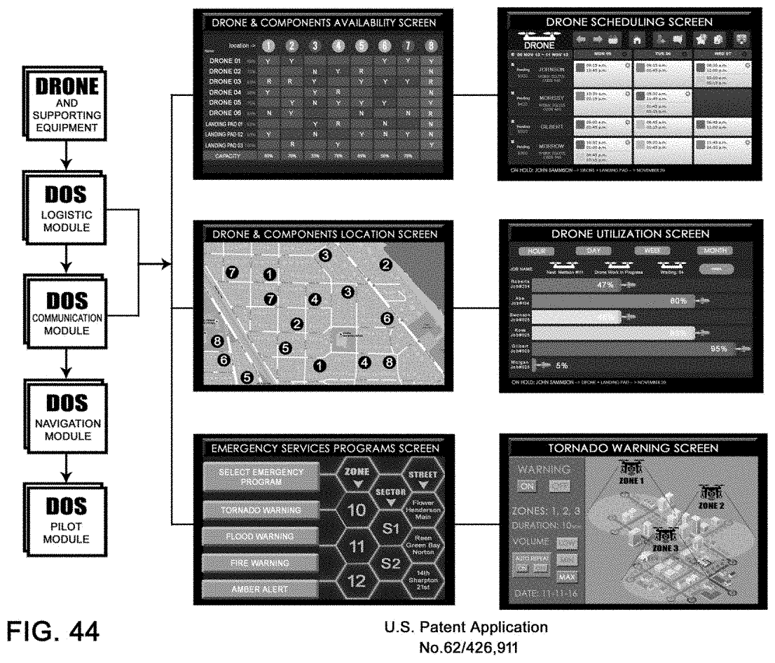

FIG. 44, illustrates a schematic from the DOS Logistic Module and DOS Communication Module, having a 1) Drone & Components Avaialbility Screen 2) Drone Scheduling Screen; 3) Crone & Components Location Screen; 4) Drone Utilization Screen; 5) Emergency Services Programs Screen; 6) Tornado Warning Screen.

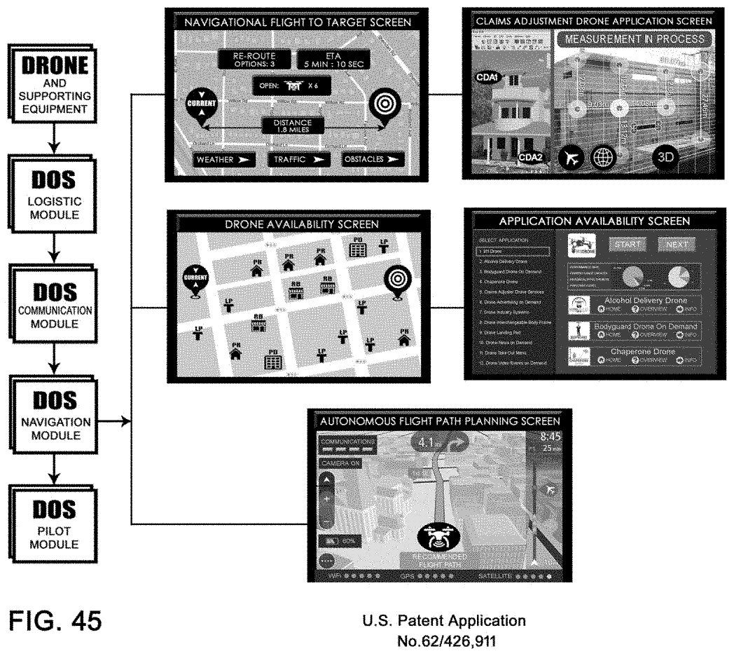

FIG. 45, illustrates a schematic from the DOS Navigation Module having a 1) Navigation Flight to Target Screen; 2) Claims Adjustment Drone Application Screen; 3) Drone Availability Screen; 4) Application Availability Screen; 5) Autonomous Flight Path Planning Screen.

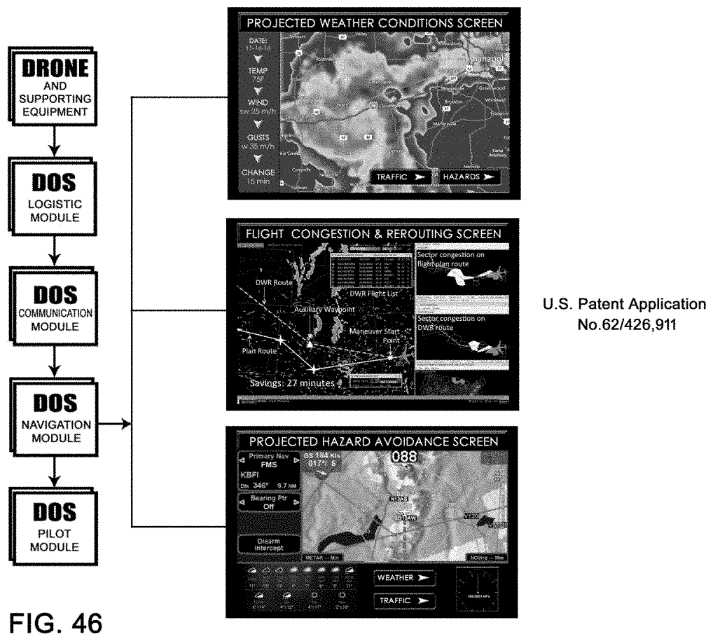

FIG. 46, illustrates a schematic from the DOS Navigation Module having 1) Projected Weather Conditions Screen; 2) Flight Congestion & ReRouting Screen; 3) Projected Hazard Avoidance Screen

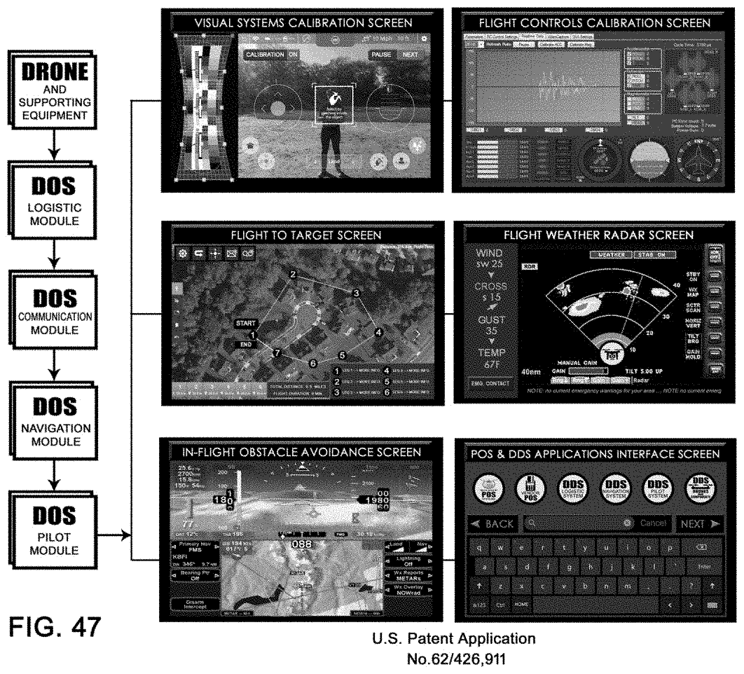

FIG. 47, illustrates a schematic from the DOS Pilot Module having 1) Visual Systems Calibration Screen; 2) Fight Conrrols Calibration Screen; 3) Fight to Target Screen; 4) Flight Weather Radar Screen; 5) In-Flight Obstacle Avoidance Screen; 6) POS & DDS Applications Interface Screen for Misc. uses.

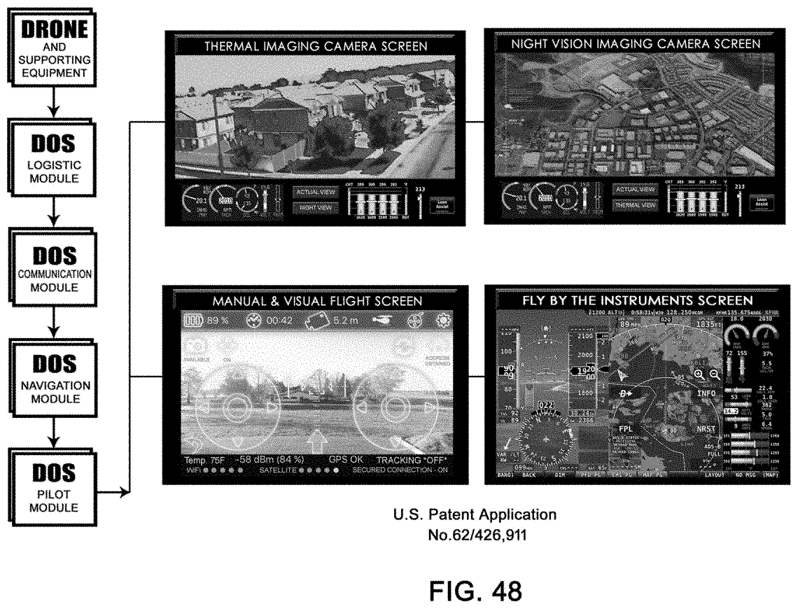

FIG. 48, illustrates a schematic from the DOS Pilot Module Thermal Imaging Camera Screen; 2) Night Vision Imaging Camera Screen; 3) Manual & Visual Flight Screen; and added is the 5) LiDAR Imaging Camera Screen.

FIG. 49, illustrates a schematic from the POS Point of Sale System and POS Customer Modules, using various mobile and land devices to place an order using TV and or Smart TV, and Alternative USB, SIM Card, SD Card or Similar Data Storage Device. This will allow for you to access the SDAS, DOS, USSD, system(s) and its various agnostic API applications for Drone Delivery and other Drone Services, allowing for Picture in Picture Viewing while placing your order.

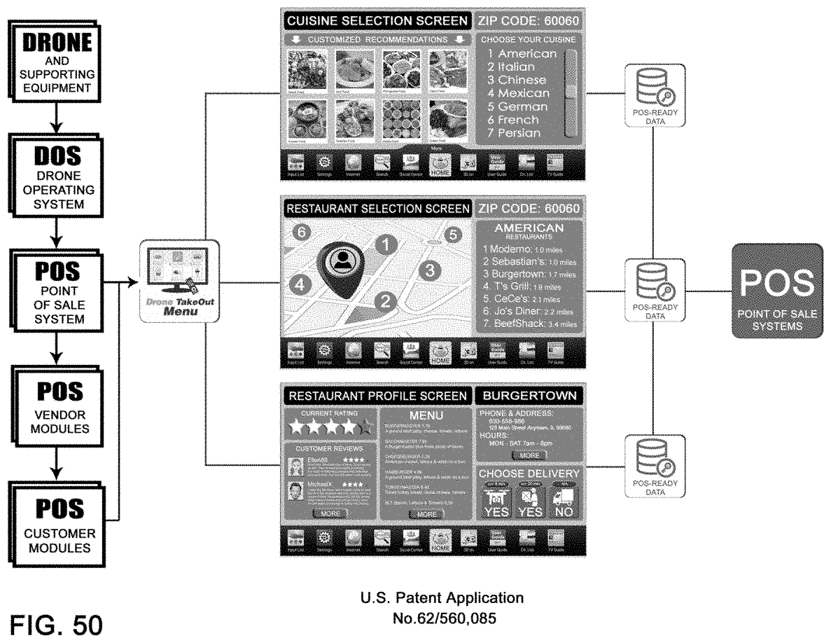

FIG.50 illustrates a schematic from the POS Point of Sale System through the Drone TakeOut Menu, providing 1) Cuisine Selection Screen; 2) Restaurant Selection Screen(Zip Code GeoFencing); 3) Restaurant Profile Screen; A) Current Ratings; B) Customer Reviews; C) Menu; Customer Information; Method of Delivery (Drone, In-House, Third-Party)

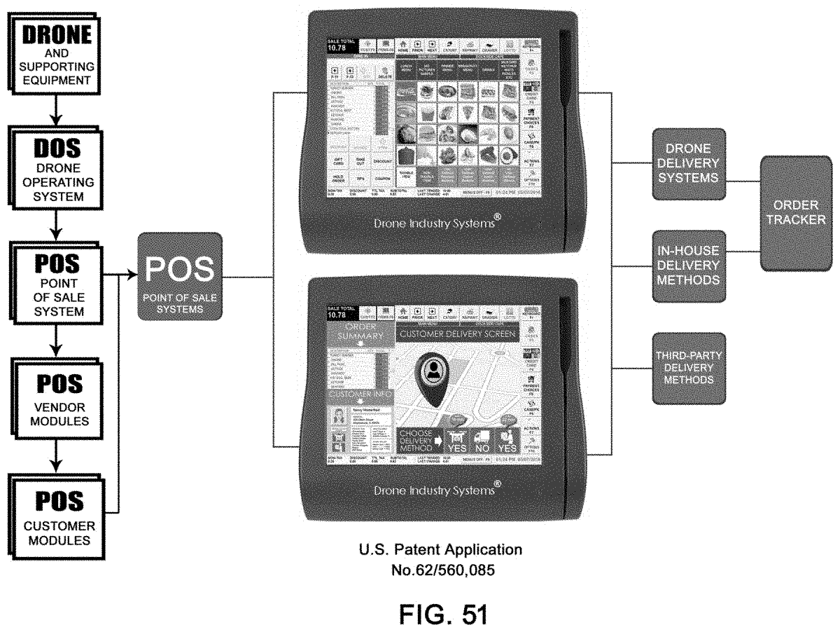

FIG. 51. illustrates a schematic from the POS Point of Sale System, POS Customer Module. Proving for 1) Drone Delivery Systems; 2) In-House Delivery Methods; 3) Third-Party Delivery Methods; 4) Order Tracker.

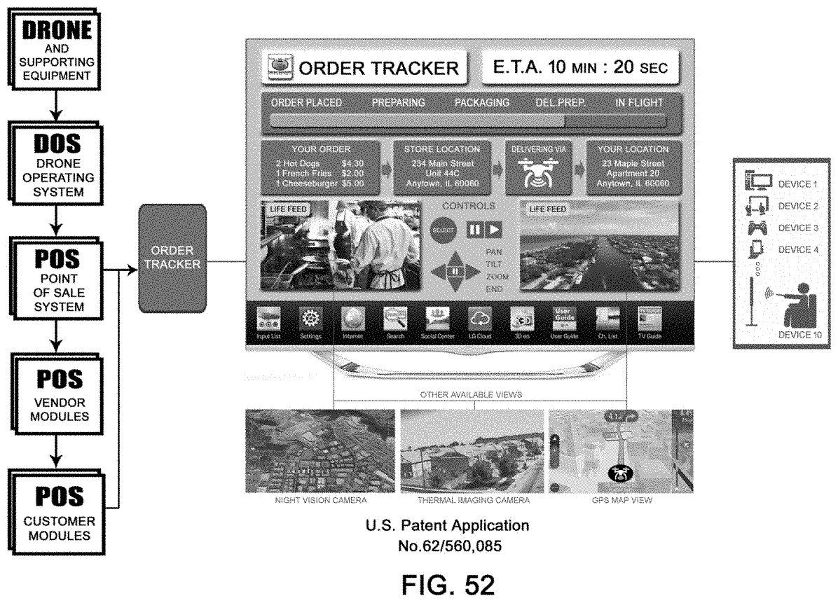

FIG. 52 illustrates a schematic from the POS Point of Sale System and POS Customer Module, to access the Order Tracker. You may view the following information: 1) E.T.A.; 2) Order Placed; 3) Preparing; 4) Packaging; 5) Delivery Prep.; 6) In-Flight; 7) Your Order Cost; 8) Store Location; 9) Selected Delivery of Choice or Availability; 10) Life (Live) Feed of Food Preparation in Kitchen; 11) Controls(Pan, Tilt, Zoom, End, Select, Stop, Play, Record, etc.); 12) Life Feed Aerial Flight of UAS Drone or Unmanned Ground Vehicle (UGV); 13) Night Vision; 14) Thermal Imaging Camera; 15) GPS Map View; 16) LiDAR Imaging Camera. Using multiple agnostic mobile devices to place, manage, interact and receive the order.

FIG. 53 illustrates a schematic of the smart drone rooftop and ground airport system 5300 including a Smart Drone Rooftop Airport, Smart Charging/Docking Station, ATC and LAANC. 5301 to receive and harbor a plurality of vehicles including drones and unmanned vehicles requiring storing and or charging before operational deployment to a destination. Drones represent in this description (“UAV's” or “Unmanned Aerial Vehicle” or “UAS” or “Unmanned Aerial Systems” or “VTOL's or “Vertical Take Off and Landing Vehicle” or “eVTOL's” or “Electric Vertical Take Off and Landing Vehicle” or “VSTOL's” or Vertical Short Take-Off and Landing Vehicles” or “STOL's” Short Take-Off and Landing Vehicles” or “eSTOL's” or “Electric Small Take-Off and Landing Vehicle” or “CTOL's” or “Conventional Take-Off and Landing Vehicle” or “eCTOL's” or “Electric Conventional Take-Off and Landing Vehicle” or “AV's” or “Autonomous Vehicles” or “CAV's” or “Connected and Autonomous Vehicles” or “Cargo Air Vehicles” or “CAV's” or Electric Cargo Air Vehicles” or “eCAV's” or “PAV's” or “Passenger Air Vehicles” or ePAV's” or “Electric Passenger Air Vehicles”).

An agnostic AI Cloud Computing Microservices System with DaaS, IaaS, PaaS, SaaS, RaaS, C-RAN, SDAS, DOS, USSN, Cyber and Network Security Network 5302 in operable communication with a point-of-sale (POS) system 5303 and similar auxiliary systems utilized by the Smart Drone Rooftop and Ground Airport System 5300 described herein. A network 5305 operates via a USSN-to-cloud communication protocol (control and command, telemetry, etc.) to communicate with the smart airport drone system 5300 provided on a rooftop or similar terminal and a ground control system 5306 permitting operators to control various aspects of the embodiments provided herein, which can be either ground or autonomous and virtual(VR, AR, MR).

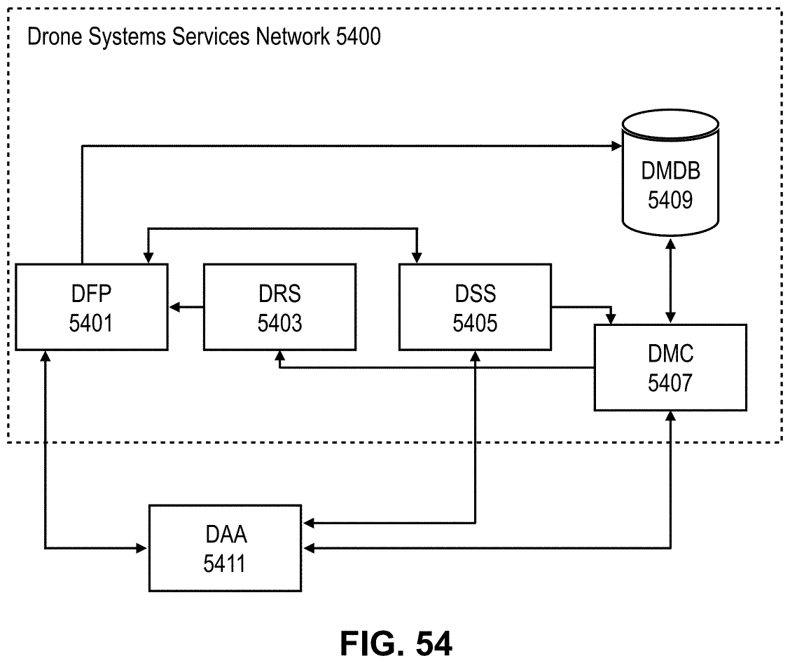

FIG. 54 illustrates a block diagram of the unmanned systems service network 5400 comprising at least one of the following: a drone flight planner (DFP) 5401, drone request system (DRS) 5403, a drone system slate (DSS) 5405, a drone mission checker (DMC) 5407, a drone mission database (DMDB) 5409, and a drone authentication authority (DAA) 5411. The customer requests service from the DRS 5403 which asks the DFP 5401 to plan a flight. The DFP 5401 sends the origin and destination to the DSS 5405 which responds with the status information of candidate nodes for the mission. The DFP 5401 invites nodes to be part of a mission via the DAA 5411 which sends an authentication message to the nodes which may accept or reject the invitation which may be returned to the DFP 5401. The DFP 5401 may then transmit a confirmation to the DAA 5411 which passes the confirmation to the nodes. The DFP 5401 logs the flight in the DMDB 5409 and the nodes send status changes to the DAA 5411 which forwards the status changes to the DSS 5405. The DSS 5405 sends status changes to the DMC 5407 to determine if any active missions must be updated. The DMC 5407 queries the DMDB 5409 to help it identify affected missions, and if missions are affected, the DMC 5407 transmits a request to the DRS 5403 to launch a drone flight modification request to repeat the process. The drone system services network provides flexibility, extensibility, security, performance and scalability to the drone airport system.

Each node may be characterized by at least one of the following: Node type (drone, battery, point-of-sale, rooftop, mailbox, etc.), Industry Type (Public, Private, Public Private Participation(PPP), Military), Sector type (for special-purpose applications like medical delivery or law enforcement), Unique 160-bit ID, Public-private key pair, Public-key certificate, Primary status (available or unavailable), Secondary status (additional detail), Event log, and Schedule of commitments. Each node may include the following NextGEN weather data streams, ADS-B data exchange, GPS, Drone Flight Planner (DFP), Drone Data Exchange (DDE), Drone System State (DSS), Drone Missions Database (DMDB), Device Authentication Authority (DAA), and Drone Mission Checker (DMC).

Individual nodes will publish status and event information to the DDE at regular intervals. From this, the current state of the entire system will be built and updated. Users and customers have access to another service called the Drone Request System (DRS) through which they can hail services.

In some embodiments, four types of delivery order services are available for UAV delivery. Drone Industry Systems Corp Orders (DISC) taking a direct order from our customer, who are using our In-house web site or mobile app., which only allows for selecting our direct participating vendors. Vendor's direct customer order operates by a vendor taking a direct order from the customer, using the vendor's web site or mobile app., connected to our API-OEM POS operating system and UAS hailing service. Vendor in-house hailing request operates by a vendor in our DISC network, hailing a drone from our POS system for an in-house and or phone delivery order. A third party take away delivery service hailing request operate by a third party taking an order direct from their customer, using our OEM API hailing app. and UAS hailing services.

In some embodiments, nodes may include controllers, rooftop clients (r-clients), and extended clients (e-clients). Each rooftop airport will employ one controller node and as many client nodes as the rooftop can accommodate. The controller providers services to the client nodes and serves as the rooftop airports central point of contact. The controller node sends commands and configuration information to the client nodes and receives data and service requests from them. The controller and clients communication with each other over a local Wi-Fi network or similar network configuration.

In some embodiments, the controller node consists of an internet-connected computer, authentication fob, GPS transmitter, and a mobile network antenna. The computer and authentication are housed in a theft-proof container and resilient container.

In some embodiments, The Future Air Navigation System (FANS) integration modulation: to provide an option for direct data link communication between the pilot, remote pilot and the Air Traffic Controller (ATC), an Aircraft Communications Addressing and Reporting System (ACARS) communications (satellite-based), Communication, Navigation and Surveillance (CNS)/ Air Traffic Management (ATM) for Air Traffic Service(ATS) Providers, and Data Link Service Providers (DSP)/Communication Service Providers (CSP).

Radio or satellite technology (SatCom) may be used to enable digital transmission of short, relatively simple messages between the aircraft, UAS, UAV, VTOL, Heliport, Vertiport's and ground stations. Communications typically include the traditional: air traffic control clearances, pilot requests, and position reporting.

The goal of FANS is to improve performance related to Communication, Navigation and Surveillance (CNS)/Air Traffic Management (ATM) activities within the operating environment. Through a satellite data link integration feature, airplanes UAS, UAV, and VTOL equipped with FANS can transmit Automatic Dependent Surveillance (ADS) reports with actual position and intent information at least every five minutes. The position is based on the highly accurate Global Positioning System (GPS).

In some embodiments, a Real-time En route and Re-Route AI Weather Reporting feature from FANS and NextGen to and between airplanes UAS, UAV, and VTOL aircraft. An additional integration modulation is included for observation, prediction, UAS/UAV deployment and third-party services, that will be available with the assistance of UAS/UAVs, meteorological, networking, and operating system equipment on the UAS/UAV rooftop droneport/airport.

Information is disseminated from UAS/UAVs equipped with a UAS/UAV anemometer and or barometer, in order to create UAS/UAV Aircraft Reports (AMDAR) that were deployed from UAS/UAV rooftop droneport/airports. Common Support Services-Weather (CSS-Wx)—which publishes info provided by the NextGen weather processor and use of the system wide information management network, to the FAA and National Airspace System (NAS).

Observations are performed through the following: Next Gen CCS-Observations: Satellite imagery; Radar imagery; Aircraft reports (AMDAR); Surface reports (METARS); Upper air reports (balloon sounding), numerical modeling; Statistical forecasting including NWS forecasters, auto forecast system and forecast integration; Consolidated Storm Prediction for Aviation (CoSpa), Storm Prediction Center (SPC), UAS/UAV Weather Avoidance Field (WAF and UASWAF) Module-with UAS/UAV Deviation Model and Forecast UAS/UAV Avoidance Regions Models; Vortex 2 and 3—For Weather Chasing and reporting with UAS/UAVs, National Severe Storms Laboratories (NSSL), and UAS/UAV in-house, Mesonet and or other third-party UAS/UAV fleets.

In some embodiments, each r-client includes the following: a system-on-a-chip (SoC) computer, such as a Raspberry Pi, that is equipped with a WiFi antenna, a USB key that includes the R-client's 160-bit identification number and private key, an R-Client configuration manager that holds the 160-bit ID and public key of the Controller, an R-Client messenger tool for communicating instructions and data with the Controller, a Wi-Fi router, NFC antenna, or Bluetooth antenna to communicate with other R-Clients or, for Smart Landing Pads/Mailbox Landing Pads/Charging Stations/Hangers/Heliport, Vertiports for UAV and VTOL, that land on it.

In some embodiments, an e-client includes is any remote device or application that requests or uses the services of the rooftop airport. Examples of E-Clients include in-flight UAVs, point-of-sale systems, take away delivery apps, flight-hailing apps, public safety systems. weather-reporting systems, and logistics operators. E-Clients communicate with Controllers to request services, request data, provide data, arrange flights, and coordinate landings.

When installing the drone airport system provided herein, the Controller maintains an inventory of R-Clients. R-Clients include rooftop landing pads and other equipment associated with UAV services that share the roof. To install a new R-client, the rooftop operator will (1) register the R-client's 160-bit ID in the Controller's R-Client Inventory System; (2) register the Controller's ID and public key with the R-client's configuration manager; (3) assign the R-client a fixed IP address through the Controller's Wi-Fi router; and (4) install the R-Client messenger tool on the R-client and configure it to communicate with the Controller.

In some embodiments, to reserve and implement a landing, A UAV operator uses a desktop app, POS app, web browser or mobile app to connect to the Controller's reservations homepage. He specifies “landing request” as the type of transaction, the UAV model, id, payload, date and time of arrival, and special requests related to the landing. The Controller scans its reservations system and identifies which of its R-clients can accommodate the request. After the user acknowledges the arrangements and pays any associated fees, the Controller logs the schedule in its schedule database, logs the financial transaction in its fees ledger, and sends the UAV operator the GPS coordinates of the R-client that will host the landing. The UAV operator, through its own Controller and or the end user's automated mobile app, will program the UAV with the GPS coordinates of the landing site.

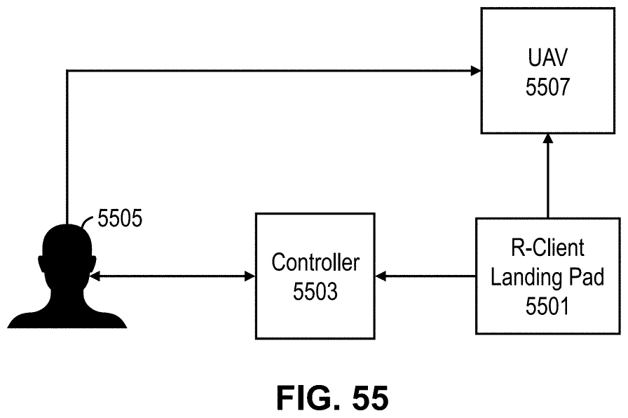

When the incoming UAV 5507 lands at the R-client 5501, the R-client will communicate the landing to the Controller 5503 via an operator 5505, which will mark the schedule item completed and that R-client occupied. The landing pad will use its built-in communication device (Wi-Fi router, NFC antenna, and or Bluetooth antenna) to establish communications with the newly landed UAV. FIG. 55 illustrates the communications involved in reserving and implementing a landing procedure wherein as described hereinabove.

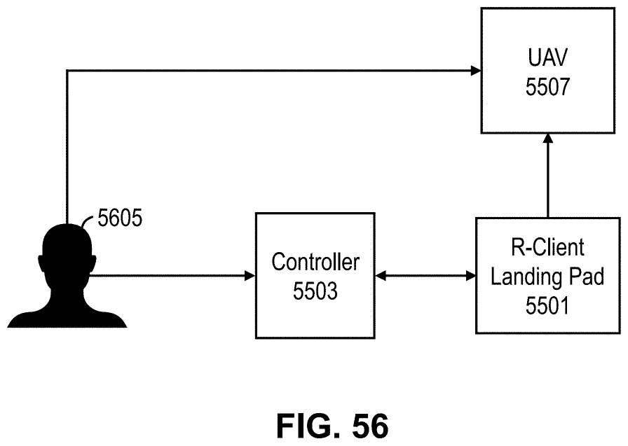

FIG. 56 illustrates the communications involved in reserving and implementing a take-off. A remote requestor 5605 uses a web browser or mobile app to connect to the Controller's 5503 reservations homepage. He specifies “takeoff request” as the type of transaction, which of the Controller's 5503 available drone models to schedule, destination GPS, and type of payload. The Controller 5503 scans its inventory of available drones to identify a match. After asking for and receiving confirmation from the remote requestor, including payment of the fees associated with the takeoff, the Controller 5503, at the designated takeoff time, sends GPS coordinates of the selected UAV's 5507 destination to the UAV's 5507 host pad through the R-client messenger tool. The host pad communicates the GPS coordinates to the UAV 5507 and initiates the takeoff. The host pad notifies the Controller 5503 that the takeoff occurred. The Controller 5503 logs the event in its schedule and resets the R-client landing pad's 5501 status to available.

Besides landing pads, a rooftop may contain other R-clients whose services and/or data external users (E-clients) can request. For example, service providers may request low-altitude weather data from NextGen weather measurement and data collection devices. To request data from R-clients, a would-be consumer will access the Controller's web page to request the desired service/data set. It is up to the owner/configurator of the Controller to decide which services to make available to which E-clients and to implement the communications needed to provide the service. Based on that configuration, the Controller and R-client will coordinate fulfilling the E-clients' request. The Controller serves as the initial point of contact that authenticates and then fulfills the request.

In some embodiments, in-house and third-party APIs can be customized for customer needs.

In some embodiments, the drone airport system integrates various technologies including FAA guidelines, rules and systems (dynamic integration), NASA guidelines, rules and systems (dynamic integration), Advanced Air Mobility (AAM) guidelines, rules and systems (dynamic integration), DARPA guidelines, rules and systems (dynamic integration), local, municipal, corporate, state, federal and military guidelines, rules and systems (dynamic integration), and any governmental auxiliary rule and regulation system, which requires modification (dynamic integration).

In some embodiments, current system hardware and software technologies from corporations such as CommScope and Nokia, will be available for integration into the rooftop airport in order to provide for third party technologies which will diversify the features the rooftop airport for can be scaled up or down to based on the class airport needs and requirements.

Smart city, smart building, communication and network technologies will be scalable and integrated into the rooftop airport based on the rooftop airports class, use and requirements.

Also disclosed is a universal Automated Artificial Intelligent Smart Rooftop UAS/UAV Drone Port/Airport Station, for General Purpose Services of Robotic UAS/UAVs, and its Supporting Hardware & Equipment related to Loading/Unloading, Deliveries, Deployment/Arrival, Dispatching, Air Traffic Control, Charging, Storing/Garaging, Di-Icing/Anti Icing, Meteorological & Data Dissemination/Retrieval, Big Data Mining, and MIMO Network Services; (“UAS” or “Drone Airport System” or “DAS”). Said Drone Airport System operation are supported by the Drone Operating System (“DOS), and provides the following capabilities: 1) Drone on demand delivery services; 2) Drones are parked, stored and or charging in the drone garage and or on a drone 3) landing pad; 4) Orders are made via mobile, land, and TV applications using wire and or wireless connections; 5) Drone AI Cloud (Artificial Intelligence Cloud) figures out if the weather permits deliver to and from the location requested at the time requested; 6) Drone AI Cloud will figure out which drone is available, using the fastest, most convenient, safest and properly equipped drone for the weather conditions, payload requirements, and any other specific demand option(s); 7) The UTM deploys the Drone to the Landing pad for loading/unloading, drop off and pickup; 8) The Drone is loaded and departs to its destination; 9) The Drone delivers arrives at its destination, confirms the receiver of the package, releases the product to the consumer and informs the POS that the order has been delivered; Page 57 of 109 10) The Drone AI then selects either the drone's next destination for charging, based upon its remaining battery use, sends it to its next order, or parks it at the nearest Drone AirPort Parking Station where it can recharge and wait for further instructions; 11) All Rooftop UAS/Drone Hardware, Exterior and or Interior Equipment and Landing Pad equipment will have a water proof option such as superhydrophobic (water) and oleophobic (hydrocarbons) coating, that will completely repel almost any liquid and or nanotechnology coating, to coat an object and create a barrier of air on its surface; 12) All UAS/Drone(s) that deploy will have the option to use UAS.UAV de-icing inflatable boot equipment© on the leading and trailing edges(s) of the propeller arm(s); 13) All UAS/Drone Hardware will have impact protections options, using products like Mashable D30 Crystalex Clear Formable Elastomer Material for Protective Gear on the UAS/Drone for Drop Test Crash Resistances; 4) All UAS/Drone Hardware will have Nanocrystalline Metal Alloy options for lighter, stronger, and more efficient, UAS.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An unmanned vehicle control system, comprising:
a ground control station in operable communication with a plurality of unmanned vehicles via a communications network, the ground control station to receive unmanned vehicle mission information and provide a plurality of instructions to the unmanned vehicle to execute a mission, the mission including a take-off procedure and a landing procedure;
a plurality of microservices to process requests from a controller;
at least one charging station to provide a docking point for the plurality of unmanned vehicles, wherein the charging station provides a power source to the plurality of unmanned vehicles and receives mission information from the ground control station, wherein the unmanned vehicles are operable to deliver a good to a remote location.

2. The system of claim 1, wherein the unmanned vehicles includes at least one of the following: unmanned aircraft systems (UAS), unmanned aircraft vehicles (UAV's), vertical take-off and landing vehicles (VTOL's), electric vertical take-off and landing vehicles (eVTOL's), vertical short take-off and landing vehicles (VSTOL's), short take-off and landing vehicles (STOL's), electric take-off and landing vehicles (eSTOL's), conventional take-off and landing vehicles (CTOL's), electric take-off and landing vehicles (eCTOL's), autonomous vehicles (AV's), connected and autonomous vehicles (CAV's), passenger air vehicles (PAV's), electric passenger air vehicles (ePAV's).

3. The system of claim 1, wherein the microservices comprise at least one of the following:
a drone flight planner (DFP), drone request system (DRS), a drone system slate (DSS), a drone mission checker (DMC), a drone mission database (DMDB), and a drone authentication authority (DAA).

4. The system of claim 1, further comprising a plurality of smart rooftop drone airports provided in a plurality of remote locations to receive the plurality of unmanned vehicles during a landing procedure.

5. The system of claim 1, further comprising a plurality of stationary landing pads, stationary smart landing pads, stationary rooftop landing pads, stationary smart rooftop landing pads, portable landing pads, smart portable landing pads, mailbox landing pads, smart drone mailbox landing pads, parcel mailbox landing pads, smart parcel mailbox landing pads, provided in a plurality of remote locations to receive the plurality of unmanned vehicles during a takeoff and landing procedure.

6. The system of claim 1, further comprising a plurality of attachable drone shipping disposable containers, attachable reusable drone shipping containers, and or a drone fixed with a shipping container already attached to it, provided in a plurality of remote locations to receive the plurality of unmanned vehicles during a loading and unloading procedure.

7. The system of claim 1, further comprising a plurality of attachable smart rooftop charging stations, drone garage stations and drone hanger stations, on top of the smart rooftop drone airports, attached to it, provided in a plurality of remote locations to receive the plurality of unmanned vehicles during a loading and unloading procedure.

8. The system of claim 1, wherein the plurality of smart rooftop drone airports provides a smart rooftop landing station to dispatch the unmanned vehicle via a take-off procedure.

9. The system of claim 5, wherein the smart rooftop drone airport provides a secure receptacle for receiving at least one.

10. The system of claim 1, wherein the point-of-sale system is configured to receive a payment from a requestor.

11. The system of claim 1, further comprising an unmanned systems services network in communication with the plurality of microservices and the ground control station to provide an autonomous unmanned vehicle delivery system to deliver goods to at least one of the plurality of smart rooftop drone airports.

12. The system of claim 2, wherein a GPS system guides the plurality of unmanned vehicles to the plurality of rooftop drone airports via the drone flight planner.

13. An unmanned vehicle control system, comprising:
a ground control station in operable communication with a plurality of unmanned vehicles via a communications network, the ground control station to receive unmanned vehicle mission information and provide a plurality of instructions to the unmanned vehicle to execute a mission, the mission including a take-off procedure and a landing procedure;
a plurality of microservices to process requests from a controller, the request including an unmanned vehicle take-off reservation procedure and an unmanned vehicle landing reservation procedure;
at least one charging station to provide a docking point for the plurality of unmanned vehicles, wherein the charging station provides a power source to the plurality of unmanned vehicles and receives mission information from the ground control station, wherein the unmanned vehicles are operable to deliver a good to a remote location.

14. The system of claim 1, wherein the unmanned vehicles includes at least one of the following: unmanned aircraft systems (UAS), unmanned aircraft vehicles (UAV's), vertical take-off and landing vehicles (VTOL's), electric vertical take-off and landing vehicles (eVTOL's), vertical short take-off and landing vehicles (VSTOL's), short take-off and landing vehicles (STOL's), electric take-off and landing vehicles (eSTOL's), conventional take-off and landing vehicles (CTOL's), electric take-off and landing vehicles (eCTOL's), autonomous vehicles (AV's), connected and autonomous vehicles (CAV's), passenger air vehicles (PAV's), electric passenger air vehicles (ePAV's).

15. The system of claim 1, wherein the microservices comprise an unmanned systems services network comprising at least one of the following: a drone flight planner (DFP), drone request system (DRS), a drone system slate (DSS), a drone mission checker (DMC), a drone mission database (DMDB), and a drone authentication authority (DAA).

16. The system of claim 12, wherein the unmanned systems services network is operable to execute the take-off reservation procedure and the landing reservation procedure.

17. The system of claim 13, further comprising a plurality of smart rooftop drone airports provided in a plurality of remote locations to receive the plurality of unmanned vehicles during a landing procedure.

18. The system of claim 14, wherein the plurality of smart rooftop drone airports provides a rooftop landing station to dispatch the unmanned vehicle via a take-off procedure.

19. The system of claim 15, wherein the smart rooftop drone airport provides a secure receptacle for receiving at least one good.

20. The system of claim 16, wherein the point-of-sale system is configured to receive a payment from a requestor.

21. The system of claim 17, further comprising an unmanned systems services network in communication with the plurality of microservices and the ground control station to provide an autonomous unmanned vehicle delivery system to deliver goods to at least one of the plurality of smart rooftop drone airports.

22. The system of claim 18, wherein a GPS system guides the plurality of unmanned vehicles to the plurality of smart rooftop drone airports via the drone flight planner.

23. An unmanned vehicle control system, comprising:
a ground control station in operable communication with a plurality of unmanned vehicles via a communications network, the ground control station to receive unmanned vehicle mission information and provide a plurality of instructions to the unmanned vehicle to execute a mission, the mission including a take-off procedure and a landing procedure;
a plurality of microservices to process requests from a controller, the request including an unmanned vehicle take-off reservation procedure comprising the steps of; communicating, via an r-client, the landing to a controller via an operator; marking the schedule item is completed;
indicating the r-client is occupied; and establishing communications with the landed unmanned vehicle;
an unmanned vehicle landing reservation procedure comprising the steps of: connecting to the controllers reservations; specifying a take-off request as a transaction type; receiving information from a remote requestor; transmitting GPS coordinates of a plurality of unmanned vehicles; initiating a take-off; and logging an event via the controller to reset the r-client landing pads, drone landing pads, smart landing pads, smart drone landing pads, smart drone mailbox landing pads, smart parcel mailbox landing pads, status; and
at least one charging station to provide a docking point for the plurality of unmanned vehicles, wherein the charging station provides a power source to the plurality of unmanned vehicles and receives mission information from the ground control station, wherein the unmanned vehicles is operable to deliver a good to a remote location.
